(19) United States
(12) Patent Application Publication
(10) Pub. No.: US 2006/0102030 A1
(43) Pub. Date: May 18, 2006

(54) Ink supply amount adjustment method and apparatus for printing press

(76) Inventor: Masahiro Hirano, Ibaraki (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/271,627

(22) Filed: Nov. 10, 2005

(30) Foreign Application Priority Data
Nov. 12, 2004 (JP) 329043/2004

(51) Int. Cl. B41F 31/02

(52) U.S. Cl. 101/350.1

(57) ABSTRACT

In an ink supply amount adjustment method, a standard ink fountain roller rotation amount preset before ink supply amount adjustment is compared with an ink fountain roller rotation amount after ink supply amount adjustment. A standard ink fountain key opening ratio preset before ink supply amount adjustment is compared with an ink fountain key opening ratio after ink supply amount adjustment. An ink fountain roller rotation amount correction amount is obtained on the basis of at least comparison result. An ink fountain key opening ratio correction amount common to all the ink fountain keys is obtained on the basis of at least the comparison result of the ink fountain key opening ratio. The ink fountain key opening ratio and the ink fountain roller rotation amount are adjusted in accordance with the obtained ink fountain key opening ratio correction amount and the obtained ink fountain roller rotation amount correction amount. An ink supply amount adjustment apparatus is also disclosed.

### BACKGROUND OF THE INVENTION

The present invention relates to an ink supply amount adjustment method and apparatus for a printing press, which adjust the ink supply amount to a printing plate by adjusting setting of the opening ratio of an ink fountain key or the rotation amount of an ink fountain roller.

As shown in FIG. 16, the inking device (inker) in each color printing unit of a rotary printing press comprises an ink fountain 1 which stores ink 2, an ink fountain roller 3 which forms part of the ink fountain 1 and supplies the ink from the ink fountain 1, a plurality of ink fountain keys 4-1 to 4-n which are juxtaposed in the axial direction of the ink fountain roller 3 to adjust the amount of the ink to be supplied to the ink fountain roller, an ink ductor roller 5 which transfers the ink supplied from the ink fountain roller 3, ink rollers 6 to which the ink from the ink ductor roller 5 is supplied, and a plate cylinder 8 to which the ink is supplied through the ink rollers 6. A printing plate 7 with an image printed on the surface is mounted on the outer surface of the plate cylinder 8.

In the above-described printing press, the supply amount of ink to be supplied from the ink fountain 1 to the ink fountain roller 3 is adjusted by adjusting the opening ratios of the ink fountain keys 4-1 to 4-n. In addition, the supply amount of ink to be supplied from the ink fountain roller 3 to the printing plate 7 through the ink rollers 6 is adjusted by adjusting the feed rate of the ink fountain roller 3 (to be referred to as a feed rate hereinafter). The adjusted ink is supplied to the printing plate 7 so that printing on a printing paper sheet is performed.

The opening ratios of the ink fountain keys 4-1 to 4-n are set in accordance with a preset “image area ratio−ink fountain key opening ratio conversion curve” in accordance with the image area ratios of areas on the printing plate 7 corresponding to the ink fountain keys 4-1 to 4-n. The feed rate of the ink fountain roller 3 (ink feed rate) is set in accordance with a preset standard ink feed rate. Setting of the opening ratios of the ink fountain keys 4-1 to 4-n and setting of the feed rate of the ink fountain roller 3 are done for each color printing unit. That is, the “image area ratio−ink fountain key opening ratio conversion curve” and standard ink feed rate are permanently set for each color.

In the above-described ink supply amount adjustment method, however, no proper ink supply amount can be obtained because of a seasonal change in printing environment (a change in temperature or humidity) or a change over time in printing materials such as a blanket and rubber roller. For this reason, after the opening ratios of the ink fountain keys 4-1 to 4-n and the feed rate of the ink fountain roller 3 are set on the basis of the “image area ratio−ink fountain key opening ratio conversion curve” and “standard ink feed rate”, the operator manually and finely tunes the opening ratios of the ink fountain keys 4-1 to 4-n or the feed rate of the ink fountain roller 3 at the time of printing while checking the color of a printing product printed by the printing plate 7. This fine tuning of the ink supply amount requires advanced skills, and not everybody can easily do it. Additionally, since fine tuning is very time-consuming, the printing operation delays.

Recently, as disclosed in Japanese Patent Laid-Open No. 61-162355 (reference 1), the “image area ratio−ink fountain key opening ratio conversion curve” is corrected by using the ink supply amount finally adjusted by the operator, thereby supplying an ink amount as proper as possible.

However, the above-described method of reference 1 executes correction on the basis of only the opening ratios of the ink fountain keys. For this reason, if the ink supply amount should be increased/decreased as a whole, the opening ratios of all ink fountain keys must be adjusted. Since this cumbersome operation requires labor and time, the printing materials are wasted, and the operation efficiently also becomes poor. Japanese Patent Laid-Open No. 61-268449 discloses correcting both the opening ratios of the ink fountain keys and the feed rate of the ink fountain roller. However, it is a mere irrational idea.

### SUMMARY OF THE INVENTION

It is an object of the present invention to provide an ink supply amount adjustment method and apparatus for a printing press, which can easily adjust the ink supply amount in a short time.

In order to achieve the above object, according to the present invention, there is provided an ink supply amount adjustment method for a printing press including a plurality of ink fountain keys each of which adjusts an amount of ink supplied from an ink fountain in accordance with an opening ratio, and an ink fountain roller which adjusts, in accordance with a rotation amount, an amount of ink to be supplied from the ink fountain to a plate cylinder, comprising the steps of comparing a standard rotation amount of the ink fountain roller preset before ink supply amount adjustment with a rotation amount of the ink fountain roller after ink supply amount adjustment, comparing a standard opening ratio of each ink fountain key preset before ink supply amount adjustment with an opening ratio of the ink fountain key after ink supply amount adjustment, obtaining an ink fountain roller rotation amount correction amount on the basis of at least one of two comparison results, obtaining an ink fountain key opening ratio correction amount common to all the ink fountain keys on the basis of at least the comparison result of the ink fountain key opening ratio, and adjusting the ink fountain key opening ratio and the ink fountain roller rotation amount in accordance with the obtained ink fountain key opening ratio correction amount and the obtained ink fountain roller rotation amount correction amount.

According to the present invention, there is also provided an ink supply amount adjustment apparatus for a printing press including a plurality of ink fountain keys each of which adjusts an amount of ink supplied from an ink fountain in accordance with an opening ratio, and an ink fountain roller which adjusts, in accordance with a rotation amount, an amount of ink to be supplied from the ink fountain to a plate cylinder, comprising first comparison means for comparing a standard rotation amount of the ink fountain roller preset before ink supply amount adjustment with a rotation amount of the ink fountain roller after ink supply amount adjustment, second comparison means for comparing a standard opening ratio of each ink fountain key preset before ink supply amount adjustment with an opening ratio of the ink fountain key after ink supply amount adjustment, first calculation means for obtaining an ink fountain roller rotation amount correction amount on the basis of at least one of comparison results of the first comparison means and the second comparison means, second calculation means for obtaining an ink fountain key opening ratio correction amount common to all the ink fountain keys on the basis of at least the comparison result of the second comparison means, and adjustment means for adjusting the ink fountain key opening ratio and the ink fountain roller rotation amount on the basis of calculation results of the first calculation means and the second calculation means.

The standard ink fountain key opening ratio preset before ink supply amount adjustment is obtained by adding an opening ratio correction amount, which is obtained by preceding adjustment, to, e.g., an opening ratio obtained from an “image area ratio−ink fountain key opening ratio conversion curve”. The standard ink fountain roller feed rate preset before ink supply amount adjustment is obtained by adding a feed rate correction amount, which is obtained by preceding adjustment, to, e.g., a permanently defined standard ink feed rate.

The standard ink feed rate may be obtained from a predetermined “image area ratio−ink fountain roller feed rate conversion curve”. Not the image area ratio but the image area itself may be used. If the opening ratio correction amount or feed rate correction amount is not obtained yet, i.e., in adjustment of the first time, an opening ratio obtained from the image area ratio or image area is set as the standard ink fountain key opening ratio. In addition, the standard ink feed rate which is permanently defined or obtained from the image area ratio or image area is set as the standard ink fountain roller feed rate.

### BRIEF DESCRIPTION OF THE DRAWINGS

FIG. 1 is a block diagram showing the outline of an ink supply amount adjustment apparatus for a printing press according to the present invention;

FIGS. 2A and 2B are flowcharts showing the learning operation of the ink fountain roller feed rate correction amount and ink fountain key opening ratio correction amount in the ink supply amount adjustment apparatus shown in FIG. 1;

FIG. 3 is a graph showing approximate curves I to IV representing the relationship between the image area ratio and the ink fountain key opening ratio;

FIGS. 4A to 4C are views showing the influence of the image area ratio on the density in the first to fourth ranges in correspondence with a change in ink fountain key opening ratio or a change in ink fountain roller feed rate;

FIGS. 5A to 5C are flowcharts following FIG. 2B;

FIG. 6 is a block diagram of an ink supply amount control apparatus for a printing press according to the first embodiment of the present invention;

FIGS. 7A to 7D are views showing details of a memory unit shown in FIG. 6;

FIG. 8 is a block diagram of first to nth ink fountain key control devices shown in FIG. 6;

FIG. 9 is a block diagram of first to mth ink fountain roller control devices shown in FIG. 6;

FIGS. 10A to 10Z are flowcharts showing the learning operation of the ink fountain roller feed rate correction amount and ink fountain key opening ratio correction amount in the ink supply amount adjustment apparatus shown in FIG. 6;

FIGS. 11A to 11D are flowcharts following FIG. 10Z;

FIG. 12 is a flowchart showing the processing operation in the ink fountain roller control device shown in FIG. 9;

FIG. 13 is a flowchart showing the processing operation in the ink fountain key control device shown in FIG. 8;

FIGS. 14A to 14H are flowcharts according to the second embodiment;

FIG. 15 is a functional block diagram of a CPU 9-1 shown in FIG. 1; and

FIG. 16 is a view showing the main part of an ink supply apparatus in a conventional rotary printing press.

### DESCRIPTION OF THE PREFERRED EMBODIMENTS

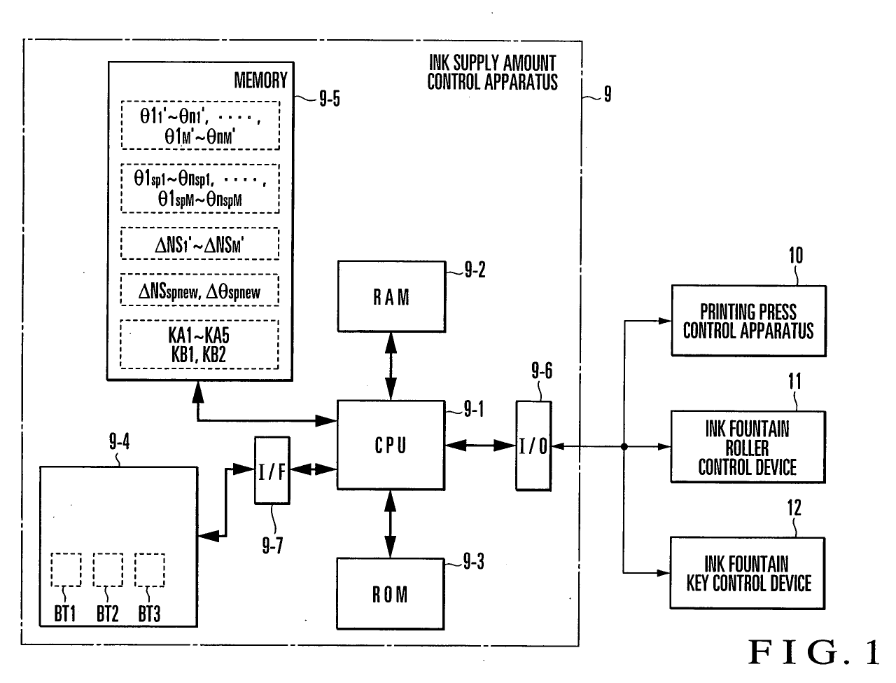

The present invention will be described below in detail with reference to the accompanying drawings. The outline (arrangement and operation) of the present invention will be described first with reference to FIGS. 1 to 5C.

Referring to FIG. 1, an ink supply amount control apparatus 9 comprises a CPU (Central Processing Unit) 9-1, RAM (Random Access Memory) 9-2, ROM (Read Only Memory) 9-3, input device 9-4, memory 9-5, and interfaces (I/O, I/F) 9-6 and 9-7. The CPU 9-1 is connected to the printing press control apparatus 10, ink fountain roller control device 11, and ink fountain key control device 12 through the interface 9-6.

The CPU 9-1 operates in accordance with a program stored in the ROM 9-3 while obtaining various kinds of input information given through the interfaces 9-6 and 9-7 and accessing the RAM 9-2 or memory 9-5. The ROM 9-3 stores a correction amount learning program to learn the correction amount of the feed rate (rotation amount) of the ink fountain roller and the correction amount of the opening ratio of each ink fountain key.

The input device 9-4 comprises a learning button BT1, ink fountain roller feed rate adjustment button BT2, and ink fountain key opening ratio adjustment button BT3. The memory 9-5 stores coefficients KA1 to KA5 to be used in learning the ink fountain roller feed rate correction amount and coefficients KB1 and KB2 to be used in learning the ink fountain key opening ratio correction amount. The coefficients KA1 and KA2, the coefficients KA3 and KA4, and the coefficients KB1 and KB2 are used in pairs and set to KA1>KA2, KA3>KA4, and KB1>KB2. The coefficients KA1 to KA5, KB1, and KB2 are 1 or less. The memory 9-5 stores an “image area ratio−ink fountain key opening ratio conversion curve” and “image area ratio−ink fountain roller feed rate conversion curve”.

[Learning of Ink Fountain Roller Feed Rate Correction Amount and Ink Fountain Key Opening Ratio Correction Amount]

As a prerequisite, the same learning operation of the ink fountain roller feed rate correction amount and ink fountain key opening ratio correction amount was executed in the past. As a learning result, an ink fountain roller feed rate correction amount ΔNSspnew and an ink fountain key opening ratio correction amount Δθspnew common to all ink fountain keys are stored in the memory 9-5.

Every time the correction amounts were learned in the past, a difference ΔNS′ between an ink fountain roller feed rate NS′ after ink supply amount adjustment and a standard feed rate NSsp before ink supply amount adjustment used at that time was stored in the memory 9-5 as the log data of the past feed rate. In addition, every time the correction amounts were learned in the past, ink fountain key opening ratios θ1′ to θn′ after ink supply amount adjustment and standard opening ratios θ1sp to θnsp before ink supply amount adjustment used at that time were stored in the memory 9-5 as the log data of the past opening ratios. In this example, correction amount learning was done M times in the past. Differences ΔNS₁′ to ΔNS_{M}′ between the ink fountain roller feed rates after ink supply amount adjustment and the standard feed rates before ink supply amount adjustment used at that time and ink fountain key opening ratios θ1₁′ to θn₁′, . . . , θ1_{M}′ to θn_{M}′ after ink supply amount adjustment and standard opening ratios θ1sp₁, to θnsp₁, . . . , θ1sp_{M} to θnsp_{M} before ink supply amount adjustment used at that time were stored as log data.

Referring to FIG. 16, a printing plate 7 is mounted on the outer surface of a plate cylinder 8. The feed rate of an ink fountain roller 3 and the opening ratios of ink fountain keys 4-1 to 4-n are preset. In this case, the CPU 9-1 of the ink supply amount control apparatus 9 obtains the average values of the image area ratios of areas of the printing plate 7 corresponding to the ink fountain keys 4-1 to 4-n. Next, the CPU 9-1 obtains an ink fountain roller feed rate NS_{B} corresponding to the average values of the image area ratios on the basis of the “image area ratio−ink fountain roller feed rate conversion curve” stored in the memory 9-5. The CPU 9-1 also obtains ink fountain key opening ratios θ1_{B} to θn_{B} corresponding to the image area ratios by referring to the “image area ratio−ink fountain key opening ratio conversion curve” stored in the memory 9-5 on the basis of the image area ratios of the areas corresponding to the ink fountain keys 4-1 to 4-n.

The ink fountain roller feed rate correction amount ΔNSspnew at that time, which is stored in the memory 9-5, is added (added if ΔNSspnew has a positive value or subtracted if ΔNSspnew has a negative value) to the obtained ink fountain roller feed rate NS_{B} to obtain the preset value (standard feed rate before ink supply amount adjustment) NSsp of the ink fountain roller feed rate. The preset value NSsp is given to the ink fountain roller control device 11. The ink fountain key opening ratio correction amount Δθspnew at that time, which is stored in the memory 9-5, is uniformly added (added if Δθspnew has a positive value or subtracted if Δθspnew has a negative value) to the obtained ink fountain key opening ratios θ1_{B} to θn_{B} to obtain the preset values (standard opening ratios before ink supply amount adjustment) θ1sp to θnsp of the ink fountain key opening ratios. The preset values are sent to the ink fountain key control device 12. With this operation, the feed rate of the ink fountain roller 3 is set to NSsp, and the opening ratios of the ink fountain keys 4-1 to 4-n are set to θ1sp to θnsp.

The operator instructs to start printing in this state, i.e., in the state wherein the feed rate of the ink fountain roller 3 is set to NSsp, and the opening ratios of the ink fountain keys 4-1 to 4-n are set to θ1sp to θnsp. After that, the operator checks the color of a printing product printed in this preset state and finely tunes the feed rate of the ink fountain roller 3 or the opening ratios of the ink fountain keys 4-1 to 4-n by adjusting the ink fountain roller feed rate adjustment button BT2 or ink fountain key opening ratio adjustment button BT3 such that a desired tone can be obtained. Then, printing is restarted.

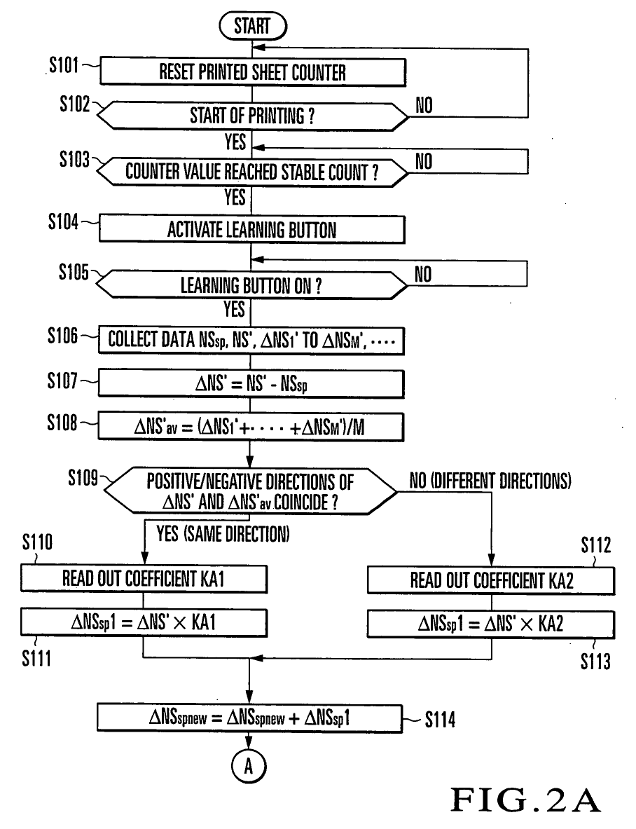

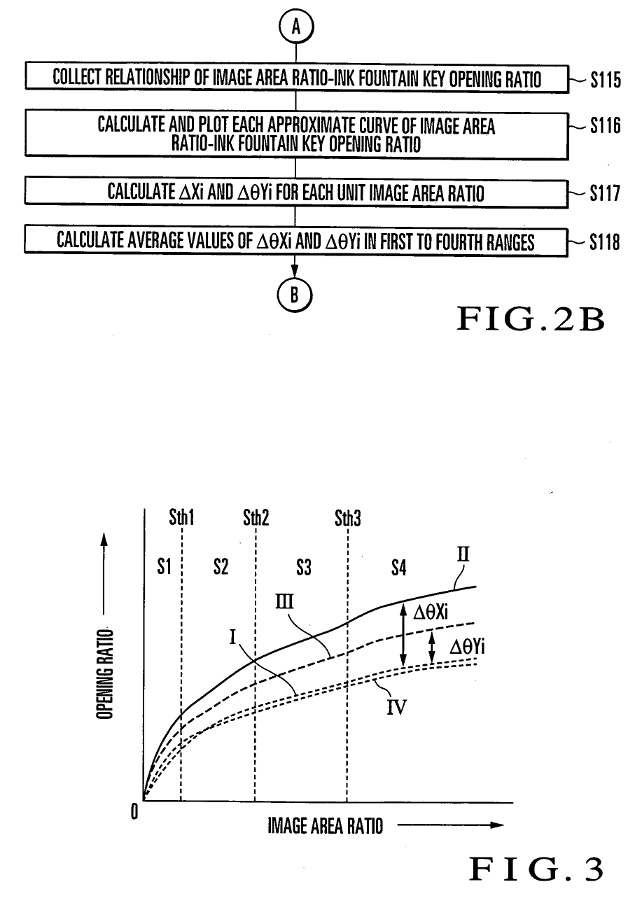

Referring to FIGS. 2A and 2B, when the feed rate of the ink fountain roller 3 or the opening ratios of the ink fountain keys 4-1 to 4-n are adjusted, and printing is restarted (YES in step S102), the CPU 9-1 starts the operation of an internal (printed sheet) counter that is reset in step S101, thereby starting counting the number of printed sheets. When the count value of the printed sheet counter has reached a predetermined stable count (step S103), the learning button BT1 is activated (step S104). For example, the indicator color of the learning button BT1 is changed to notify the operator of the learnable state.

[Learning of Ink Fountain Roller Feed Rate Correction Amount (First Correction Amount) from Change in Ink Fountain Roller Feed Rate]

The ink fountain roller feed rate correction amount (first correction amount) is obtained by, e.g., multiplying the difference between the ink fountain roller feed rate after ink supply amount adjustment and the standard feed rate before ink supply amount adjustment by a predetermined coefficient. If the positive/negative direction of the difference between the ink fountain roller feed rate after ink supply amount adjustment and the standard feed rate before ink supply amount adjustment is the same as the positive/negative direction of the average value of the differences between the ink fountain roller feed rates after a plurality of number of times of past ink supply amount adjustment and the standard feed rates before a plurality of number of times of past ink supply amount adjustment, the first coefficient is used as the coefficient. If the positive/negative directions are different, the second coefficient (KA2) smaller than the first coefficient (KA1) is used as the coefficient. That is, if the adjustment direction of the ink fountain roller feed rate opposes the previous direction, a smaller coefficient is used to reduce the degree of correction.

If the absolute value of the ink fountain roller feed rate correction amount is larger than a predetermined upper limit value, the ink fountain roller feed rate correction amount is corrected such that the absolute value of the ink fountain roller feed rate correction amount equals the upper limit value. That is, the upper limit value is set to the ink fountain roller feed rate correction amount not to perform correction beyond the upper limit value.

The learning operation will be described below in detail. When the learning button BT1 is turned on (YES in step S105), the CPU 9-1 learns a first correction amount ΔNSsp1 of the ink fountain roller feed rate from a change in ink fountain roller feed rate. The first correction amount ΔNSsp1 of the ink fountain roller feed rate is executed in the following way.

The CPU 9-1 collects current the ink fountain roller feed rate preset value NSsp (the current standard feed rate NSsp of the ink fountain roller before ink supply amount adjustment), current ink fountain roller feed rate NS′ (the current ink fountain roller feed rate NS′ after ink supply amount adjustment), and log data ΔNS₁′ to ΔNS_{M}′ of the past ink fountain roller feed rates (step S106).

Next, the current ink fountain roller feed rate NS′ after ink supply amount adjustment and the standard feed rate NSsp before ink supply amount adjustment are compared to obtain the difference ΔNS′ between them as a comparison result (step S107). An average value ΔNS′av of the past log data ΔNS₁′ to ΔNS_{M}′ is obtained (step S108). It is checked whether the positive/negative direction of ΔNS′ coincides with that of ΔNS′av (step S109). If one of ΔNS′ and ΔNS′av is 0, it is determined that they have the same positive/negative direction.

If ΔNS′ and ΔNS′av have the same direction (YES in step S109), the CPU 9-1 reads out the coefficient KA1 from the memory 9-5 (step S110). Next, ΔNS′ obtained in step S107 is multiplied by the coefficient KA1 to obtain the first correction amount ΔNSsp1(ΔNSsp1=ΔNS′×KA1) of the ink fountain roller feed rate (step S111).

If ΔNS′ and ΔNS′av have different directions (NO in step S109), the CPU 9-1 reads out the coefficient KA2 from the memory 9-5 (KA1>KA2) (step S112). Next, ΔNS′ is multiplied by the coefficient KA2 to obtain the first correction amount ΔNSsp1 of the ink fountain roller feed rate (step S113).

The first correction amount ΔNSsp1 of the ink fountain roller feed rate obtained in step S111 or S113 is added to the current ink fountain roller feed rate correction amount ΔNSspnew (ink fountain roller feed rate correction amount ΔNSspnew obtained by preceding learning) stored in the memory 9-5 to set the next ink fountain roller feed rate correction amount ΔNSspnew (ΔNSspnew (next value)=ΔNSspnew (preceding value)+ΔNSsp1) (step S114).

In the learning of the first correction amount ΔNSsp1 of the ink fountain roller feed rate, if ΔNS′ and ΔNS′av have different directions, i.e., if the adjustment direction of the ink fountain roller feed rate opposes the previous direction, the coefficient KA2 smaller than the coefficient KA1 is used to reduce the degree of correction. In addition, since ΔNS′ is multiplied by the coefficient KA1 or KA2 of 1 or less, the setting never change largely at a time.

In this description, an upper limit value ΔNSup is defined for the first correction amount ΔNSsp1 of the ink fountain roller feed rate. If the absolute value of the first correction amount ΔNSsp1 of the ink fountain roller feed rate obtained in step S111 or S113 is larger than the upper limit value ΔNSup, ΔNSsp1 is corrected such that the absolute value of ΔNSsp1 equals ΔNSup, thereby preventing ΔNSsp1 from exceeding ΔNSup.

[Learning of Ink Fountain Key Opening Ratio Correction Amount from Change in Ink Fountain Key Opening Ratio]

The ink fountain key opening ratio correction amount is obtained by, e.g., multiplying the average value of the differences between the opening ratios of the plurality of ink fountain keys after ink supply amount adjustment and the standard opening ratios before ink supply amount adjustment by a predetermined coefficient. In this case, when the positive/negative direction of the average value of the differences between the opening ratios of the plurality of ink fountain keys after ink supply amount adjustment and the standard opening ratios before ink supply amount adjustment is the same as that of the average value of the differences between the opening ratios of the plurality of ink fountain keys after a plurality of number of times of past ink supply amount adjustment and the standard opening ratios before a plurality of number of times of past ink supply amount adjustment, the first coefficient (KB1) is used as the coefficient. If the positive/negative directions are different, the second coefficient (KB2) smaller than the first coefficient is used as the coefficient. That is, if the adjustment direction of the ink fountain key opening ratios opposes the previous direction, a smaller coefficient is used to reduce the degree of correction.

In learning the ink fountain key opening ratio correction amount, the image area ratios or image areas of areas corresponding to the plurality of ink fountain keys belong to a minimum one of a plurality of ranges (e.g., four ranges) defined by division. That is, the ink fountain keys correspond to an area which has a small opening ratio and is insensitive to a change in ink fountain roller feed rate but is influenced by even a very small change in opening ratio. The CPU 9-1 learns the ink fountain key opening ratio correction amount Δθspnew from a change in ink fountain key opening ratio.

The learning operation will be described below in detail. The CPU 9-1 collects the ink fountain key opening ratios in correspondence with the image area ratios of the areas corresponding to them (step S115). As the ink fountain key opening ratios, the current ink fountain key opening ratio preset values θ1sp to θnsp (current standard ink fountain key opening ratios θ1sp to θnsp before ink supply amount adjustment), current ink fountain key opening ratios θ1′ to θn′ (current ink fountain key opening ratios θ1′ to θn′ after ink supply amount adjustment), past ink fountain key opening ratios θ1₁′ to θn₁′, . . . , θ1_{M}′ to θn_{M}′ after ink supply amount adjustment, and past standard opening ratios θ1sp₁ to θnsp₁, . . . , θ1sp_{M} to θnsp_{M} before ink supply amount adjustment are collected.

For each of the current standard ink fountain key opening ratios θ1sp to θnsp before ink supply amount adjustment, current ink fountain key opening ratios θ1′ to θn′ after ink supply amount adjustment, average values θ1′av to θn′av of the log data θ1₁′ to θn₁′, . . . , θ1_{M}′ to θn_{M}′ of the past ink fountain key opening ratios after ink supply amount adjustment, and average values θ1spav to θnspav of the log data θ1sp₁ to θnsp₁, . . . , θ1sp_{M} to θnsp_{M} of the past standard ink fountain key opening ratios before ink supply amount adjustment, the CPU 9-1 calculates and plots an approximate curve representing the relationship between the image area ratio and the ink fountain key opening ratio (step S116).

Referring to FIG. 3, an approximate curve I represents the relationship between the image area ratios and the current standard ink fountain key opening ratios θ1sp to θnsp before ink supply amount adjustment. An approximate curve II represents the relationship between the image area ratios and the current ink fountain key opening ratios θ1′ to θn′ after ink supply amount adjustment. An approximate curve III represents the relationship between the image area ratios and the average values θ1′av to θn′av of the past ink fountain key opening ratios after ink supply amount adjustment. An approximate curve IV represents the relationship between the image area ratios and the average values θ1spav to θnspav of the past standard ink fountain key opening ratios after ink supply amount adjustment.

After obtaining the approximate curves I to IV, the CPU 9-1 compares, for each step (unit image area ratio), the current ink fountain key opening ratio after ink supply amount adjustment and the standard ink fountain key opening ratio before ink supply amount adjustment to obtain a difference ΔθXi as a comparison result. Next, a difference ΔθYi between the average value of the past ink fountain key opening ratios after ink supply amount adjustment and the standard opening ratio before ink supply amount adjustment is calculated by
ΔθXi=θ′−θsp
ΔθYi=θ′av−θspav
(step S117).

The range of image area ratios plotted along the abscissa in FIG. 3 is divided into first, second, third, and fourth ranges S1, S2, S3, and S4. More specifically, threshold values Sth1, Sth2, and Sth3 (Sth1<Sth2<Sth3) are defined. The range of image area ratios is divided into the first range (minimum range) S1 from 0 to Sth1, the second range (second smallest range) S2 from Sth1 to Sth2, the third range (third smallest range) S3 from Sth2 to Sth3, and the fourth range (fourth smallest range) S4 from Sth3. Next,

average values ΔθX1 and ΔθY1 of ΔθXi and ΔθYi in the first range S1,

average values ΔθX2 and ΔθY2 of ΔθXi and ΔθYi in the second range S2,

average values ΔθX3 and ΔθY3 of ΔθXi and ΔθYi in the third range S3, and

average values ΔθX4 and ΔθY4 of ΔθXi and ΔθYi in the fourth range S4

are calculated (step S118).

For example, the average value ΔθY1 of ΔθYi in the first range S1 obtained here equals the average value of the average values of the differences between the past ink fountain key opening ratios after ink supply amount adjustment and the standard opening ratios before ink supply amount adjustment, which belong to the first range S1.

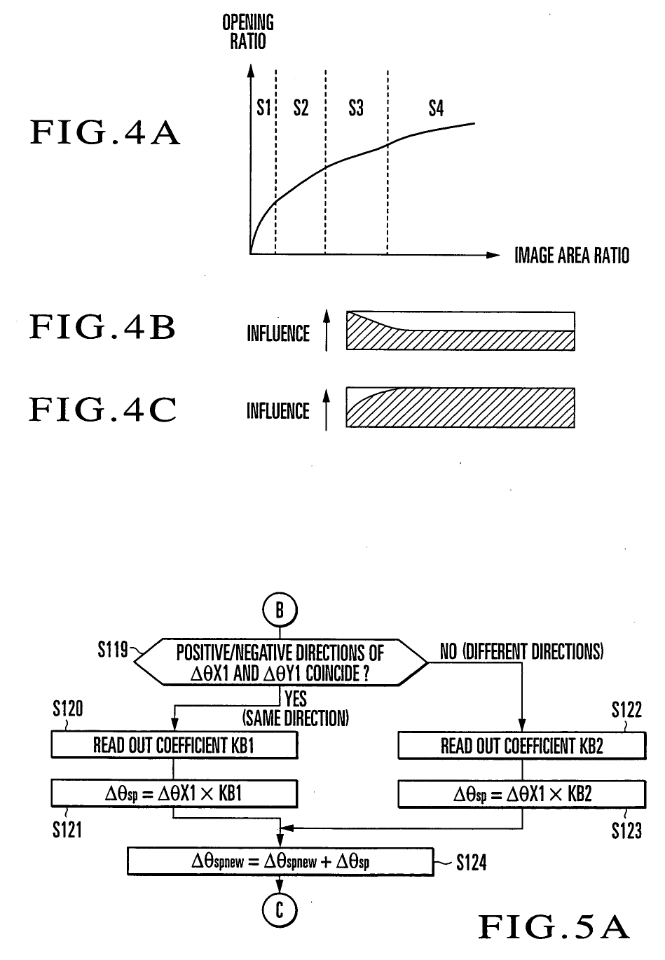

The first range S1 as the minimum range is insensitive to a change in ink fountain roller feed rate but is influenced by even a very small change in ink fountain key opening ratio. FIGS. 4A and 4B show the influence on the density when the ink fountain key opening ratio is changed in a very small amount. FIGS. 4A and 4C show the influence on the density when the ink fountain roller feed rate is changed. The second range S2 as the second smallest range is influenced by both a very small change in ink fountain key opening ratio and a change in ink fountain roller feed rate. The third range S3 as the third smallest range is a normally used range which is relatively rarely influenced by a very small change in ink fountain key opening ratio but relatively greatly influenced by a change in ink fountain roller feed rate. The fourth range S4 as the fourth smallest range (maximum range) is relatively rarely influenced by a very small change in ink fountain key opening ratio but relatively greatly influenced by a change in ink fountain roller feed rate, like the third range S3. However, the image is too large so this range is used not so usually.

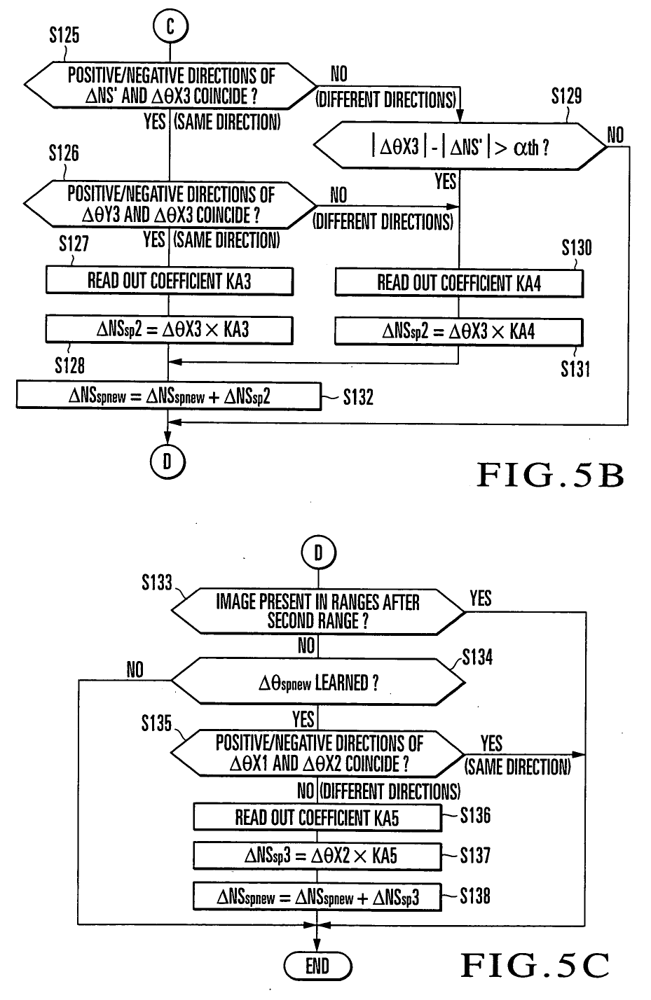

The CPU 9-1 learns the ink fountain key opening ratio correction amount Δθspnew from the average values ΔθX1 and ΔθY1 of ΔθXi and ΔθYi in the first range S1, as shown in FIG. 5A. First, the CPU 9-1 checks whether the positive/negative directions of ΔθX1 and ΔθY1 coincide with each other (step S119). If one of ΔθX1 and ΔθY1 is 0, it is determined that they have the same positive/negative direction.

If ΔθX1 and ΔθY1 have the same direction (YES in step S119), the CPU 9-1 reads out the coefficient KB1 (first coefficient) from the memory 9-5 (step S120). Next, ΔθX1 is multiplied by the coefficient KB1 to obtain the ink fountain key opening ratio correction amount Δθsp(Δθsp=ΔθX1×KB1) (step S121).

If ΔθX1 and ΔθY1 have different directions (NO in step S119), the CPU 9-1 reads out the coefficient KB2 (second coefficient; KB1>KB2) from the memory 9-5 (step S122). Next, ΔθX1 is multiplied by the coefficient KB2 to obtain the ink fountain key opening ratio correction amount Δθsp(Δθsp=ΔθX1×KB2) (step S123).

The ink fountain key opening ratio correction amount Δθsp obtained in step S121 or S123 is added to the current ink fountain key opening ratio correction amount Δθspnew stored in the memory 9-5 to set the next ink fountain key opening ratio correction amount A θspnew (Δθspnew (next value)=Δθspnew (preceding value)+Δθsp) (step S124).

In the learning of the ink fountain key opening ratio correction amount Δθsp, if ΔθX1 and ΔθY1 have different directions, i.e., if the adjustment direction of the ink fountain key opening ratio opposes the previous direction, the coefficient KB2 smaller than the coefficient KB1 is used to reduce the degree of correction. In addition, since ΔθX1 is multiplied by the coefficient KB1 or KB2 of 1 or less, the setting never change largely at a time.

[Learning of Ink Fountain Roller Feed Rate Correction Amount (Second Correction Amount) from Change in Ink Fountain Key Opening Ratio]

The ink fountain roller feed rate correction amount (second correction amount) is obtained by multiplying the average value of the differences between the opening ratios of the plurality of ink fountain keys after ink supply amount adjustment and the standard opening ratios before ink supply amount adjustment by a predetermined coefficient. In this case, when the positive/negative direction of the difference between the ink fountain roller feed rate after ink supply amount adjustment and the standard feed rate before ink supply amount adjustment is the same as that of the average value of the differences between the opening ratios of the plurality of ink fountain keys after ink supply amount adjustment and the standard opening ratios before ink supply amount adjustment, the first coefficient (KA3) is used as the coefficient. If the positive/negative directions are different, the second coefficient (KA4) smaller than the first coefficient is used as the coefficient. That is, if the adjustment direction of the ink fountain roller feed rate opposes that of the ink fountain key opening ratio, a smaller coefficient is used to reduce the ink fountain roller feed rate correction amount.

The ink fountain roller feed rate correction amount (second correction amount) is obtained by multiplying the average value of the differences between the opening ratios of the plurality of ink fountain keys after ink supply amount adjustment and the standard opening ratios before ink supply amount adjustment by a predetermined coefficient. In this case, when the positive/negative direction of the average value of the differences between the opening ratios of the plurality of ink fountain keys after ink supply amount adjustment and the standard opening ratios before ink supply amount adjustment is the same as that of the average value of the differences between the opening ratios of the plurality of ink fountain keys after a plurality of number of times of past ink supply amount adjustment and the standard opening ratios before a plurality of number of times of past ink supply amount adjustment, the first coefficient (KA3) is used as the coefficient. If the positive/negative directions are different, the second coefficient (KA4) smaller than the first coefficient is used as the coefficient. That is, if the adjustment direction of the ink fountain key opening ratios opposes the previous direction, a smaller coefficient is used to reduce the ink fountain roller feed rate correction amount.

When the absolute value of the average value of the differences between the opening ratios of the plurality of ink fountain keys after ink supply amount adjustment and the standard opening ratios before ink supply amount adjustment is larger than the absolute value of the difference between the ink fountain roller feed rate after ink supply amount adjustment and the standard feed rate before ink supply amount adjustment, the ink fountain roller feed rate correction amount (second correction amount) is obtained by multiplying the average value of the differences between the opening ratios of the plurality of ink fountain keys after ink supply amount adjustment and the standard opening ratios before ink supply amount adjustment by a predetermined coefficient (KA4).

In learning the second correction amount of the ink fountain roller feed rate, the image area ratios or image areas of areas corresponding to the plurality of ink fountain keys belong to the third smallest one of n ranges (n≧3), e.g., four ranges defined by division. That is, the ink fountain keys correspond to an area which has a large opening ratio and is relatively rarely influenced by a very small change in opening ratio but relatively largely influenced by a change in ink fountain roller feed rate.

The learning operation will be described below in detail. The CPU 9-1 learns a second ink fountain roller feed rate correction amount ΔNSsp2 from a change in ink fountain key opening ratio. The second ink fountain roller feed rate correction amount ΔNSsp2 is learned from the average value ΔθX3 of ΔθXi in the third range S3, as shown in FIG. 5B.

First, the CPU 9-1 checks whether the positive/negative directions of ΔNS′ and ΔθX3 coincide with each other (step S125). If one of ΔNS′ and ΔθX3 is 0, it is determined that they have the same positive/negative direction.

If ΔNS′ and ΔθX3 have the same direction (YES in step S125), the CPU 9-1 checks whether the positive/negative directions of ΔθY3 and ΔθX3 coincide with each other (step S126). If one of ΔθY3 and ΔθX3 is 0, it is determined that they have the same positive/negative direction.

If ΔθY3 and ΔθX3 have the same direction (YES in step S126), the CPU 9-1 reads out the coefficient KA3 from the memory 9-5 (step S127). Next, ΔθX3 is multiplied by the coefficient KA3 to obtain the second ink fountain roller feed rate correction amount ΔNSsp2 (ΔNSsp2=ΔθX3×KA3) (step S128).

If ΔθY3 and ΔθX3 have different directions (NO in step S126), the CPU 9-1 reads out the coefficient KA4 (KA3>KA4) from the memory 9-5 (step S130). Next, ΔθX3 is multiplied by the coefficient KA4 to obtain the second ink fountain roller feed rate correction amount ΔNSsp2 (ΔNSsp2=ΔθX3×KA4) (step S131).

The second ink fountain roller feed rate correction amount ΔNSsp2 obtained in step S128 or S131 is added to the current ink fountain roller feed rate correction amount ΔNSspnew stored in the memory 9-5 (if the first correction amount ΔNSsp1 has been obtained, ΔNSspnew obtained by adding ΔNSsp1) to set the next ink fountain roller feed rate correction amount ΔNSspnew (ΔNSspnew (next value)=ΔNSspnew (current value)+ΔNSsp2) (step S132) If ΔNS′ and ΔθX3 have different directions in step S125 (NO in step S125), the CPU 9-1 checks whether the difference between the absolute value of ΔθX3 and that of ΔNS′ exceeds a predetermined threshold value αth (step S129). If the difference between the absolute value of ΔθX3 and that of ΔNS′ exceeds αth (YES in step S129), the CPU 9-1 reads out the coefficient KA4 from the memory 9-5, like the case wherein ΔNS′ and ΔθX3 have different directions in step S126 (step S130). Next, ΔθX3 is multiplied by the coefficient KA4 to obtain the second ink fountain roller feed rate correction amount ΔNSsp2 (ΔNSsp2=ΔθX3×KA4) (step S131).

In the learning of the second ink fountain roller feed rate correction amount ΔNSsp2, if ΔNS′ and ΔθX3 have different directions, and the difference between the absolute value of ΔθX3 and that of ΔNS′ is large, i.e., if the adjustment direction of the ink fountain roller feed rate opposes the adjustment direction of the ink fountain key opening ratio in the third range S3, and the influence of adjustment of the opening ratio is larger than that of the feed rate, the coefficient KA4 smaller than the coefficient KA3 is used to reduce the degree of correction.

Additionally, in the learning of the second ink fountain roller feed rate correction amount ΔNSsp2, if ΔNS′ and ΔθX3 have the same direction, and ΔθY3 and ΔθX3 have different directions, i.e., if the adjustment direction of the ink fountain key opening ratio in the third range S3 opposes the previous direction although the adjustment direction of the ink fountain roller feed rate does not oppose the adjustment direction of the ink fountain key opening ratio in the third range S3, the coefficient KA4 smaller than the coefficient KA3 is used to reduce the degree of correction.

[Learning of Ink Fountain Roller Feed Rate Correction Amount (Third Correction Amount) from Change in Ink Fountain Key Opening Ratio]

The ink fountain key opening ratio correction amount or ink fountain roller feed rate correction amount (first or second correction amount) is obtained in the above-described way. If no ink fountain key corresponds to the image area ratio or image area larger than the second smallest range, and the ink fountain key opening ratio correction amount is obtained, the positive/negative direction of the average value of the differences between the opening ratios of ink fountain keys belonging to the second smallest range after ink supply amount adjustment and the standard opening ratios belonging to the second smallest range before ink supply amount adjustment is compared with the positive/negative direction of the average value of the differences between the opening ratios of ink fountain keys belonging to the minimum range after ink supply amount adjustment and the standard opening ratios belonging to the minimum range before ink supply amount adjustment. If the directions are different, the ink fountain roller feed rate correction amount (third correction amount) is obtained by multiplying the average value of the differences between the opening ratios of ink fountain keys belonging to the second smallest range after ink supply amount adjustment and the standard opening ratios belonging to the second smallest range before ink supply amount adjustment by a predetermined coefficient (KA5).

More specifically, since the second smallest range of the image area ratio or image area is influenced by both the ink fountain key opening ratio and the ink fountain roller feed rate, it is difficult to determine which element has caused the change in tone. Hence, the ink fountain roller feed rate correction amount is not normally learned mainly on the basis of the second smallest range. Only when the adjustment direction of ink fountain keys belonging to the first smallest range (minimum range) opposes that of ink fountain keys belonging to the second smallest range, and no ink fountain key belongs to ranges after the second smallest range, i.e., only when all the ink fountain keys belong to any one of the minimum range and second smallest range, it is determined that the tone is influenced by the ink fountain roller feed rate, and the third ink fountain roller feed rate correction amount is learned.

The learning operation will be described below in detail. The CPU 9-1 learns a third ink fountain roller feed rate correction amount ΔNSsp3 from a change in ink fountain key opening ratio. The third ink fountain roller feed rate correction amount ΔNSsp3 is learned from the average value ΔθX2 of ΔθXi in the second range S2, as shown in FIG. 5C.

First, the CPU 9-1 checks whether an image is present in ranges after the second range S2, i.e., whether neither the third range S3 nor fourth range S4 has an image, and only the first range S1 or second range S2 has an image. If only the first range S1 or second range S2 has an image (NO in step S133), i.e., if no ink fountain key corresponds to an image area ratio larger than the second range S2, it is checked whether the ink fountain key opening ratio correction amount Δθspnew has been learned (step S134).

If the ink fountain key opening ratio correction amount Δθspnew has been learned (YES in step S134), it is checked whether the positive/negative direction of ΔθX1 coincides with that of ΔθX2 (step S135). If ΔθX1 and ΔθX2 have different directions (NO in step S135), the coefficient KA5 is read out from the memory 9-5 (step S136). Next, ΔθX2 is multiplied by the coefficient KA5 to obtain the third ink fountain roller feed rate correction amount ΔNSsp3 (ΔNSsp3=ΔΔθX2×KA5) (step S137).

The obtained third ink fountain roller feed rate correction amount ΔNSsp3 is added to the current ink fountain roller feed rate correction amount ΔNSspnew stored in the memory 9-5 (if the first correction amount ΔNSsp1 or second correction amount ΔNSsp2 has been obtained, ΔNSspnew obtained by adding ΔNSsp1 or ΔNSsp2) to set the next ink fountain roller feed rate correction amount ΔNSspnew (ΔNSspnew (next value)=ΔNSspnew (current value)+ΔNSsp2) (step S138).

More specifically, since the second smallest range of the image area ratio is influenced by both the ink fountain key opening ratio and the ink fountain roller feed rate, it is difficult to determine which element has caused the change in tone. Hence, the ink fountain roller feed rate correction amount is not normally learned mainly on the basis of the second smallest range. In this embodiment, only when the adjustment direction of ink fountain keys belonging to the first range S1 opposes that of ink fountain keys belonging to the second range S2, and no ink fountain key belongs to the third range S3 or subsequent range, it is determined that the tone is influenced by the ink fountain roller feed rate, and the third ink fountain roller feed rate correction amount ΔNSsp3 is learned. The fourth range S4 is determined as inappropriate as the representative value of learning because its use frequency is lower than the first range S1 to third range S3. Hence, learning is not executed only in this portion although the ink fountain key opening ratios are adjusted.

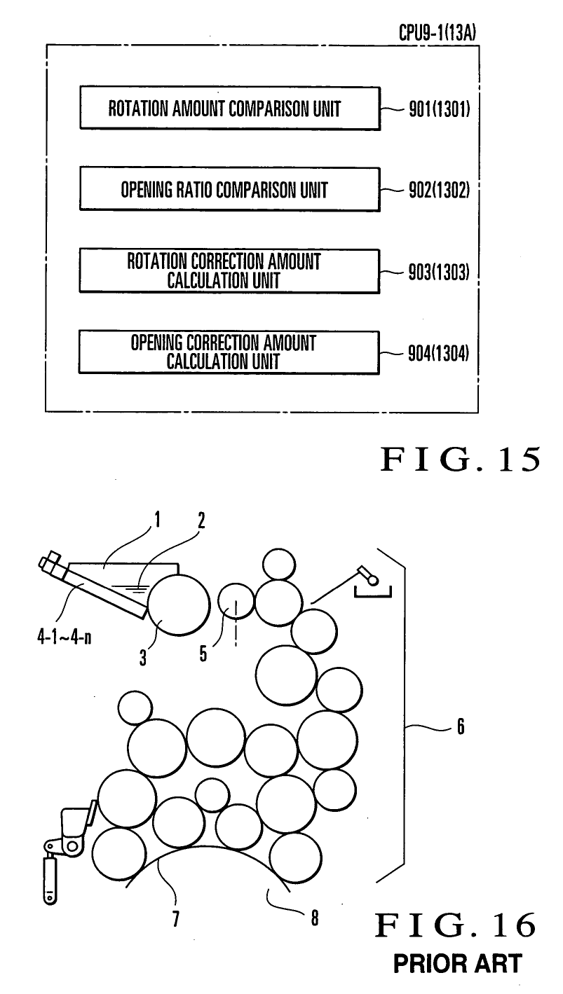

FIG. 15 shows the functional blocks of the CPU 9-1 shown in FIG. 1. Referring to FIG. 15, the CPU 9-1 comprises a rotation amount comparison unit 901 which compares the standard rotation amount of the ink fountain roller 3 preset before ink supply amount adjustment with the rotation amount of the ink fountain roller 3 after ink supply amount adjustment, an opening ratio comparison unit 902 which compares the standard opening ratios of the ink fountain keys 4-1 to 4-n preset before ink supply amount adjustment with the opening ratios of the ink fountain keys 4-1 to 4-n after ink supply amount adjustment, a rotation correction amount calculation unit 903 which obtains the correction amount of the ink fountain roller rotation amount on the basis of at least one of the comparison results of the rotation amount comparison unit 901 and opening ratio comparison unit 902, and an opening correction amount calculation unit 904 which obtains an ink fountain key opening ratio correction amount common to all ink fountain keys on the basis of at least the comparison result of the opening ratio comparison unit 902.

The rotation amount comparison unit 901 executes step S107. The opening ratio comparison unit 902 executes step S117. The rotation correction amount calculation unit 903 executes steps S108 to S114. The opening correction amount calculation unit 904 executes steps S118 to S124.

### First Embodiment

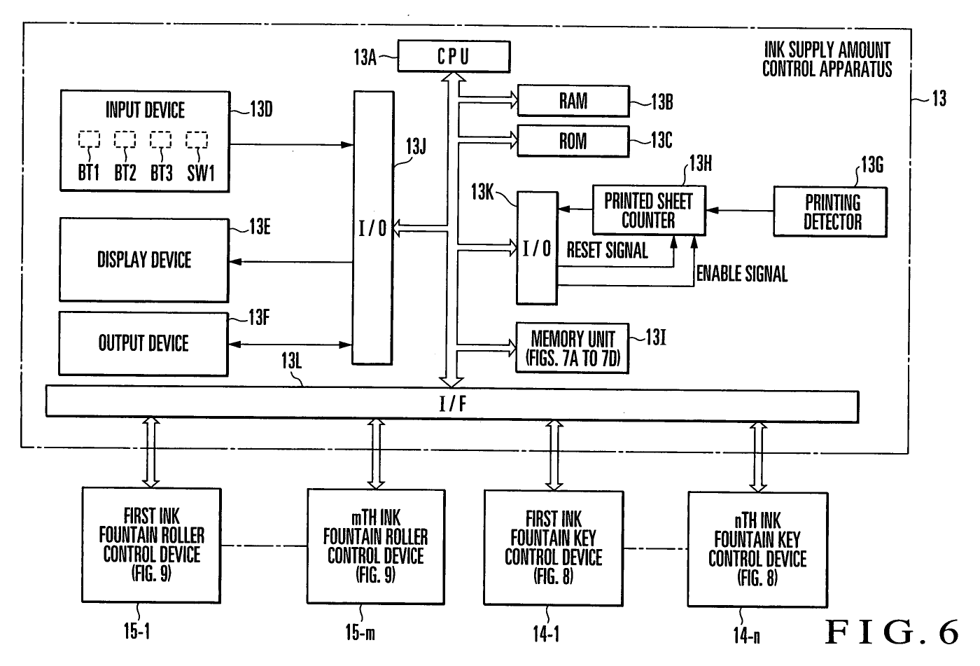

FIG. 6 shows the first embodiment in which the above-described ink supply amount control apparatus is embodied. An ink supply amount control apparatus 13 comprises a CPU 13A, RAM 13B, ROM 13C, input device 13D, display device 13E, output device 13F, printing detector 13G, printed sheet counter 13H, memory unit 13I, and input/output interfaces (I/O, I/F) 13J to 13L. The ink supply amount control apparatus 13 corresponds to the ink supply amount control apparatus 9 shown in FIG. 1.

The CPU 13A operates in accordance with a program stored in the ROM 13C while obtaining various kinds of input information given through the interfaces 13J to 13L and accessing the RAM 13B or memory unit 13I. The input device 13D has a learning button BT1, ink fountain roller feed rate adjustment button BT2 of each color, ink fountain key opening ratio adjustment button BT3 of each color, and learning control mode switch SW1.

Referring to FIG. 6, reference numerals 14-1 to 14-n denote ink fountain key control devices individually provided in correspondence with ink fountain keys 4-1 to 4-n of the respective colors shown in FIG. 16. The ink fountain key control devices 14-1 to 14-n individually adjust the opening ratios of the ink fountain keys 4-1 to 4-n for an ink fountain roller 3. Each of the ink fountain key control devices 14-1 to 14-n corresponds to the ink fountain key control device 12 shown in FIG. 1.

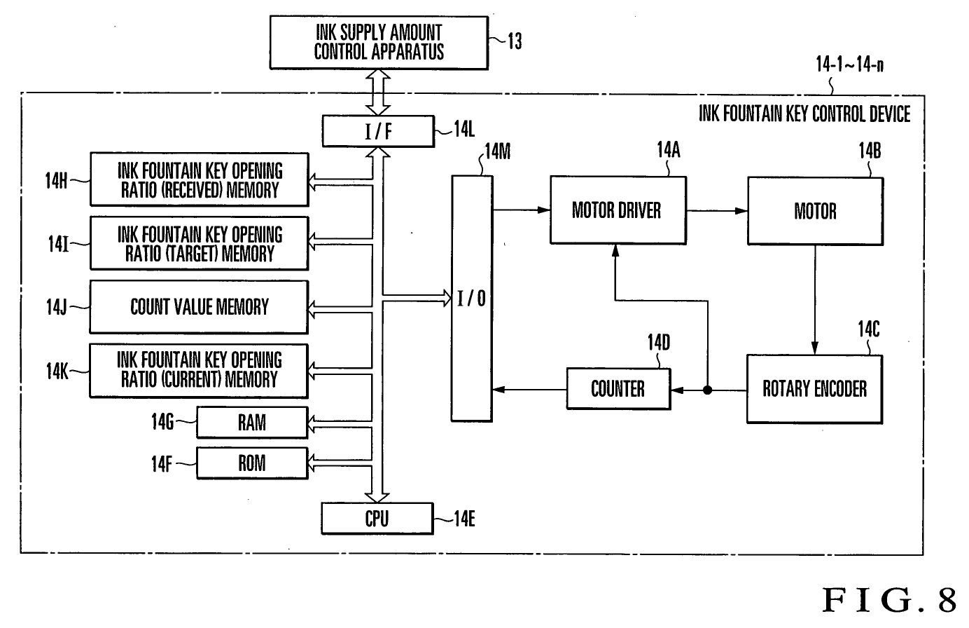

As shown in FIG. 8, each of the ink fountain key control devices 14-1 to 14-n comprises an ink fountain key driving motor driver 14A, ink fountain key driving motor 14B, rotary encoder 14C, counter 14D, CPU 14E, ROM 14F, RAM 14G, memories 14H to 14K, and interfaces (I/O, I/F) 14L and 14M. The CPU 14E is connected to the ink supply amount control apparatus 13 through the interface 14L. The rotary encoder 14C generates a rotation pulse every predetermined rotational speed (angle) of the motor 14B and outputs the pulse to the counter 14D.

The memory 14H stores a received ink fountain key opening ratio. The memory 14I stores a target ink fountain key opening ratio. The memory 14J stores the count value of the counter. The memory 14K stores the current ink fountain key opening ratio.

Referring to FIG. 6, reference numerals 15-1 to 15-m denote ink fountain roller control devices individually provided in correspondence with the ink fountain rollers 3 of the respective colors shown in FIG. 16. The ink fountain roller control devices 15-1 to 15-m individually adjust the feed rates of the ink fountain rollers 3 of the respective colors. Each of the ink fountain roller control devices 15-1 to 15-m corresponds to the ink fountain roller control device 11 shown in FIG. 1.

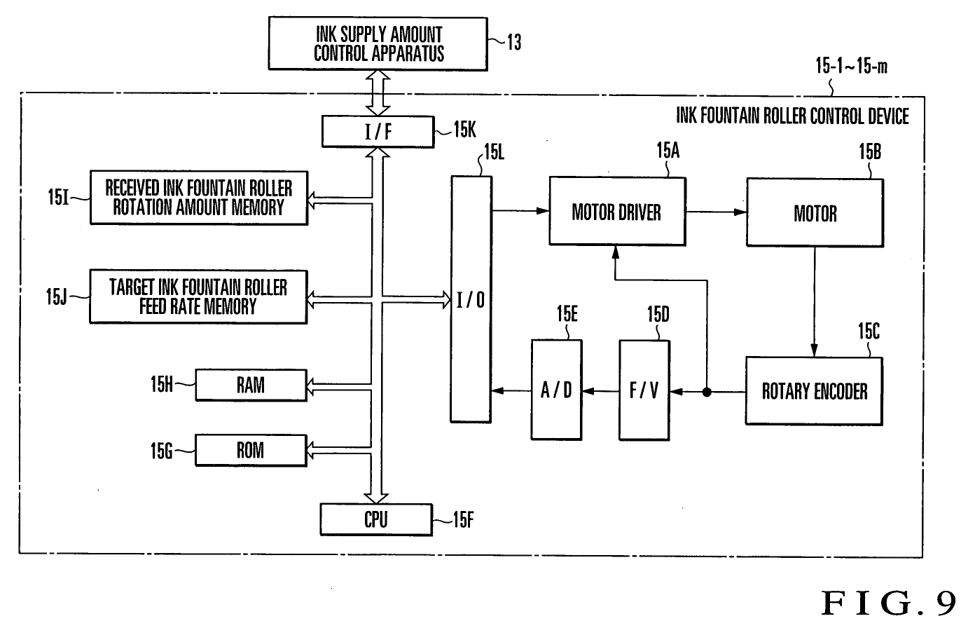

As shown in FIG. 9, each of the ink fountain roller control devices 15-1 to 15-m comprises an ink fountain roller driving motor driver 15A, ink fountain roller driving motor 15B, rotary encoder 15C, F/V converter 15D, A/D converter 15E, CPU 15F, ROM 15G, RAM 15H, memories 151 and 15J, and interfaces (I/O, I/F) 15K and 15L. The CPU 15F is connected to the ink supply amount control apparatus 13 through the interface 15K. The rotary encoder 15C generates a rotation pulse every predetermined rotational speed (angle) of the motor 15B and sends the pulse to the F/V converter 15D. The F/V converter 15D converts the frequency of the rotation pulse from the rotary encoder 15C into a voltage and outputs the voltage to the A/D converter 15E.

The memory 15I stores a received ink fountain roller rotation amount. The memory 15J stores a target ink fountain roller feed rate.

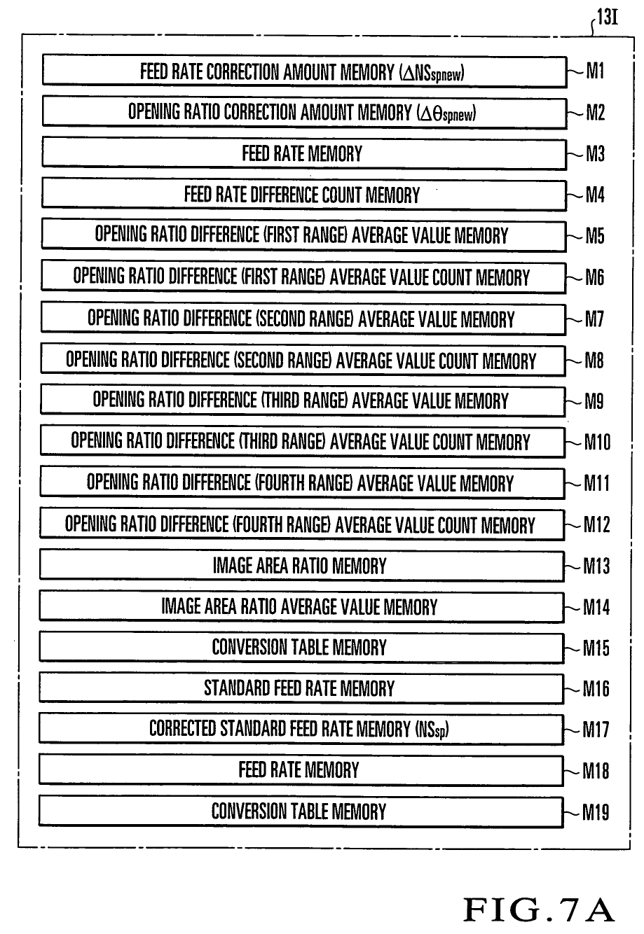

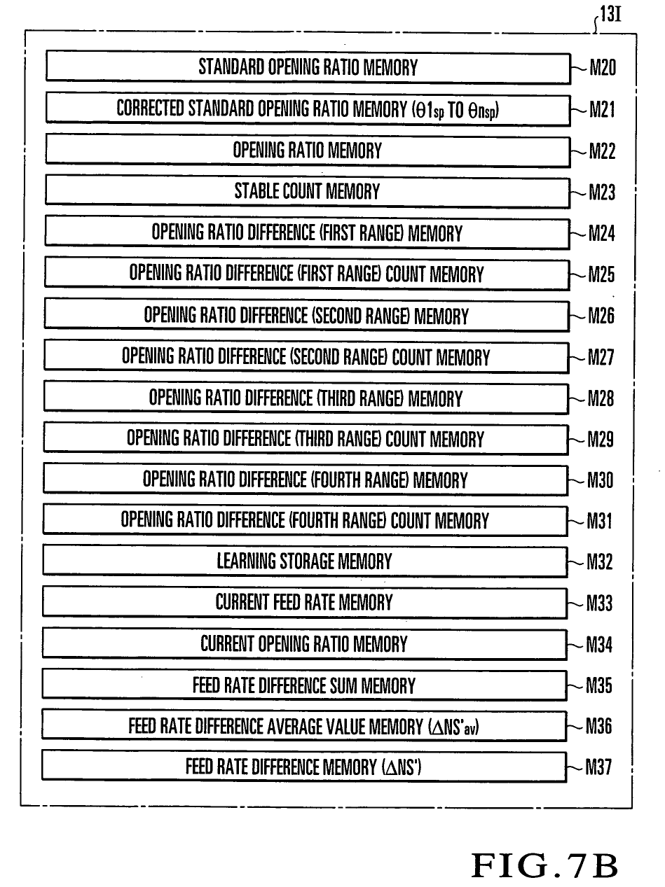

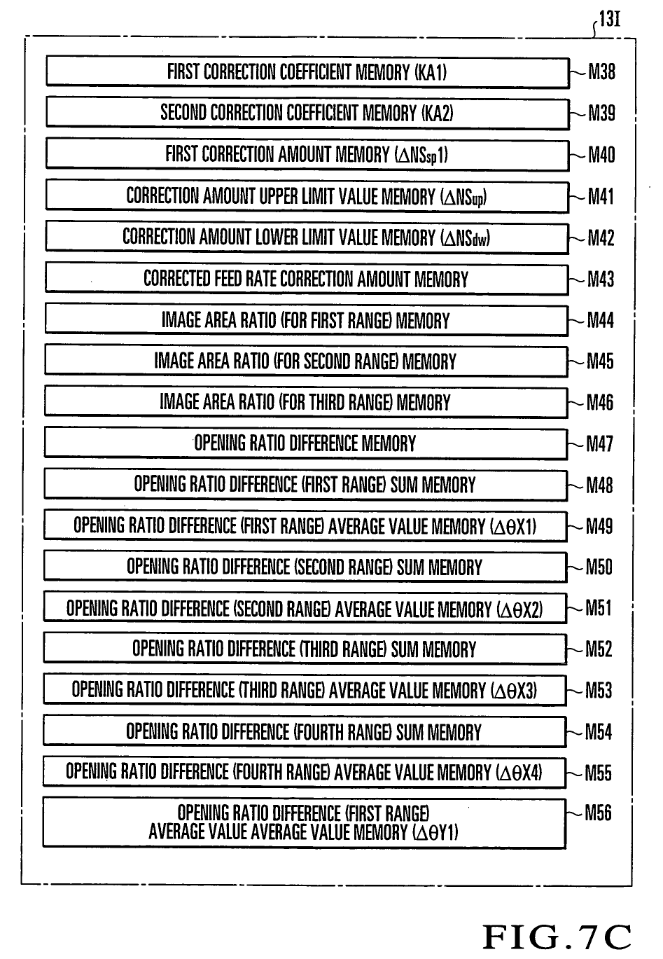

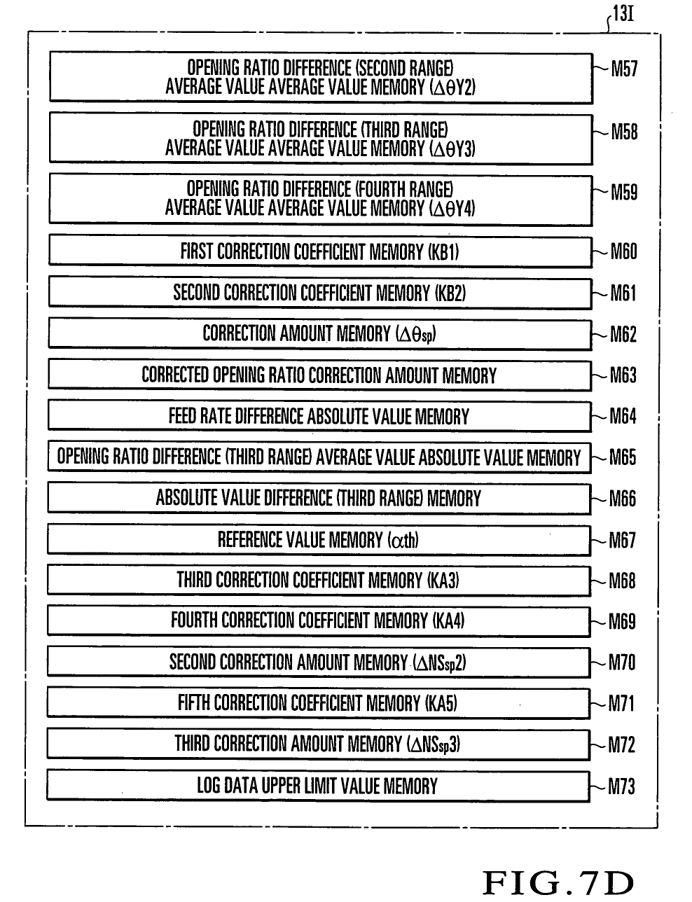

FIGS. 7A to 7D show details of the memory unit 13I in the ink supply amount control apparatus 13. The memory unit 13I has memories M1 to M73. The memory M1 stores ink fountain roller feed rate correction amounts ΔNSspnew of the respective colors. The memory M2 stores ink fountain key opening ratio correction amounts Δθspnew of the respective colors. The memory M3 stores the differences between the past ink fountain roller feed rates of the respective colors after ink supply amount adjustment and the standard feed rates before ink supply amount adjustment. The memory M4 stores the number of differences between the past ink fountain roller feed rates of the respective colors after ink supply amount adjustment and the standard feed rates before ink supply amount adjustment, which are stored in the memory M3.

The memory M5 stores the average values of the differences between the past ink fountain key opening ratios of the respective colors in a first range S1 (FIG. 4) after ink supply amount adjustment and the standard opening ratios before ink supply amount adjustment. The memory M6 stores the number of average values of the differences between the past ink fountain key opening ratios of the respective colors in the first range S1 after ink supply amount adjustment and the standard opening ratios before ink supply amount adjustment, which are stored in the memory M5. The memory M7 stores the average values of the differences between the past ink fountain key opening ratios of the respective colors in a second range S2 after ink supply amount adjustment and the standard opening ratios before ink supply amount adjustment. The memory M8 stores the number of average values of the differences between the past ink fountain key opening ratios of the respective colors in the second range S2 after ink supply amount adjustment and the standard opening ratios before ink supply amount adjustment, which are stored in the memory M7. The memory M9 stores the average values of the differences between the past ink fountain key opening ratios of the respective colors in a third range S3 after ink supply amount adjustment and the standard opening ratios before ink supply amount adjustment. The memory M10 stores the number of average values of the differences between the past ink fountain key opening ratios of the respective colors in the third range S3 after ink supply amount adjustment and the standard opening ratios before ink supply amount adjustment, which are stored in the memory M9. The memory M11 stores the average values of the differences between the past ink fountain key opening ratios of the respective colors in a fourth range S4 after ink supply amount adjustment and the standard opening ratios before ink supply amount adjustment. The memory M12 stores the number of average values of the differences between the past ink fountain key opening ratios of the respective colors in the fourth range S4 after ink supply amount adjustment and the standard opening ratios before ink supply amount adjustment, which are stored in the memory M11.

The memory M13 stores the image area ratios of areas corresponding to the ink fountain keys of the respective colors. The memory M14 stores the average value of the image area ratios. The memory M15 stores the image area ratio−ink fountain roller feed rate conversion tables of the respective colors. The memory M16 stores the standard ink fountain roller feed rates of the respective colors, which are obtained from the image area ratio−ink fountain roller feed rate conversion tables of the respective colors. The memory M17 stores corrected standard feed rates (standard feed rates before ink supply amount adjustment) NSsp of the ink fountain rollers of the respective colors. The memory M18 stores the ink fountain roller feed rates of the respective colors to the ink fountain roller control devices 15.

The memory M19 stores the image area ratio−ink fountain key opening ratio conversion tables of the respective colors. The memory M20 stores the standard ink fountain key opening ratios of the respective colors, which are obtained from the image area ratio−ink fountain key opening ratio conversion tables of the respective colors. The memory M21 stores corrected standard ink fountain key opening ratios (standard opening ratios before ink supply amount adjustment) θ1sp to θnsp. The memory M22 stores the ink fountain key opening ratios to the ink fountain key control devices 14. The memory M23 stores a predetermined stable count.

The memory M24 stores the differences between the current ink fountain key opening ratios of the respective colors in the first range S1 after ink supply amount adjustment and the standard opening ratios before ink supply amount adjustment. The memory M25 stores the number of differences between the current ink fountain key opening ratios of the respective colors in the first range S1 after ink supply amount adjustment and the standard opening ratios before ink supply amount adjustment. The memory M26 stores the differences between the current ink fountain key opening ratios of the respective colors in the second range S2 after ink supply amount adjustment and the standard opening ratios before ink supply amount adjustment. The memory M27 stores the number of differences between the current ink fountain key opening ratios of the respective colors in the second range S2 after ink supply amount adjustment and the standard opening ratios before ink supply amount adjustment. The memory M28 stores the differences between the current ink fountain key opening ratios of the respective colors in the third range S3 after ink supply amount adjustment and the standard opening ratios before ink supply amount adjustment. The memory M29 stores the number of differences between the current ink fountain key opening ratios of the respective colors in the third range S3 after ink supply amount adjustment and the standard opening ratios before ink supply amount adjustment. The memory M30 stores the differences between the current ink fountain key opening ratios of the respective colors in the fourth range S4 after ink supply amount adjustment and the standard opening ratios before ink supply amount adjustment. The memory M31 stores the number of differences between the current ink fountain key opening ratios of the respective colors in the fourth range S4 after ink supply amount adjustment and the standard opening ratios before ink supply amount adjustment.

The memory M32 stores, for each color, information representing whether the ink fountain key opening ratio correction amount is learned. The memory M33 stores the current ink fountain roller feed rates of the respective colors. The memory M34 stores the current ink fountain key opening ratios. The memory M35 stores the sum of differences between the past ink fountain roller feed rates of the respective colors after ink supply amount adjustment and the standard feed rates before ink supply amount adjustment. The memory M36 stores average values ΔNS′av of the differences between the past ink fountain roller feed rates of the respective colors after ink supply amount adjustment and the standard feed rates before ink supply amount adjustment. The memory M37 stores differences ΔNS′ between the current ink fountain roller feed rates of the respective colors after ink supply amount adjustment and the standard feed rates before ink supply amount adjustment.

The memory M38 stores first correction coefficients KA1 of the ink fountain roller feed rates of the respective colors. The memory M39 stores second correction coefficients KA2 of the ink fountain roller feed rates of the respective colors. The memory M40 stores first correction amounts ΔNSsp1 of the current ink fountain roller feed rates of the respective rates. The memory M41 stores upper limit values ΔNSup of the correction amounts of ink fountain roller feed rates of the respective colors. The memory M42 stores lower limit values ΔNSdw of the correction amounts of ink fountain roller feed rates of the respective colors. The memory M43 stores the corrected correction amounts of the ink fountain roller feed rates of the respective colors. The memory M44 stores the image area ratios to determine the first range S1 of the respective colors. The memory M45 stores the image area ratios to determine the second range S2 of the respective colors. The memory M46 stores the image area ratios to determine the third range S3 of the respective colors.

The memory M47 stores the differences between the current ink fountain key opening ratios after ink supply amount adjustment and the standard opening ratios before ink supply amount adjustment. The memory M48 stores the sum of the differences between the current ink fountain key opening ratios of the respective colors in the first range S1 after ink supply amount adjustment and the standard opening ratios before ink supply amount adjustment. The memory M49 stores average values ΔθX1 of the differences between the current ink fountain key opening ratios of the respective colors in the first range S1 after ink supply amount adjustment and the standard opening ratios before ink supply amount adjustment. The memory M50 stores the sum of the differences between the current ink fountain key opening ratios of the respective colors in the second range S2 after ink supply amount adjustment and the standard opening ratios before ink supply amount adjustment. The memory M51 stores average values ΔθX2 of the differences between the current ink fountain key opening ratios of the respective colors in the second range S2 after ink supply amount adjustment and the standard opening ratios before ink supply amount adjustment.

The memory M52 stores the sum of the differences between the current ink fountain key opening ratios of the respective colors in the third range S3 after ink supply amount adjustment and the standard opening ratios before ink supply amount adjustment. The memory M53 stores average values ΔθX3 of the differences between the current ink fountain key opening ratios of the respective colors in the third range S3 after ink supply amount adjustment and the standard opening ratios before ink supply amount adjustment. The memory M54 stores the sum of the differences between the current ink fountain key opening ratios of the respective colors in the fourth range S4 after ink supply amount adjustment and the standard opening ratios before ink supply amount adjustment. The memory M55 stores average values ΔθX4 of the differences between the current ink fountain key opening ratios of the respective colors in the fourth range S4 after ink supply amount adjustment and the standard opening ratios before ink supply amount adjustment.

The memory M56 stores average values ΔθY1 of the average values of the differences between the past ink fountain key opening ratios of the respective colors in the first range S1 after ink supply amount adjustment and the standard opening ratios before ink supply amount adjustment. The memory M57 stores average values ΔθY2 of the average values of the differences between the past ink fountain key opening ratios of the respective colors in the second range S2 after ink supply amount adjustment and the standard opening ratios before ink supply amount adjustment. The memory M58 stores average values ΔθY3 of the average values of the differences between the past ink fountain key opening ratios of the respective colors in the third range S3 after ink supply amount adjustment and the standard opening ratios before ink supply amount adjustment. The memory M59 stores average values ΔθY4 of the average values of the differences between the past ink fountain key opening ratios of the respective colors in the fourth range S4 after ink supply amount adjustment and the standard opening ratios before ink supply amount adjustment.

The memory M60 stores first correction coefficients KB1 of the ink fountain key opening ratios of the respective colors. The memory M61 stores second correction coefficients KB2 of the ink fountain key opening ratios of the respective colors. The memory M62 stores correction amounts Δθsp of the current ink fountain key opening ratios of the respective colors. The memory M63 stores the corrected correction amounts of the ink fountain key opening ratios of the respective colors. The memory M64 stores the absolute values of differences ΔNS′ between the current ink fountain roller feed rates of the respective colors after ink supply amount adjustment and the standard feed rates before ink supply amount adjustment. The memory M65 stores the absolute values of the average values ΔθX3 of the differences between the current ink fountain key opening ratios of the respective colors in the third range S3 after ink supply amount adjustment and the standard opening ratios before ink supply amount adjustment. The memory M66 stores the difference between the absolute value of ΔθX3 and the absolute value of ΔNS′.

The memory M67 stores a reference value (necessity determination reference value) αth to determine the necessity of correction of the ink fountain roller feed rate correction amounts of the respective colors. The memory M68 stores third correction coefficients KA3 of the ink fountain roller feed rates of the respective colors. The memory M69 stores fourth correction coefficients KA4 of the ink fountain roller feed rates of the respective colors. The memory M70 stores second correction amounts ΔNSsp2 of the current ink fountain roller feed rates of the respective colors. The memory M71 stores fifth correction coefficients KA5 of the ink fountain roller feed rates of the respective colors. The memory M72 stores third correction amounts ΔNSsp3 of the ink current fountain roller feed rates. The memory M73 stores the upper limit value of the number of stored differences (log data) between the past ink supply amounts after ink supply amount adjustment and the standard ink supply amounts before ink supply amount adjustment.

[Learning of Ink Fountain Roller Feed Rate Correction Amount and Ink Fountain Key Opening Ratio Correction Amount]

As a prerequisite, the same learning operation of the ink fountain roller feed rate correction amount and ink fountain key opening ratio correction amount as described above was executed in the past. As a learning result, the next ink fountain roller feed rate correction amount ΔNSspnew is stored in the memory M1. The next ink fountain key opening ratio correction amount Δθspnew, which is common to all ink fountain keys (to be referred to as all ink fountain keys hereinafter) of the respective colors, is stored in the memory M2.

Every time the correction amounts were learned in the past, the difference between the ink fountain roller feed rate after ink supply amount adjustment and the standard feed rate before ink supply amount adjustment used at that time was stored in the memory M3. The number of differences is stored in the memory M4. In addition, every time the correction amounts were learned in the past, the average values of the ink fountain key opening ratios of the respective colors in the ranges S1, S2, S3, and S4 after ink supply amount adjustment and the standard opening ratios before ink supply amount adjustment used at that time were stored in the memories M5, M7, M9, and M11. The numbers of average values are stored in the memories M6, M8, M10, and M12.

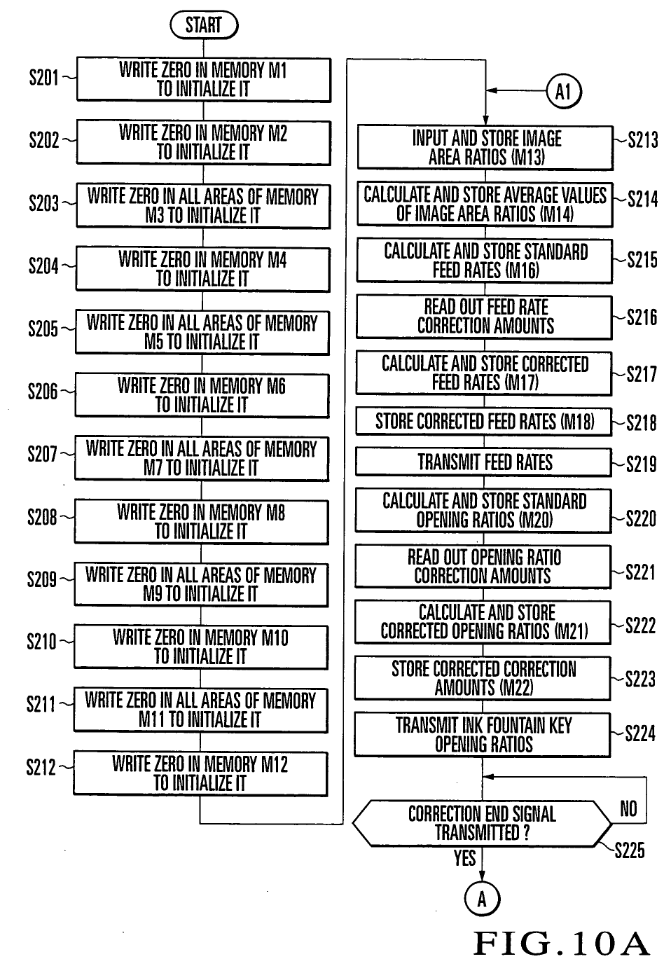

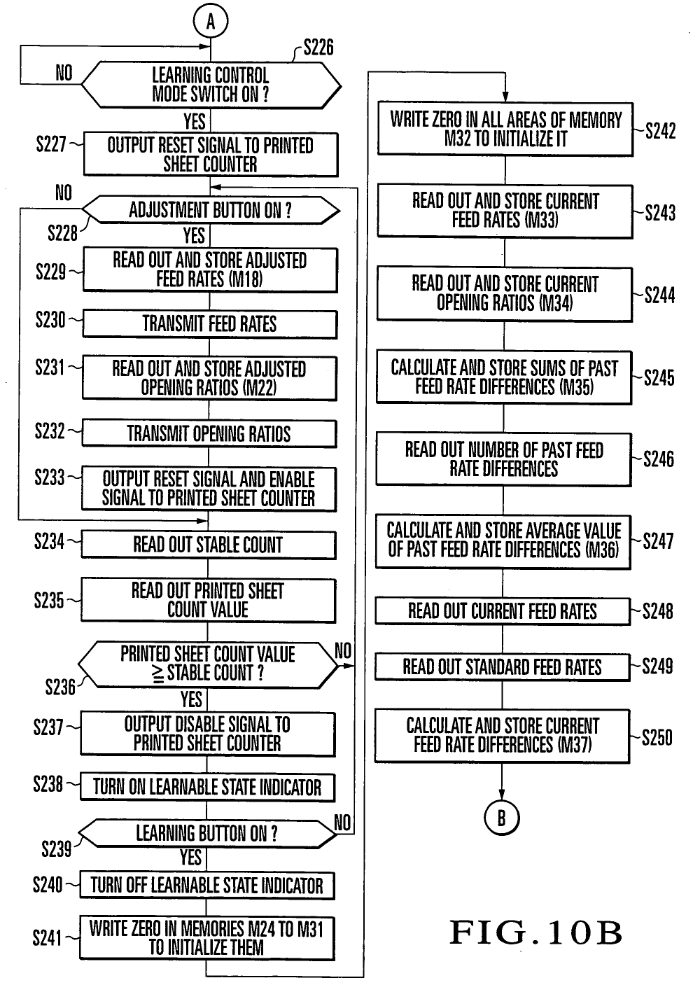

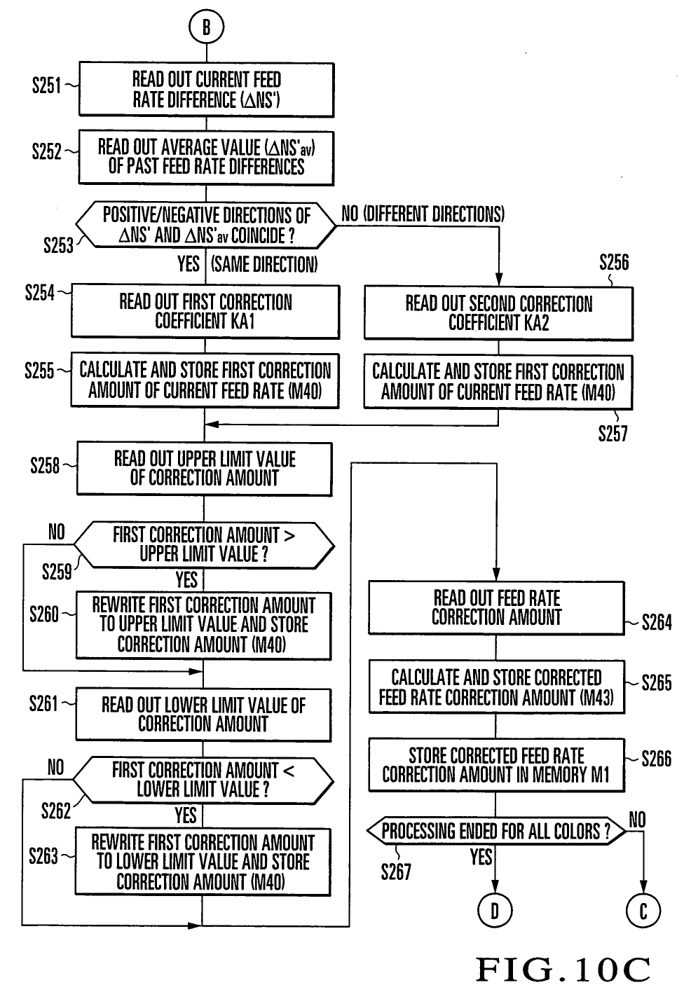

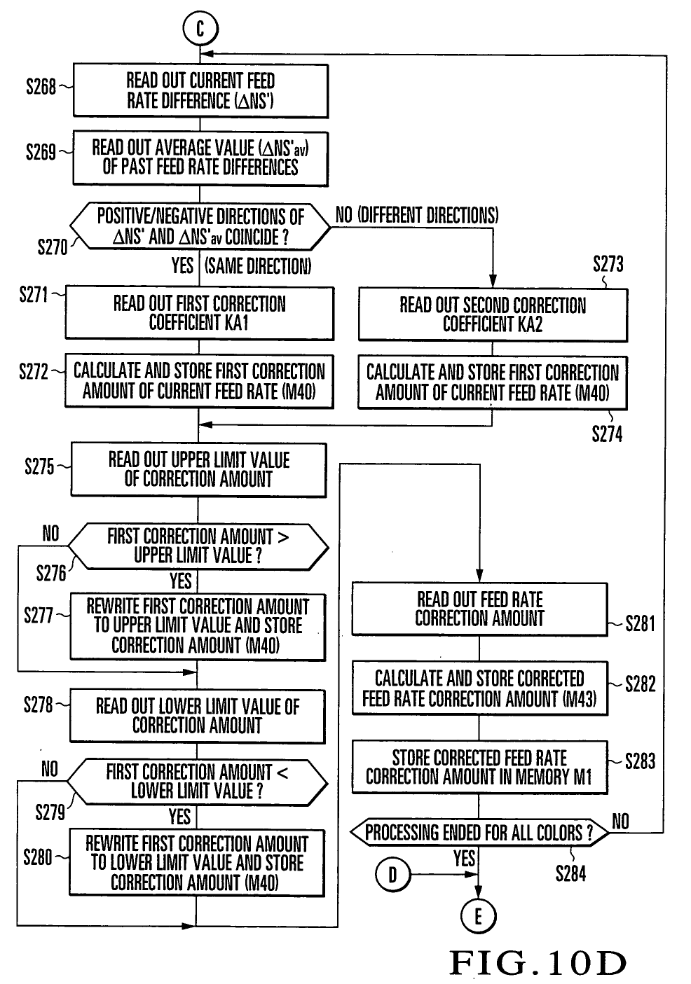

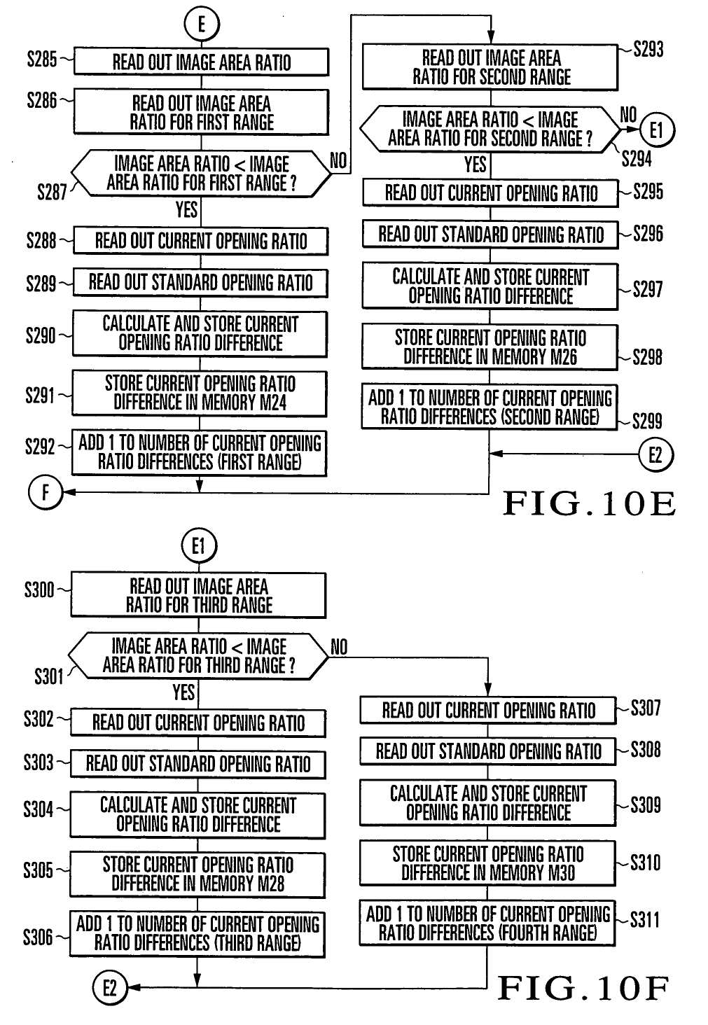

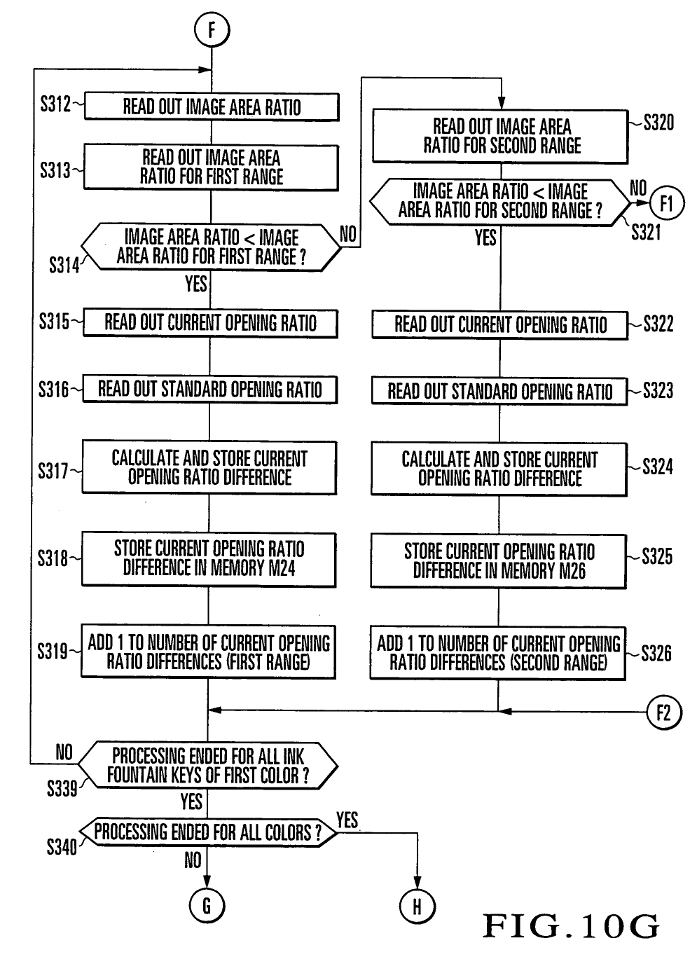

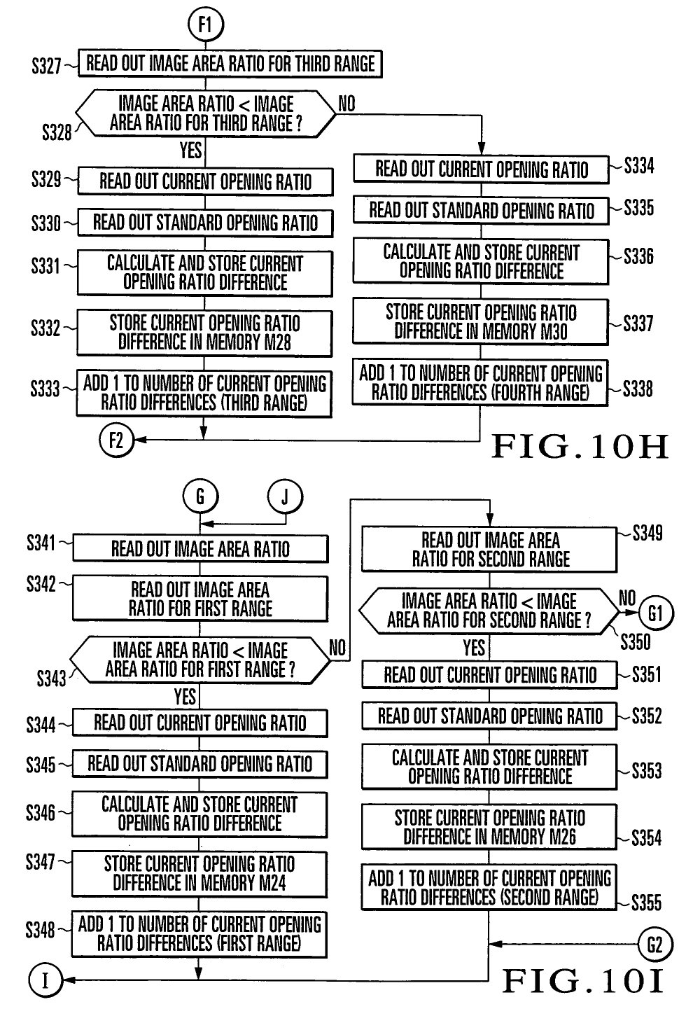

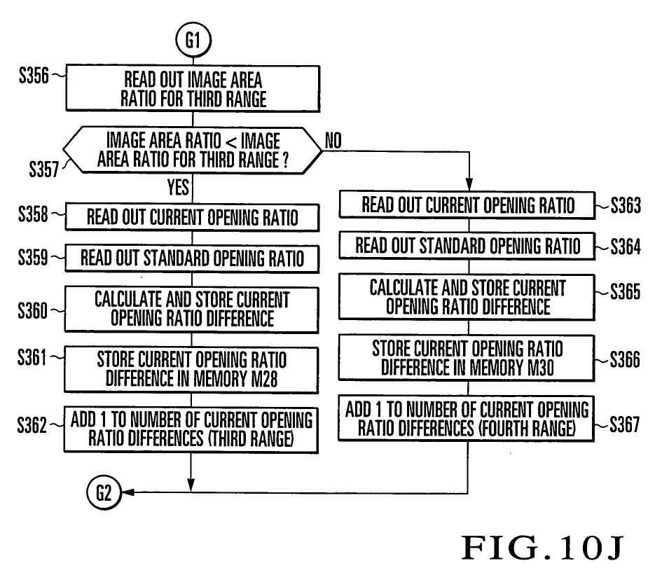

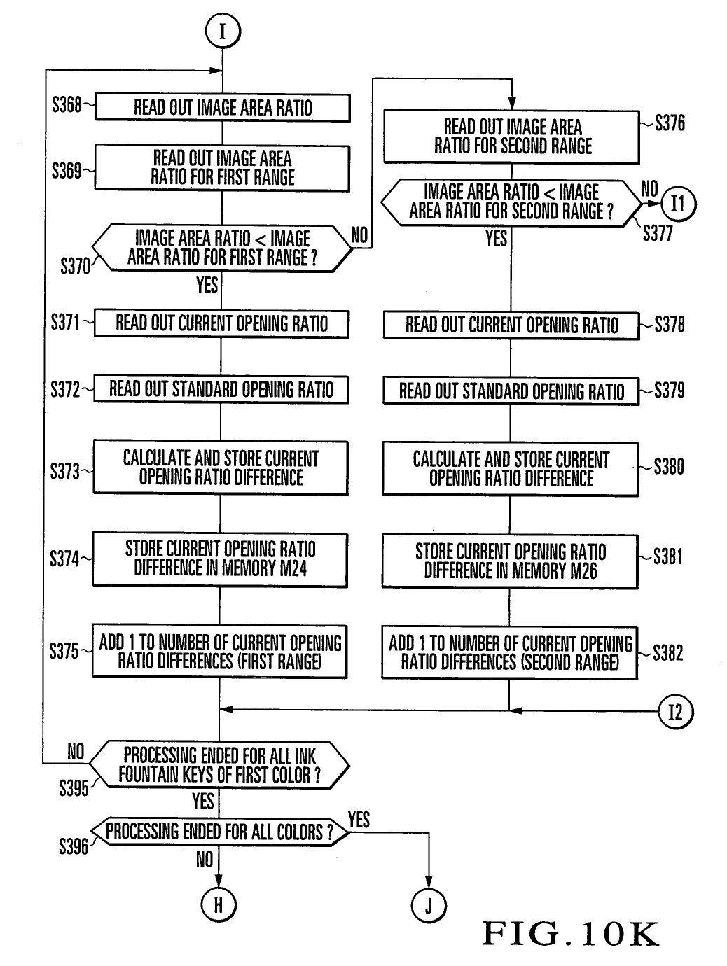

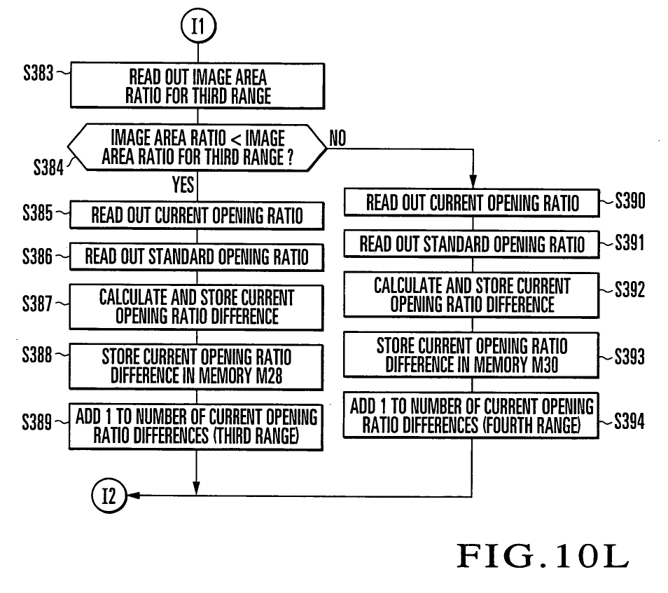

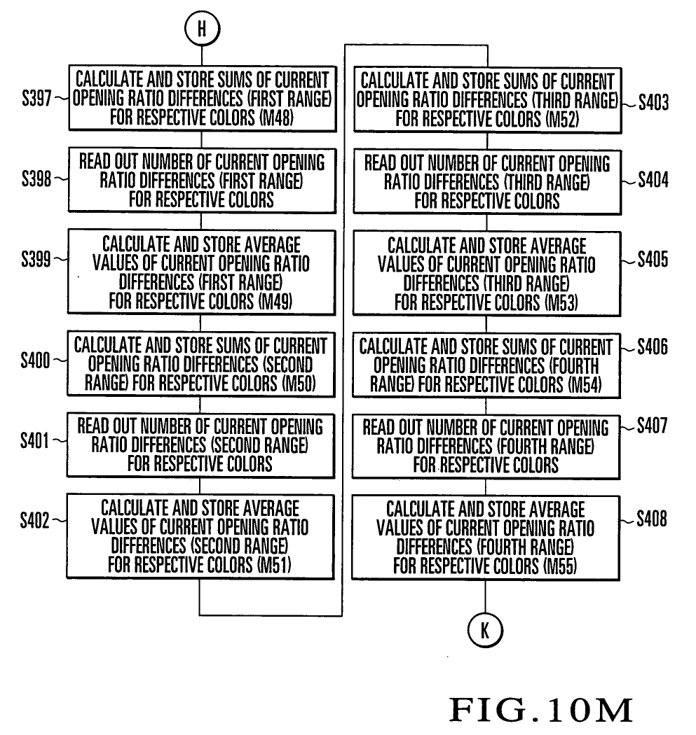

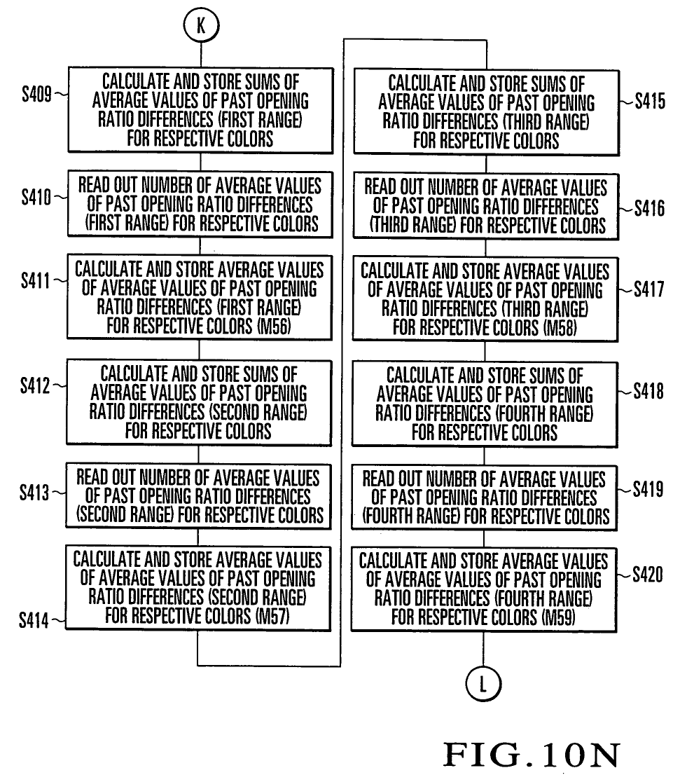

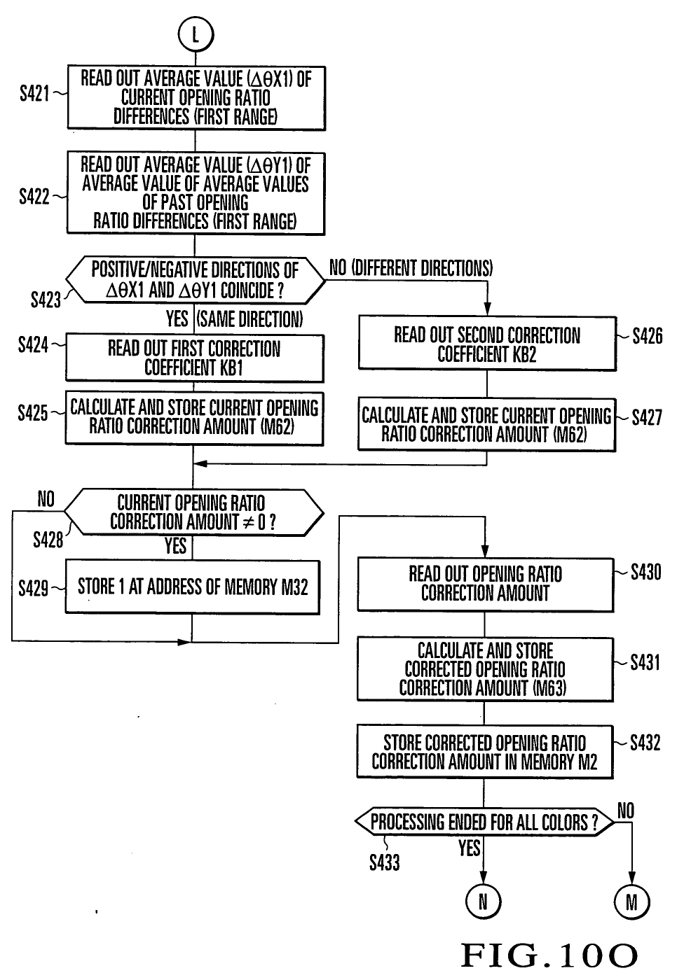

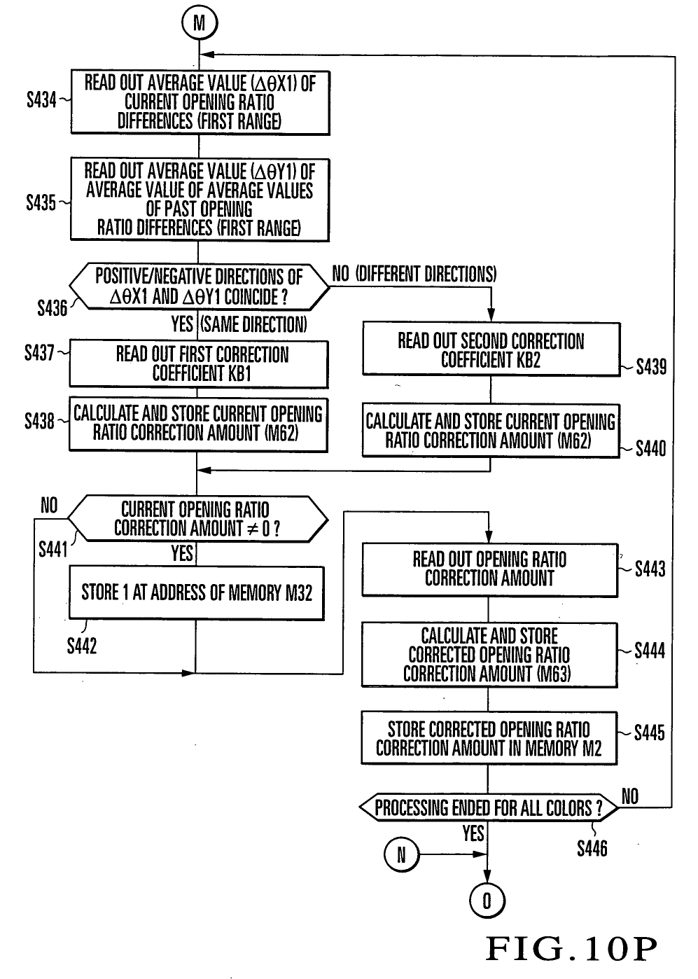

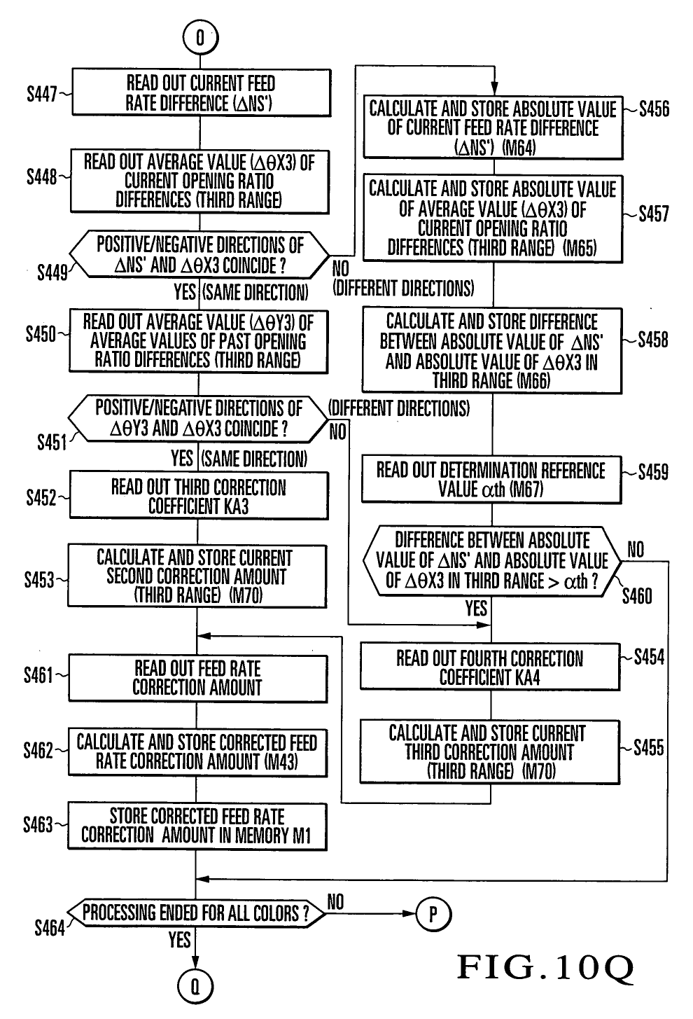

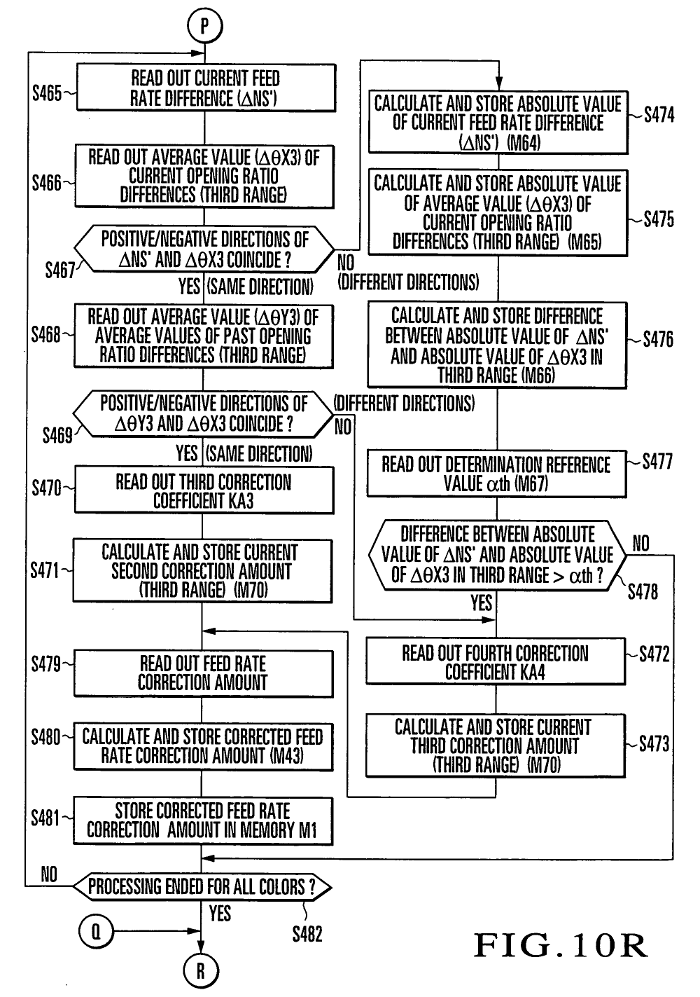

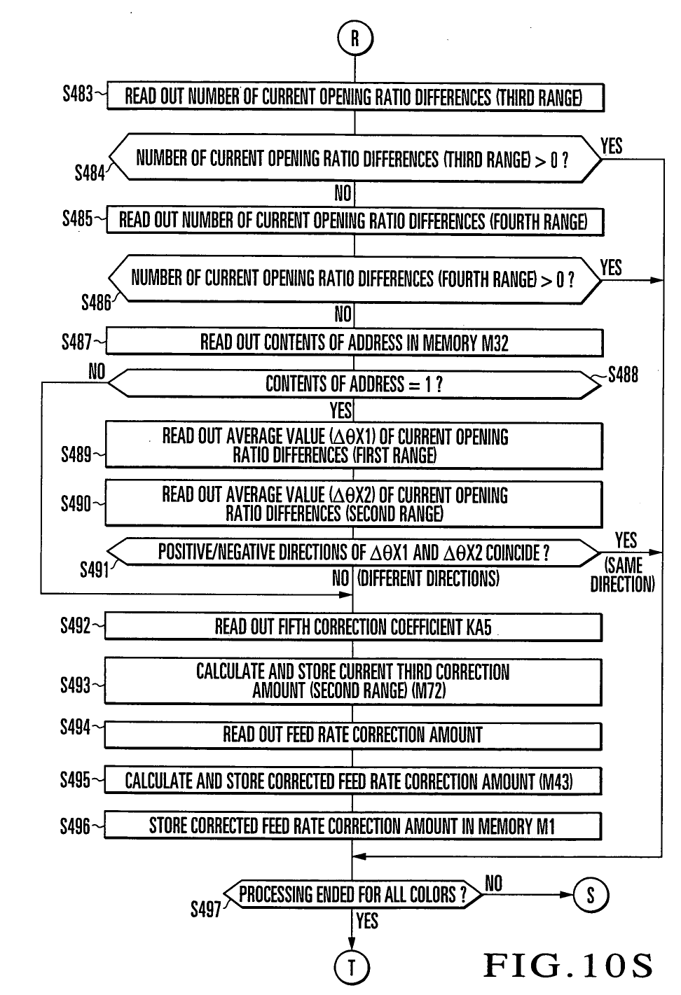

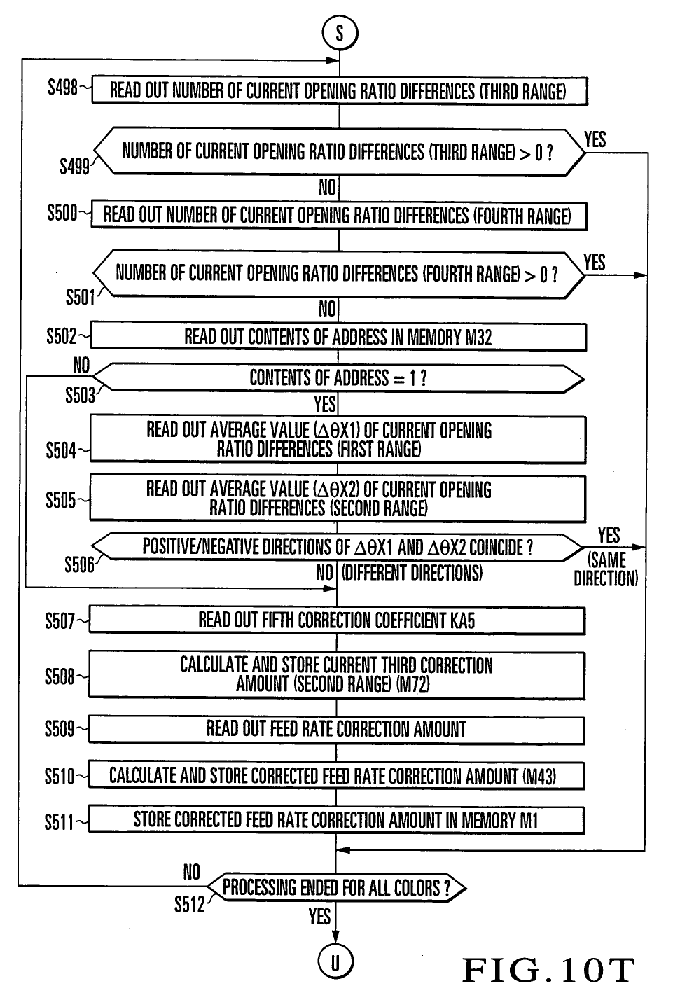

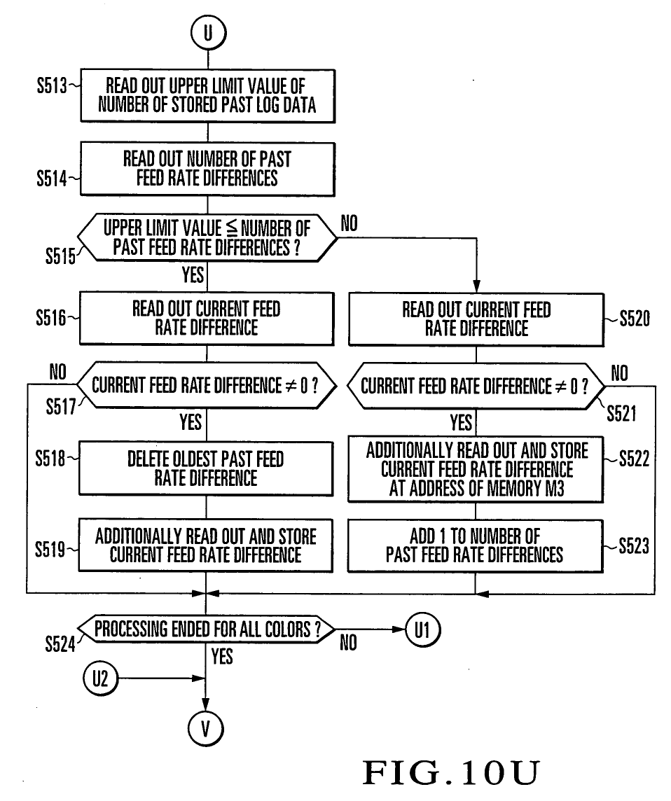

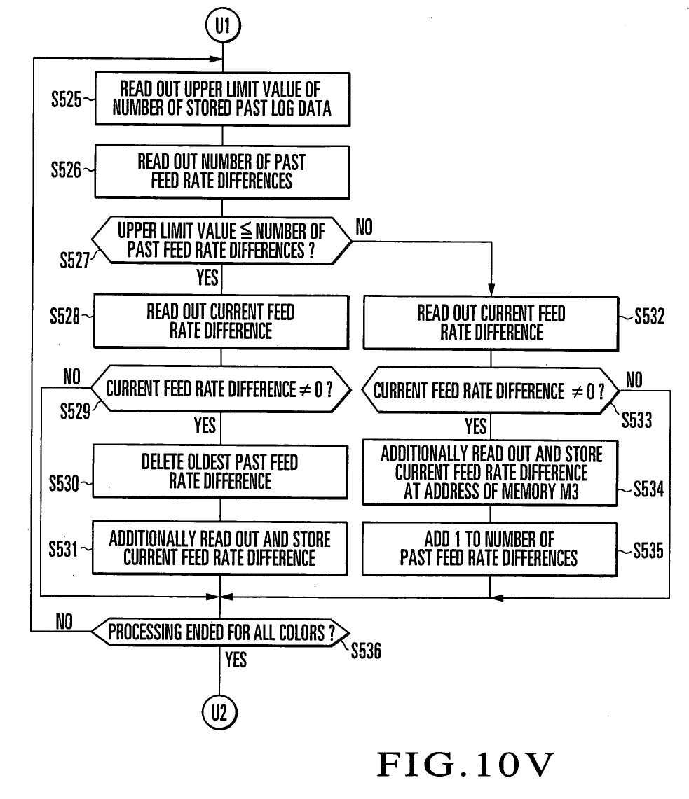

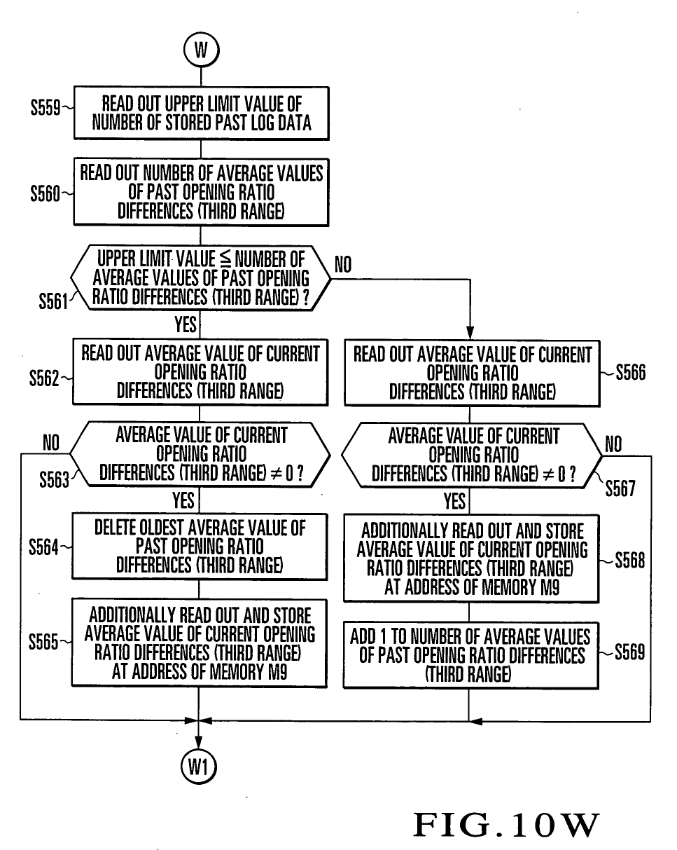

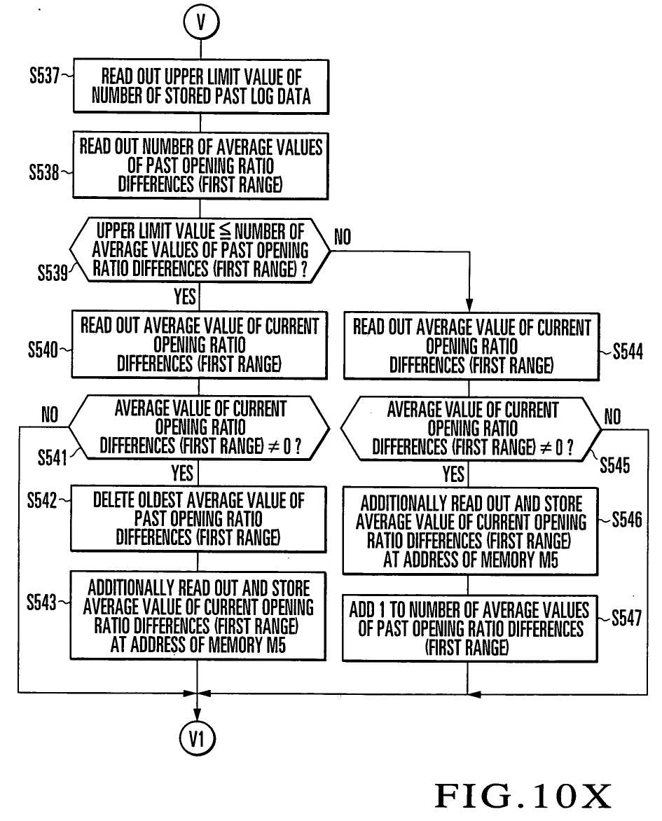

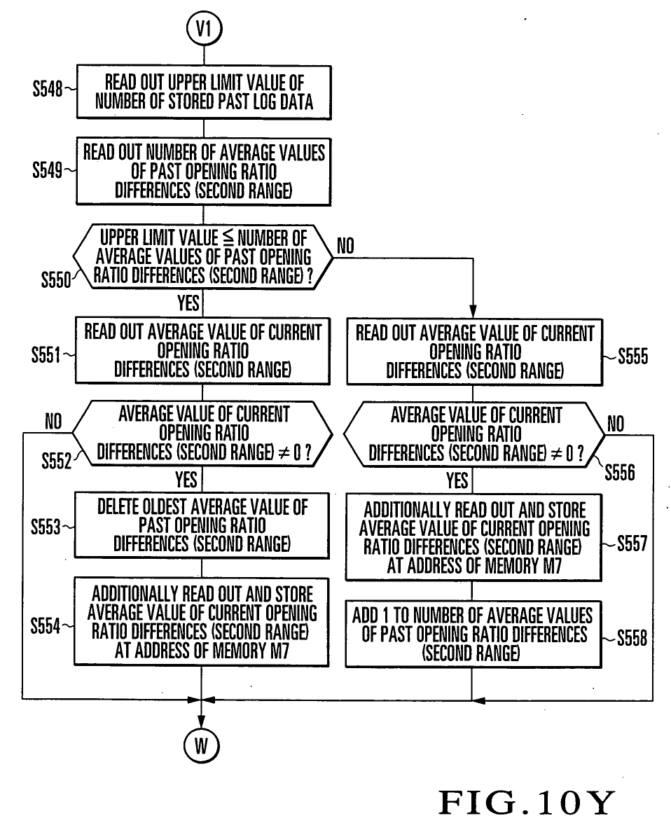

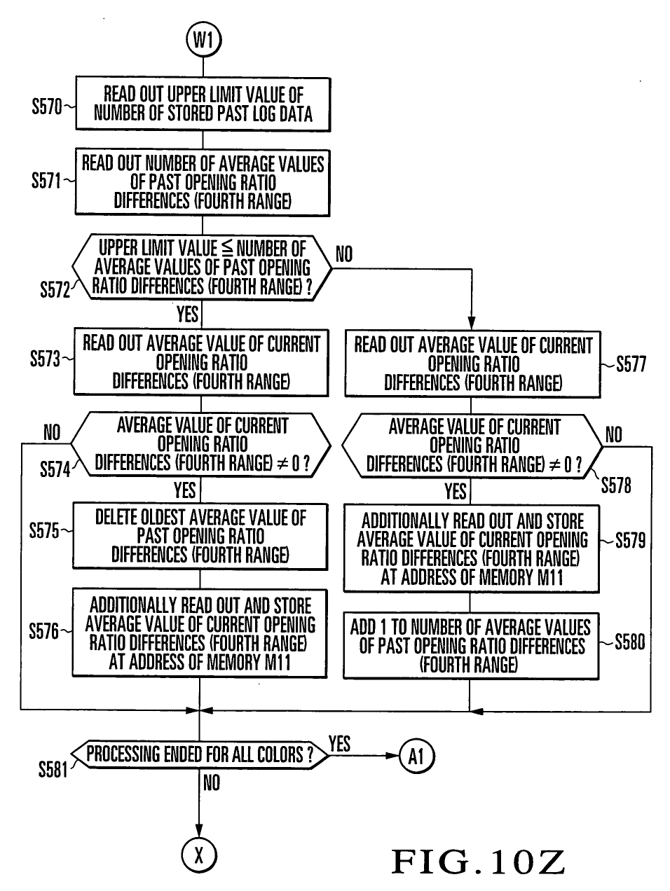

Referring to FIG. 16, a printing plate 7 is mounted. The feed rate of the ink fountain roller 3 and the opening ratios of the ink fountain keys 4-1 to 4-n are preset. In this case, the CPU 13A of the ink supply amount control apparatus 13 starts processing from step S213 shown in FIG. 10A on the basis of the above-described prerequisites. In steps S201 to S212, the memories M1 to M12 are initialized to set their contents to “0”. This processing is executed only in learning the initial correction amount.

In step S213, the CPU 13A stores, in the memory M13, the image area ratios of the printing plate 7 in ranges corresponding to the ink fountain keys of the respective colors input by the operator. In this example, a flexible disk on which the image area ratios of areas corresponding to the ink fountain keys of the respective colors are written is set in the output device 13F. The CPU 13A reads out the image area ratios of areas corresponding to the ink fountain keys of the respective colors from the flexible disk set in the output device 13F and stores the image area ratios in the memory M13.

In this embodiment, to measure the image area ratio in each range of the printing plate, an “image area ratio measuring device” disclosed in patent reference 3 or 4 by the present applicant is used. The image area ratio measured by using the “image area ratio measuring device” is written on a flexible disk. The flexible disk on which the image area ratio is written is set in the output device 13F. The CPU 13A and the “image area ratio measuring device” may be connected online to directly receive the image area ratio in each range of the printing plate from the “image area ratio measuring device”.

The CPU 13A obtains the average values of the image area ratios of the respective colors from the image area ratios of the areas corresponding to the ink fountain keys of the respective colors, which are stored in the memory M13, and stores the average values in the memory M14 (step S214). Next, by using the image area ratio average value—ink fountain roller feed rate conversion tables of the respective colors in the memory M15, the standard ink fountain roller feed rates (standard feed rates before correction) of the respective colors are obtained from the average values of the image area ratios of the respective colors and stored in the memory M16 (step S215).

The ink fountain roller feed rate correction amounts ΔNSspnew (the correction amounts obtained by preceding learning) of the respective colors are read out from the memory M1 (step S216). The readout ink fountain roller feed rate correction amounts ΔNSspnew of the respective colors are added to the standard ink fountain roller feed rates of the respective colors obtained in step S215. The resultant values are stored in the memory M17 as the standard ink fountain roller feed rates of the respective colors before ink supply amount adjustment (step S217). The standard ink fountain roller feed rates Nsp of the respective colors before ink supply amount adjustment are set in the memory M18 (step S218) and transmitted to the ink fountain roller control devices 15 (FIG. 9) of the respective colors (step S219).

As shown in FIG. 12, upon receiving the standard ink fountain roller feed rate Nsp from the ink supply amount control apparatus 13 (YES in step S701), the CPU 15F of the ink fountain roller control device 15 of each color stores the received standard ink fountain roller feed rate Nsp in the memory 15I (step S702). In addition, the received standard ink fountain roller feed rate Nsp is written in the memory 15J as a target feed rate (step S703). The target feed rate is read out from the memory 15J (step S704) and sent to the ink fountain roller driving motor driver 15A so that the feed rate of the ink fountain roller driving motor 15B is set to the target feed rate (standard feed rate Nsp) (step S705).

After the standard feed rates are transmitted to the ink fountain roller control devices 15 of the respective colors in step S219, the CPU 13A of the ink supply amount control apparatus 13 obtains the standard opening ratio (standard opening ratio before correction) of each ink fountain key from the image area ratio in a range corresponding to each ink fountain key by using the image area ratio−ink fountain key opening ratio conversion table in the memory M19 and stores the standard opening ratio in the memory M20 (step S220).

Next, the ink fountain key opening ratio correction amounts Δθspnew (correction amounts obtained by preceding learning) of the respective colors are read out from the memory M2 (step S221). The readout ink fountain key opening ratio correction amounts Δθspnew of the respective colors are added to the standard ink fountain key opening ratios obtained in step S220. The results are stored in the memory M21 as standard ink fountain keys opening ratios θ1sp to θnsp of the respective colors before ink supply amount adjustment (step S222). The standard ink fountain keys opening ratios θ1sp to θnsp of the respective colors before ink supply amount adjustment are set in the memory M22 (step S223) and transmitted to the ink fountain key control devices 14 of the respective colors (step S224).

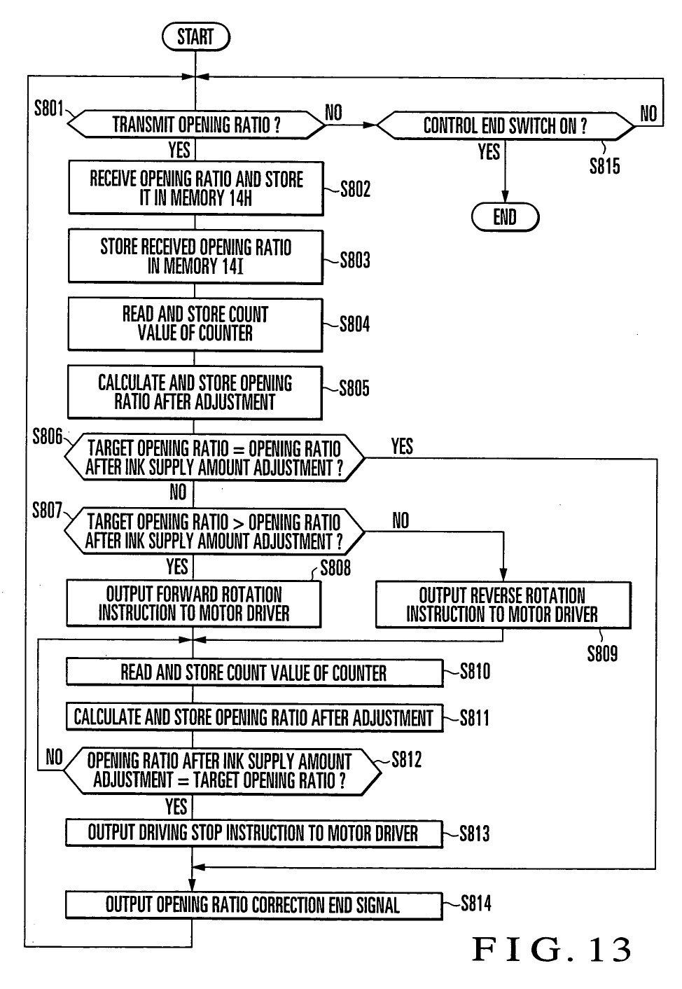

As shown in FIG. 13, upon receiving the ink fountain key opening ratio from the ink supply amount control apparatus 13 (YES in step S801), the CPU 14E of the ink fountain key control device 14 (FIG. 8) of each color stores the received opening ratio in the memory 14H (step S802) and writes the received opening ratio in the memory 14I as a target opening ratio (step S803). The count value of the counter 14D is read (step S804). The current ink fountain key opening ratio is obtained from the count value of the counter 14D (step S805). If the current ink fountain key opening ratio equals the target opening ratio (YES in step S806), the flow immediately advances to step S814 to output an ink fountain key opening ratio correction end signal to the ink supply amount control apparatus 13.

If the current ink fountain key opening ratio does not equal the target opening ratio (NO in step S806), the ink fountain key driving motor 14B is driven until the current ink fountain key opening ratio equals the target opening ratio (corrected opening ratio) (steps S807 to S813). Then, an ink fountain key opening ratio correction end signal is output to the ink supply amount control apparatus 13 (step S814).

Upon receiving the ink fountain key opening ratio correction end signals from all ink fountain key control devices 14 (YES in step S225 shown in FIG. 10A), the CPU 13A of the ink supply amount control apparatus 13 advances to step S226 (FIG. 10B). With the above processing, the feed rates of the ink fountain rollers 3 are preset to the standard feed rates NSsp, and the opening ratios of the ink fountain keys 4-1 to 4-n of the respective colors are preset to the standard opening ratios θ1sp to θnsp.

The operator starts printing in the preset state. After checking the color of the printing product printed in the preset state, a learning control mode switch SW1 is turned on. An ink fountain roller feed rate adjustment button BT2 or ink fountain key opening ratio adjustment button BT3 is operated to finely tune the feed rates of the ink fountain rollers 3 or the opening ratios of the ink fountain keys 4-1 to 4-n such that a desired tone can be obtained. Then, printing is restarted.

When the learning control mode switch SW1 is turned on (YES in step S226), the CPU 13A of the ink supply amount control apparatus 13 sends a reset signal to the printed sheet counter 13H to reset the count value to zero (step S227). In accordance with the operation of the ink fountain roller feed rate adjustment button BT2 or ink fountain key opening ratio adjustment button BT3 (YES in step S228), the ink fountain roller feed rates of the respective colors, which are adjusted by the ink fountain roller feed rate adjustment buttons BT2 of the respective colors, are set in the memory M18 (step S229) and transmitted to the ink fountain roller control devices 15 (step S230). In addition, the ink fountain key opening ratios which are adjusted by the ink fountain key opening ratio adjustment buttons BT3 of the respective colors are set in the memory M22 (step S231) and transmitted to the ink fountain key control devices 14 of the respective colors (step S232). A reset signal and enable signal are sent to the printed sheet counter 13H to start the count operation (step S233).

The CPU 13A monitors the count value of the printed sheet counter 13H. If the count value has reached the stable count stored in the memory M23 (YES in step S236), a disable signal is sent to the printed sheet counter 13H to stop the operation (step S237). Next, a message representing the learnable state is displayed on the display device 13E (step S238).

When the learning button BT1 is turned on (YES in step S239), the CPU 13A turns off the display of the learnable state on the display device 13E (step S240) and initializes the memories M24 to M31 to “0” (step S241). In addition, “0” is written in all areas of the memory M32 which stores the presence/absence of ink fountain key opening ratio correction amount learning to initialize the memory (step S242).

The current ink fountain roller feed rates of the respective colors, i.e., the ink fountain roller feed rates NS′ of the respective colors after ink supply amount adjustment are read out from the memory M18 and written in the memory M33 (step S243). The current ink fountain key opening ratios of the respective colors, i.e., the ink fountain key opening ratios θ1′ to θn′ of the respective colors after ink supply amount adjustment are read out from the memory M22 and written in the memory M34 (step S244).

[Learning of Ink Fountain Roller Feed Rate Correction Amount (First Correction Amount) from Change in Ink Fountain Roller Feed Rate]

The CPU 13A obtains the sum of differences between the past ink fountain roller feed rates of the respective colors after ink supply amount adjustment and the standard feed rates before ink supply amount adjustment from the differences between the past ink fountain roller feed rates of the respective colors after ink supply amount adjustment and the standard feed rates before ink supply amount adjustment, which are stored in the memory M3, and writes the sum in the memory M35 (step S245).

The number of differences between the past ink fountain roller feed rates of the respective colors after ink supply amount adjustment and the standard feed rates before ink supply amount adjustment, which is stored in the memory M4, is read out (step S246). The sum obtained in step S245 is divided by the number read out in step S246 to obtain the average values ΔNS′av of the differences between the past ink fountain roller feed rates of the respective colors after ink supply amount adjustment and the standard feed rates before ink supply amount adjustment. The average values ΔNS′av are stored in the memory M36 (step S247).

The current ink fountain roller feed rates (feed rates after ink supply amount adjustment) NS′ of the respective colors are read out from the memory M33 (step S248). The standard ink fountain roller feed rates NSsp of the respective colors before ink supply amount adjustment are read out from the memory M17 (step S249). The differences ΔNS′ between the ink fountain roller feed rates NS′ after ink supply amount adjustment and the standard feed rates NSsp before ink supply amount adjustment are obtained and stored in the memory M37 (step S250).

The difference ΔNS′ between the current ink fountain roller feed rate of the first color after ink supply amount adjustment and the standard feed rate before ink supply amount adjustment is read out from the memory M37 (step S251 shown in FIG. 10C). The average value ΔNS′av between the past ink fountain roller feed rate of the first color after ink supply amount adjustment and the standard feed rate before ink supply amount adjustment is read out from the memory M36 (step S252). It is checked whether the positive/negative direction of ΔNS′ and that of ΔNS′av coincide with each other (step S253). If one of ΔNS′ and ΔNS′av is 0, it is determined that they have the same positive/negative direction.

If ΔNS′ and ΔNS′av have the same direction (YES in step S253), the CPU 13A reads out the first correction coefficient KA1 of the ink fountain roller feed rate of the first color from the memory M38 (step S254). Then, ΔNS′ read out in step S251 is multiplied by the correction coefficient KA1 to obtain the first correction amount ΔNSsp1 (ΔNSsp1=ΔNS′×KA1) of the current ink fountain roller feed rate of the first color. The first correction amount ΔNSsp1 is stored in the memory M40 (step S255).

If ΔNS′ and ΔNS′av have different directions (NO in step S253), the CPU 13A reads out the second correction coefficient KA2 (KA1>KA2) of the ink fountain roller feed rate of the first color from the memory M39 (step S256). Then, ΔNS′ read out in step S251 is multiplied by the correction coefficient KA2 to obtain the first correction amount ΔNSsp1 (ΔNSsp1=ΔNS′×KA2) of the current ink fountain roller feed rate of the first color. The first correction amount ΔNSsp1 is stored in the memory M40 (step S257).

The upper limit value ΔNSup of the ink fountain roller feed rate correction amount of the first color is read out from the memory M41 (step S258). If the first correction amount ΔNSsp1 of the current ink fountain roller feed rate of the first color, which is obtained by the above-described method, is larger than the upper limit value ΔNSup (YES in step S259), the first correction amount ΔNSsp1 is rewritten to the upper limit value ΔNSup (step S260).

The lower limit values ΔNSdw of the ink fountain roller feed rate correction amount of the first color is read out from the memory M42 (step S261). If the first correction amount ΔNSsp1 of the current ink fountain roller feed rate of the first color, which is obtained by the above-described method, is smaller than the lower limit values ΔNSdw (YES in step S262), the first correction amount ΔNSsp1 is rewritten to the lower limit values ΔNSdw (step S263).

The current ink fountain roller feed rate correction amount ΔNSspnew of the first color is read out from the memory M1 (step S264). The first correction amount ΔNSsp1 of the current ink fountain roller feed rate of the first color is added to the readout current ink fountain roller feed rate correction amount ΔNSspnew. The result is stored in the memory M43 as the corrected ink fountain roller feed rate correction amount of the first color (step S265) and overwritten in the memory M1 as the next ink fountain roller feed rate correction amount of the first color (step S266).

The CPU 13A reads out, from the memory M37, the difference ΔNS′ between the current ink fountain roller feed rate of the next color after ink supply amount adjustment and the standard feed rate before ink supply amount adjustment (step S268 shown in FIG. 10D). The CPU 13A also reads out, from the memory M36, the average value ΔNS′av between the past ink fountain roller feed rate of the next color after ink supply amount adjustment and the standard feed rate before ink supply amount adjustment (step S269). It is checked whether the positive/negative direction of ΔNS′ and that of ΔNS′av coincide with each other (step S270) Processing in steps S271 to S283 corresponding to steps S254 to S266 described above is executed. With this processing, the first correction amount ΔNSsp1 of the current ink fountain roller feed rate of the next color is obtained. The first correction amount ΔNSsp1 is added to the current ink fountain roller feed rate correction amount ΔNSspnew of the next color. The result is overwritten in the memory M1 as the next ink fountain roller feed rate correction amount ΔNSspnew of the next color.

The CPU 13A repeats the processing in steps S268 to S284 for all colors. If the processing is ended for all colors (YES in step S284), the flow advances to step S285 shown in FIG. 10E.

[Learning of Ink Fountain Key Opening Ratio Correction Amount from Change in Ink Fountain Key Opening Ratio]

In step S285, the CPU 13A reads out the image area ratio of an area corresponding to the first ink fountain key of the first color from the memory M13. Next, the image area ratio to determine the first range of the first color is read out from the memory M44 (step S286). It is checked whether the image area ratio of the area corresponding to the first ink fountain key of the first color is smaller than the image area ratio to determine the first range of the first color (step S287).

If the image area ratio of the area corresponding to the first ink fountain key of the first color is smaller than the image area ratio to determine the first range of the first color (YES in step S287), the current opening ratio θ1′ of the first ink fountain key of the first color, i.e., the opening ratio θ1′ of the first ink fountain key of the first color after ink supply amount adjustment is read out from the memory M34 (step S288). Next, the standard opening ratio θ1sp of the first ink fountain key of the first color before ink supply amount adjustment is read out from the memory M21 (step S289). The standard opening ratio θ1sp is subtracted from θ1′ to obtain the difference Δθ1′ between the current opening ratio of the first ink fountain key of the first color after ink supply amount adjustment and the standard opening ratio before ink supply amount adjustment. The difference A 01′ is stored in the memory M47 (step S290).

The difference A 01′ obtained in step S290 is stored in the memory M24 as the difference between the current ink fountain key opening ratio of the first color in the first range S1 after ink supply amount adjustment and the standard opening ratio before ink supply amount adjustment (step S291). Then, 1 is added to the number of the differences between the current ink fountain key opening ratio of the first color in the first range S1 after ink supply amount adjustment and the standard opening ratio before ink supply amount adjustment in the memory M25 (step S292).

If the image area ratio of the area corresponding to the first ink fountain key of the first color is larger than the image area ratio to determine the first range of the first color (NO in step S287), the image area ratio to determine the second range of the first color is read out from the memory M45 (step S293). It is checked whether the image area ratio of the area corresponding to the first ink fountain key of the first color is smaller than the image area ratio to determine the second range of the first color (step S294).

If the image area ratio of the area corresponding to the first ink fountain key of the first color is smaller than the image area ratio to determine the second range of the first color (YES in step S294), the opening ratio θ1′ of the first ink fountain key of the first color after ink supply amount adjustment is read out from the memory M34 (step S295). Next, the standard opening ratio θ1sp of the first ink fountain key of the first color before ink supply amount adjustment is read out from the memory M21 (step S296). The standard opening ratio θ1sp is subtracted from θ1′ to obtain the difference Δθ1′ between the current opening ratio of the first ink fountain key of the first color after ink supply amount adjustment and the standard opening ratio before ink supply amount adjustment. The difference Δθ1′ is stored in the memory M47 (step S297).

The difference θ1′ obtained in step S297 is stored in the memory M26 as the difference between the current ink fountain key opening ratio of the first color in the second range S2 after ink supply amount adjustment and the standard opening ratio before ink supply amount adjustment (step S298). Then, 1 is added to the number of the differences between the current ink fountain key opening ratio of the first color in the second range S2 after ink supply amount adjustment and the standard opening ratio before ink supply amount adjustment in the memory M27 (step S299).

If the image area ratio of the area corresponding to the first ink fountain key of the first color is larger than the image area ratio to determine the second range of the first color (NO in step S294), the image area ratio to determine the third range of the first color is read out from the memory M46 (step S300 shown in FIG. 10F). It is checked whether the image area ratio of the area corresponding to the first ink fountain key of the first color is smaller than the image area ratio to determine the third range of the first color (step S301).

If the image area ratio of the area corresponding to the first ink fountain key of the first color is smaller than the image area ratio to determine the third range of the first color (YES in step S301), the opening ratio 01′ of the first ink fountain key of the first color after ink supply amount adjustment is read out from the memory M34 (step S302). Next, the standard opening ratio θ1sp of the first ink fountain key of the first color before ink supply amount adjustment is read out from the memory M21 (step S303). The standard opening ratio θ1sp is subtracted from θ1′ to obtain the difference Δθ1′ between the current opening ratio of the first ink fountain key of the first color after ink supply amount adjustment and the standard opening ratio before ink supply amount adjustment. The difference Δθ1′ is stored in the memory M47 (step S304).

The difference Δθ1′ obtained in step S304 is stored in the memory M28 as the difference between the current ink fountain key opening ratio of the first color in the third range S3 after ink supply amount adjustment and the standard opening ratio before ink supply amount adjustment (step S305). Then, 1 is added to the number of the differences between the current ink fountain key opening ratio of the first color in the third range S3 after ink supply amount adjustment and the standard opening ratio before ink supply amount adjustment in the memory M29 (step S306).

If the image area ratio of the area corresponding to the first ink fountain key of the first color is larger than the image area ratio to determine the third range of the first color (NO in step S301), the opening ratio θ1′ of the first ink fountain key of the first color after ink supply amount adjustment is read out from the memory M34 (step S307). Next, the standard opening ratio θ1sp of the first ink fountain key of the first color before ink supply amount adjustment is read out from the memory M21 (step S308). The standard opening ratio θ1sp is subtracted from θ1′ to obtain the difference Δθ1′ between the current opening ratio of the first ink fountain key of the first color after ink supply amount adjustment and the standard opening ratio before ink supply amount adjustment. The difference Δθ1′ is stored in the memory M47 (step S309).

The difference A 01′ obtained in step S309 is stored in the memory M30 as the difference between the current ink fountain key opening ratio of the first color in the fourth range S4 after ink supply amount adjustment and the standard opening ratio before ink supply amount adjustment (step S310). Then, 1 is added to the number of the differences between the current ink fountain key opening ratio of the first color in the fourth range S4 after ink supply amount adjustment and the standard opening ratio before ink supply amount adjustment in the memory M31 (step S311).

Next, the CPU 13A reads out the image area ratio of an area corresponding to the next ink fountain key of the first color from the memory M13 (step S312 shown in FIG. 10G). Processing in steps S313 to S338 corresponding to steps S286 to S311 described above is executed. If the difference Δθ2′ between the current opening ratio of the next ink fountain key of the first color after ink supply amount adjustment and the standard opening ratio before ink supply amount adjustment is smaller than the image area ratio to determine the first range, Δθ2′ is stored in the memory M24, and 1 is added to the number in the memory M25. If the difference Δθ2′ is larger than the image area ratio to determine the first range and smaller than the image area ratio to determine the second range, Δθ2′ is stored in the memory M26, and 1 is added to the number in the memory M27. If the difference Δθ2′ is larger than the image area ratio to determine the second range and smaller than the image area ratio to determine the third range, Δθ2′ is stored in the memory M28, and 1 is added to the number in the memory M29. If the difference Δθ2′ is larger than the image area ratio to determine the third range, Δθ2′ is stored in the memory M30, and 1 is added to the number in the memory M31.

The CPU 13A repeats the processing in steps S312 to S339 for all ink fountain keys of the first color. When the processing is ended for all ink fountain keys of the first color (YES in step S339), the same processing is repeated for all ink fountain keys of the next color (steps S314 to S395 in FIGS. 10I to 10L). When the processing is ended for all ink fountain keys of the next color (YES in step S395 in FIG. 10K), the processing in steps S341 to S396 is repeated for all colors. If the processing is ended for all colors (YES in step S396), the flow advances to step S397 shown in FIG. 10M.

In step S397, the CPU 13A obtains the sum of the differences between the current ink fountain key opening ratios of the respective colors in the first range S1 after ink supply amount adjustment and the standard opening ratios before ink supply amount adjustment from the differences between the current ink fountain key opening ratios of the respective colors in the first range S1 after ink supply amount adjustment and the standard opening ratios before ink supply amount adjustment in the memory M24. The sum is stored in the memory M48. Next, the number of differences between the current ink fountain key opening ratios of the respective colors in the first range S1 after ink supply amount adjustment and the standard opening ratios before ink supply amount adjustment is read out from the memory M25 (step S398). The average values ΔθX1 of the differences between the current ink fountain key opening ratios of the respective colors in the first range S1 after ink supply amount adjustment and the standard opening ratios before ink supply amount adjustment are obtained and stored in the memory M49 (step S399).

As in steps S397 to S399, the average values ΔθX2 of the differences between the current ink fountain key opening ratios of the respective colors in the second range S2 after ink supply amount adjustment and the standard opening ratios before ink supply amount adjustment are obtained and stored in the memory M51 (step S400 to S402). The average values ΔθX3 of the differences between the current ink fountain key opening ratios of the respective colors in the third range S3 after ink supply amount adjustment and the standard opening ratios before ink supply amount adjustment are obtained and stored in the memory M53 (step S403 to S405). The average values ΔθX4 of the differences between the current ink fountain key opening ratios of the respective colors in the fourth range S4 after ink supply amount adjustment and the standard opening ratios before ink supply amount adjustment are obtained and stored in the memory M55 (step S406 to S408).

The CPU 13A obtains the sum of the average values of the differences between the past ink fountain key opening ratios of the respective colors in the first range S1 after ink supply amount adjustment and the opening ratios before ink supply amount adjustment from the average values of the differences between the past ink fountain key opening ratios of the respective colors in the first range S1 after ink supply amount adjustment and the opening ratios before ink supply amount adjustment in the memory M5 (step S409). The number of average values of the differences between the past ink fountain key opening ratios of the respective colors in the first range S1 after ink supply amount adjustment and the opening ratios before ink supply amount adjustment is read out from the memory M6 (step S410). The average value ΔθY1 of the average values of the differences between the past ink fountain key opening ratios of the respective colors in the first range S1 after ink supply amount adjustment and the opening ratios before ink supply amount adjustment is obtained and stored in the memory M56 (step S411).

As in steps S409 to S411, the average value ΔθY2 of the average values of the differences between the past ink fountain key opening ratios of the respective colors in the second range S2 after ink supply amount adjustment and the opening ratios before ink supply amount adjustment is obtained and stored in the memory M57 (steps S412 to S414). The average value ΔθY3 of the average values of the differences between the past ink fountain key opening ratios of the respective colors in the third range S3 after ink supply amount adjustment and the opening ratios before ink supply amount adjustment is obtained and stored in the memory M58 (steps S415 to S417). The average value ΔθY4 of the average values of the differences between the past ink fountain key opening ratios of the respective colors in the fourth range S4 after ink supply amount adjustment and the opening ratios before ink supply amount adjustment is obtained and stored in the memory M59 (steps S418 to S420).

Next, the average value ΔθX1 of the differences between the current ink fountain key opening ratios of the first color in the first range S1 after ink supply amount adjustment and the standard opening ratios before ink supply amount adjustment is read out from the memory M49 (step S421 shown in FIG. 100). The average value ΔθY1 of the average values of the differences between the past ink fountain key opening ratios of the first color in the first range S1 after ink supply amount adjustment and the opening ratios before ink supply amount adjustment is read out from the memory M56 (step S422). It is checked whether the positive/negative directions of current ΔθX1 and ΔθY1 of the first color coincide with each other (step S423). If one of ΔθX1 and ΔθY1 is 0, it is determined that they have the same positive/negative direction.

If current ΔθX1 and ΔθY1 of the first color have the same direction (YES in step S423), the CPU 13A reads out the first correction coefficient KB1 of the ink fountain key opening ratio of the first color from the memory M60 (step S424). Then, ΔθX1 read out in step S421 is multiplied by the correction coefficient KB1 to obtain the correction amount Δθsp (Δθsp=ΔθX1×KB1) of the current ink fountain key opening ratio of the first color. The correction amount Δθsp is stored in the memory M62 (step S425).

If current ΔθX1 and ΔθY1 of the first color have different directions (NO in step S423), the CPU 13A reads out the second correction coefficient KB2 of the ink fountain key opening ratio of the first color from the memory M61 (step S426). Then, ΔθX1 read out in step S421 is multiplied by the correction coefficient KB2 to obtain the correction amount Δθsp (Δθsp=ΔθX1×KB2) of the current ink fountain key opening ratio of the first color. The correction amount Δθsp is stored in the memory M62 (step S427).

If the correction amount Δθsp of the current ink fountain key opening ratio of the first color is not 0 (YES in step S428), “1” is written at the address for the first color in the memory M32 which stores the presence/absence of ink fountain key opening ratio correction amount learning (step S429). The current ink fountain key opening ratio correction amount Δθspnew of the first color is read out from the memory M2 (step S430). The correction amount Δθsp of the current ink fountain key opening ratio of the first color is added to the readout current ink fountain key opening ratio correction amount Δθspnew. The result is stored in the memory M63 as the corrected ink fountain key opening ratio correction amount of the first color (step S431) and overwritten in the memory M2 as the next ink fountain key opening ratio correction amount Δθspnew of the first color (step S432).

Next, the CPU 13A reads out, from the memory M49, the average values ΔθX1 of the differences between the current ink fountain key opening ratios of the next color in the first range S1 after ink supply amount adjustment and the standard opening ratios before ink supply amount adjustment (step S434 shown in FIG. 10P). The average values ΔθY1 of the average values of the differences between the past ink fountain key opening ratios of the next color in the first range S1 after ink supply amount adjustment and the opening ratios before ink supply amount adjustment are read out from the memory M56 (step S435). Processing in steps S436 to S445 corresponding to steps S423 to S432 described above is executed. With this processing, the correction amount Δθsp of the current ink fountain key opening ratio of the next color is obtained. The correction amount Δθsp of the current ink fountain key opening ratio of the first color is added to the current ink fountain key opening ratio correction amount Δθspnew of the next color. The result is overwritten in the memory M2 as the next ink fountain key opening ratio correction amount Δθspnew of the next color.

The CPU 13A repeats the processing in steps S434 to S446 for all colors. If the processing is ended for all colors (YES in step S446), the flow advances to step S447 shown in FIG. 10Q.

[Learning of Ink Fountain Roller Feed Rate Correction Amount (Second Correction Amount) from Change in Ink Fountain Key Opening Ratio]

In step S447, the CPU 13A reads out, from the memory M37, the difference ΔNS′ between the current ink fountain roller feed rate of the first color after ink supply amount adjustment and the standard feed rate before ink supply amount adjustment. The average value ΔθX3 between the current ink fountain key opening ratio of the first color in the third range S3 after ink supply amount adjustment and the standard opening ratio before ink supply amount adjustment is read out from the memory M53 (step S448). It is checked whether the positive/negative directions of current ΔNS′ and ΔθX3 of the first color coincide with each other (step S449). If one of ΔNS′ and ΔθX3 is 0, it is determined that they have the same positive/negative direction.

If current ΔNS′ and ΔθX3 of the first color have the same direction (YES in step S449), the CPU 13A reads out, from the memory M58, the average value ΔθY3 of the average values of the differences between the past ink fountain key opening ratios of the first color in the third range S3 after ink supply amount adjustment and the standard opening ratios before ink supply amount adjustment (step S450). It is checked whether the positive/negative directions of current ΔθY3 and ΔθX3 of the first color coincide with each other (step S451). If one of ΔθY3 and ΔθX3 is 0, it is determined that they have the same positive/negative direction.

If current ΔθY3 and ΔθX3 of the first color have the same direction (YES in step S451), the CPU 13A reads out the third correction coefficient KA3 of the ink fountain roller feed rate of the first color from the memory M68 (step S452). Then, ΔθX3 is multiplied by the correction coefficient KA3 to obtain the second correction amount ΔNSsp2 (ΔNSsp2=ΔθX3×KA3) of the current ink fountain roller of the first color. The second correction amount ΔNSsp2 is stored in the memory M70 (step S453).

If current ΔθY3 and ΔθX3 of the first color have different directions (NO in step S451), the CPU 13A reads out the fourth correction coefficient KA4 (KA3>KA4) of the ink fountain roller feed rate of the first color from the memory M69 (step S454). Then, ΔθX3 is multiplied by the correction coefficient KA4 to obtain the second correction amount ΔNSsp2 (ΔNSsp2=ΔθX3×KA4) of the current ink fountain roller of the first color. The second correction amount ΔNSsp2 is stored in the memory M70 (step S455).

The current ink fountain roller feed rate correction amount ΔNSspnew of the first color is read out from the memory M1 (step S461). The second correction amount ΔNSsp2 of the current ink fountain roller feed rate of the first color is added to the readout current ink fountain roller feed rate correction amount ΔNSspnew. The result is stored in the memory M43 as the corrected ink fountain roller feed rate correction amount of the first color (step S462) and overwritten in the memory M1 as the next ink fountain roller feed rate correction amount of the first color (step S463).

If current ΔNS′ and ΔθX3 of the first color have different directions (NO in step S449), the CPU 13A obtains the absolute value of current ΔNS′ and the absolute value of current ΔθX3 of the first color (steps S456 and S457). The difference between the absolute value of ΔθX3 and the absolute value of ΔNS′ is stored in the memory M66 (step S458). The reference value αth to determine the necessity of correction of the ink fountain roller feed rate correction amount of the first color is read out from the memory M67 (step S459). If the current difference between the absolute value of ΔθX3 and the absolute value of ΔNS′ exceeds αth (YES in step S460), the fourth correction coefficient KA4 of the ink fountain roller feed rate of the first color is read out from the memory M69, like the case wherein current ΔθY3 and ΔθX3 of the first color have different directions in step S451 (step S454). Next, ΔθX3 is multiplied by the coefficient KA4 to obtain the second correction amount ΔNSsp2 (ΔNSsp2=ΔθX3×KA4) of the current ink fountain roller of the first color. The second correction amount ΔNSsp2 is stored in the memory M70 (step S455).

Next, the CPU 13A reads out, from the memory M37, the difference ΔNS′ between the current ink fountain roller feed rate of the next color after ink supply amount adjustment and the standard feed rate before ink supply amount adjustment (step S465 shown in FIG. 10R). The average value ΔθX3 between the current ink fountain key opening ratio of the next color in the third range S3 after ink supply amount adjustment and the standard opening ratio before ink supply amount adjustment is read out from the memory M53 (step S466). Processing in steps S467 to S481 corresponding to steps S449 to S463 described above is executed. With this processing, the second correction amount ΔNSsp2 of the current ink fountain roller feed rate of the next color is obtained. The second correction amount ΔNSsp2 is added to the current ink fountain roller feed rate correction amount ΔNSspnew of the next color. The result is overwritten in the memory M1 as the next ink fountain roller feed rate correction amount ΔNSspnew of the next color.

The CPU 13A repeats the processing in steps S465 to S482 for all colors. If the processing is ended for all colors (YES in step S482), the flow advances to step S483 shown in FIG. 10S.

[Learning of Ink Fountain Roller Feed Rate Correction Amount (Third Correction Amount) from Change in Ink Fountain Key Opening Ratio]

In step S483, the CPU 13A reads out, from the memory M29, the number of differences between the current ink fountain key opening ratios of the first color in the third range S3 after ink supply amount adjustment and the opening ratios before ink supply amount adjustment. If the readout number of differences between the current ink fountain key opening ratios of the first color in the third range S3 after ink supply amount adjustment and the opening ratios before ink supply amount adjustment is 0 (NO in step S484), the number of differences between the current ink fountain key opening ratios of the first color in the fourth range S4 after ink supply amount adjustment and the opening ratios before ink supply amount adjustment is read out from the memory M31 (step S485). It is checked whether the readout number of differences between the current ink fountain key opening ratios of the first color in the fourth range S4 after ink supply amount adjustment and the opening ratios before ink supply amount adjustment is 0, too (step S486).

If the number of differences between the opening ratios before ink supply amount adjustment and the current ink fountain key opening ratios of the first color after ink supply amount adjustment is 0 in both the third range S3 and the fourth range S4 (NO in step S486), the CPU 13A reads out the contents of the address for the first color in the memory M32 which stores the presence/absence of ink fountain key opening ratio correction amount learning (step S487). If the contents of the address indicate “1” (YES in step S488), the average value ΔθX1 of the differences between the current ink fountain key opening ratios of the first color in the first range S1 after ink supply amount adjustment and the standard opening ratios before ink supply amount adjustment is read out from the memory M49 (step S489).

Next, the average value ΔθX2 of the differences between the current ink fountain key opening ratios of the first color in the second range S2 after ink supply amount adjustment and the standard opening ratios before ink supply amount adjustment is read out from the memory M51 (step S490). If current ΔθX1 and ΔθX2 of the first color have different directions (NO in step S491), the fifth correction coefficient KA5 of the ink fountain roller feed rate of the first color is read out from the memory M71 (step S492). Then, ΔθX2 is multiplied by the correction coefficient KA5 to obtain the third correction amount ΔNSsp3 (ΔNSsp3=ΔθX2×KA5) of the current ink fountain roller of the first color. The third correction amount ΔNSsp3 is stored in the memory M72 (step S493).

The current ink fountain roller feed rate correction amount ΔNSspnew of the first color is read out from the memory M1 (step S494). The third correction amount ΔNSsp3 of the current ink fountain roller of the first color is added to the readout ink fountain roller feed rate correction amount ΔNSspnew of the first color. The result is stored in the memory M43 as the corrected ink fountain roller feed rate correction amount of the first color (step S495) and overwritten in the memory M1 as the next ink fountain roller feed rate correction amount ΔNSspnew of the first color (step S496).

Next, the CPU 13A reads out, from the memory M29, the number of differences between the current ink fountain key opening ratios of the next color in the third range S3 after ink supply amount adjustment and the opening ratios before ink supply amount adjustment (step S498 shown in FIG. 10T). Processing in steps S499 to S511 corresponding to steps S484 to S496 described above is executed. With this processing, the third correction amount ΔNSsp3 of the current ink fountain roller of the next color is obtained and added to the current ink fountain roller feed rate correction amount ΔNSspnew of the next color. The result is overwritten in the memory M1 as the next ink fountain roller feed rate correction amount ΔNSspnew of the next color.

The CPU 13A repeats the processing in steps S498 to S512 for all colors. If the processing is ended for all colors (YES in step S512), the flow advances to step S513 shown in FIG. 10U.

[Storage of Log Data]

In step S513, the CPU 13A reads out the upper limit value of the number of stored past log data from the memory M73. The number of differences between the past ink fountain roller feed rates of the first color after ink supply amount adjustment and the standard feed rates before ink supply amount adjustment is read out from the memory M4 (step S514). It is checked whether the number is equal to or more than the upper limit value of the number of stored past log data (step S515).

If the stored number of differences between the past ink fountain roller feed rates of the first color after ink supply amount adjustment and the standard feed rates before ink supply amount adjustment is equal to or more than the upper limit value of the number of stored past log data (YES in step S515), the difference ΔNS′ between the current ink fountain roller feed rate of the first color after ink supply amount adjustment and the standard feed rate before ink supply amount adjustment is read out from the memory M37 (step S516). If ΔNS′ is not 0 (YES in step S517), the oldest difference between the past ink fountain roller feed rate of the first color after ink supply amount adjustment and the standard feed rate before ink supply amount adjustment is deleted from the memory M3 (step S518). The difference ΔNS′ between the current ink fountain roller feed rate of the first color after ink supply amount adjustment and the standard feed rate before ink supply amount adjustment is written at the address for the first color in the memory M3 (step S519).

If the stored number of differences between the past ink fountain roller feed rates of the first color after ink supply amount adjustment and the standard feed rates before ink supply amount adjustment is smaller than the upper limit value of the number of stored past log data (NO in step S515), the difference ΔNS′ between the current ink fountain roller feed rate of the first color after ink supply amount adjustment and the standard feed rate before ink supply amount adjustment is read out from the memory M37 (step S520). If ΔNS′ is not 0 (YES in step S521), the difference A NS′ between the current ink fountain roller feed rate of the first color after ink supply amount adjustment and the standard feed rate before ink supply amount adjustment is written at the address for the first color in the memory M3 (step S522). In addition, “1” is added to the number of differences between the past ink fountain roller feed rates of the first color after ink supply amount adjustment and the standard feed rates before ink supply amount adjustment in the memory M4 (step S523).

Next, the CPU 13A reads out the upper limit value of the number of stored past log data from the memory M73 (step S525 shown in FIG. 10V). The number of differences between the past ink fountain roller feed rates of the next color after ink supply amount adjustment and the standard feed rates before ink supply amount adjustment is read out from the memory M4 (step S526). Processing in steps S527 to S535 corresponding to steps S515 to S523 described above is executed. With this processing, the difference ΔNS′ between the current ink fountain roller feed rate of the first color after ink supply amount adjustment and the standard feed rate before ink supply amount adjustment is written at the address for the next color in the memory M3.

The CPU 13A repeats the processing in steps S525 to S536 for all colors. If the processing is ended for all colors (YES in step S536), the flow advances to step S537 shown in FIG. 10X.

In step S537, the CPU 13A reads out the upper limit value of the number of stored past log data from the memory M73. The number of average values of the differences between the past ink fountain key opening ratios of the first color after ink supply amount adjustment and the standard opening ratios before ink supply amount adjustment is read out from the memory M6 (step S538). It is checked whether the number is equal to or more than the upper limit value of the number of stored past log data (step S539).

If the stored number of average values of the differences between the past ink fountain key opening ratios of the first color after ink supply amount adjustment and the standard opening ratios before ink supply amount adjustment is equal to or more than the upper limit value of the number of stored past log data (YES in step S539), the average value ΔθX1 of the differences between the ink fountain key opening ratios of the first color in the first range S1 after ink supply amount adjustment and the standard opening ratios before ink supply amount adjustment is read out from the memory M49 (step S540). If ΔθX1 is not 0 (YES in step S541), the oldest average value of the differences between the past ink fountain key opening ratios of the first color in the first range S1 after ink supply amount adjustment and the standard opening ratios before ink supply amount adjustment is deleted from the memory M5 (step S542). The average value ΔθX1 of the differences between the current ink fountain key opening ratios of the first color in the first range S1 after ink supply amount adjustment and the standard opening ratios before ink supply amount adjustment is written at the address for the first color in the memory M5 (step S543).

If the stored number of average values of the differences between the past ink fountain key opening ratios of the first color in the first range S1 after ink supply amount adjustment and the standard opening ratios before ink supply amount adjustment is smaller than the upper limit value of the number of stored past log data (NO in step S539), the average value ΔθX1 of the differences between the current ink fountain key opening ratios of the first color in the first range S1 after ink supply amount adjustment and the standard opening ratios before ink supply amount adjustment is read out from the memory M49 (step S544). If ΔθX1 is not 0 (YES in step S545), the average value ΔθX1 of the differences between the current ink fountain key opening ratios of the first color in the first range S1 after ink supply amount adjustment and the standard opening ratios before ink supply amount adjustment is written at the address for the first color in the memory M5 (step S546). In addition, “1” is added to the stored number of average values of the differences between the past ink fountain key opening ratios of the first color in the first range S1 after ink supply amount adjustment and the standard opening ratios before ink supply amount adjustment in the memory M6 (step S547).

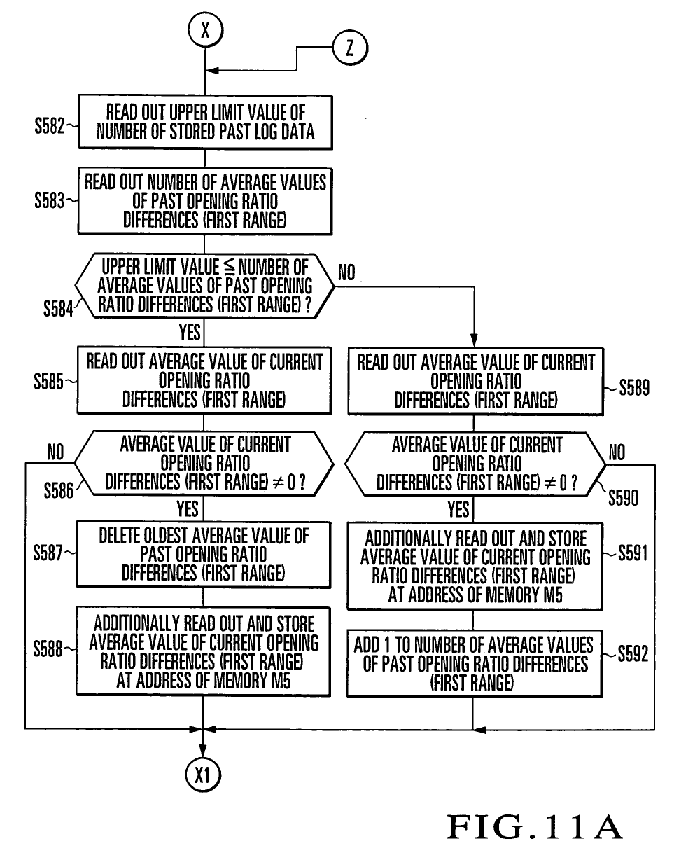

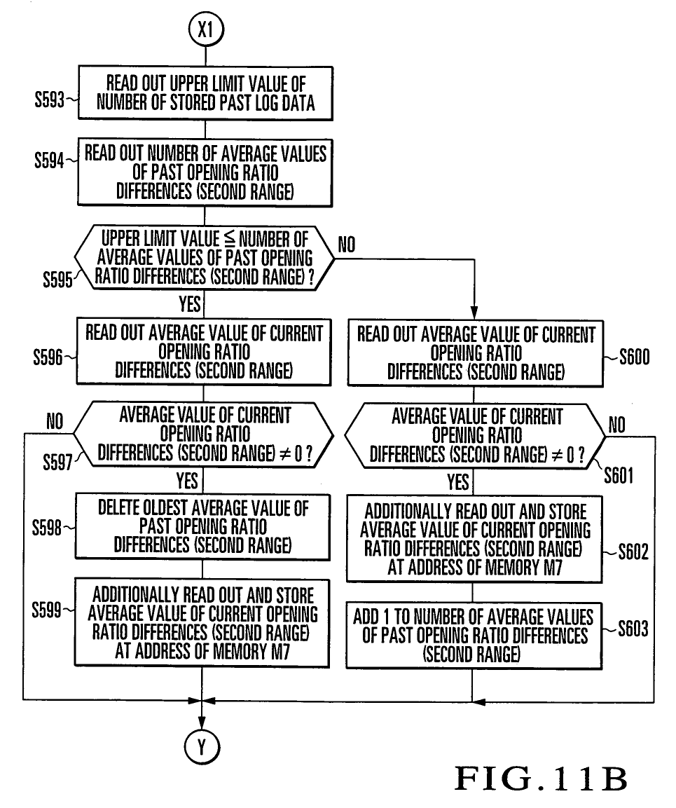

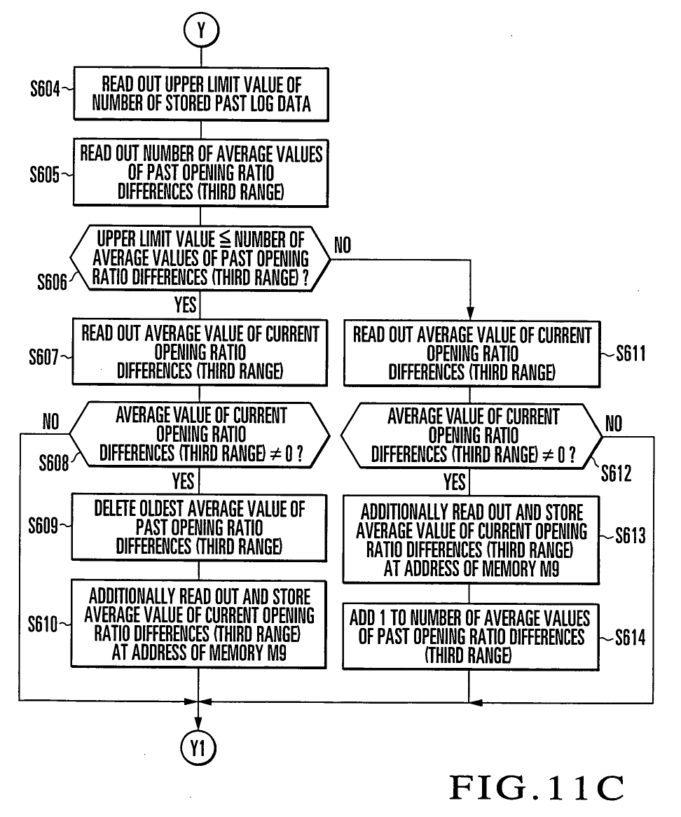

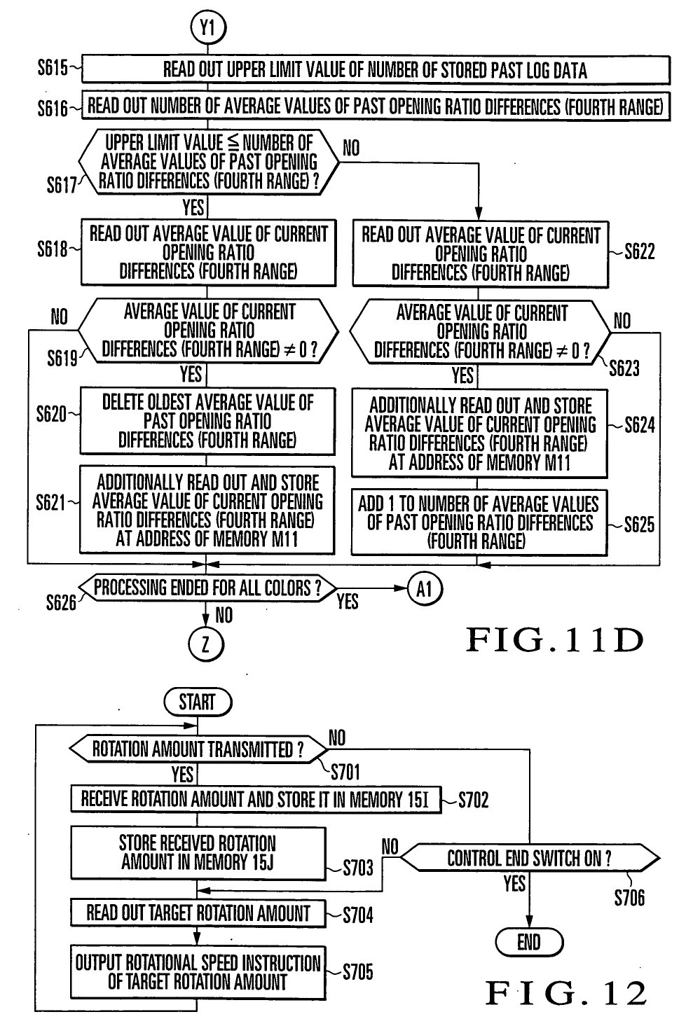

As in steps S537 to S547, the average value ΔθX2 of the differences between the current ink fountain key opening ratios of the first color in the second range S2 after ink supply amount adjustment and the standard opening ratios before ink supply amount adjustment is written at the address for the first color in the memory M7. The average value ΔθX3 of the differences between the current ink fountain key opening ratios of the first color in the third range S3 after ink supply amount adjustment and the standard opening ratios before ink supply amount adjustment is written at the address for the first color in the memory M9. The average value ΔθX4 of the differences between the current ink fountain key opening ratios of the first color in the fourth range S4 after ink supply amount adjustment and the standard opening ratios before ink supply amount adjustment is written at the address for the first color in the memory M11 (steps S548 to S581 in FIGS. 10Y and 10Z). When the processing is ended for the first color (YES in step S581), the same processing as in steps S537 to S581 is executed for the next color (steps S582 to S626 in FIGS. 11A to 11D). If the processing is ended for all colors (YES in step S626), the flow returns to step S213 in FIG. 16.

### Second Embodiment

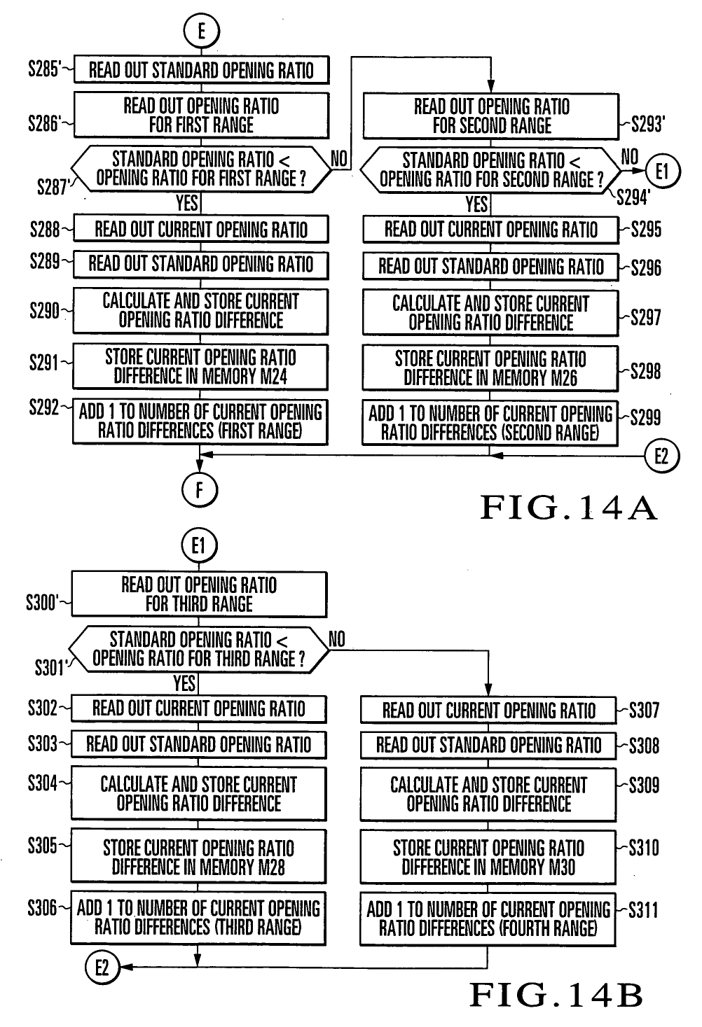

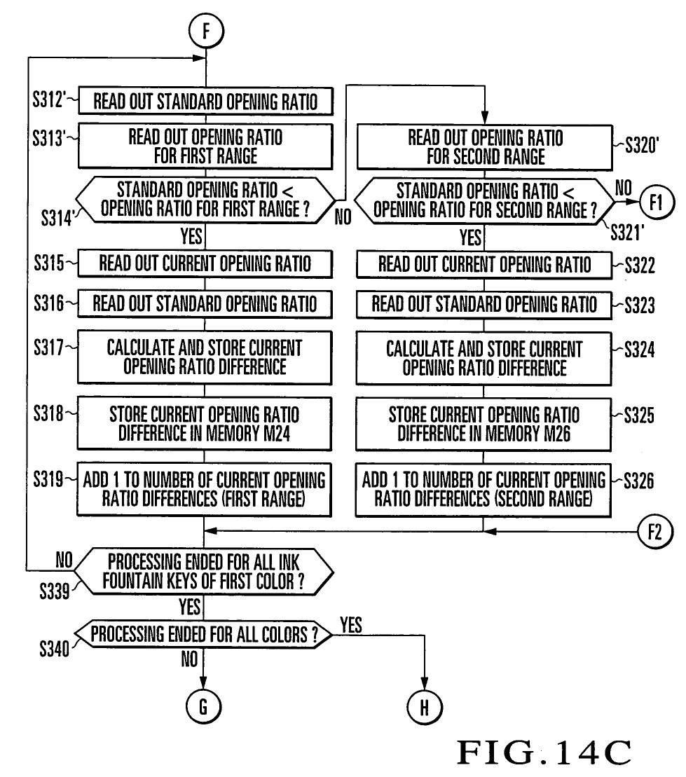

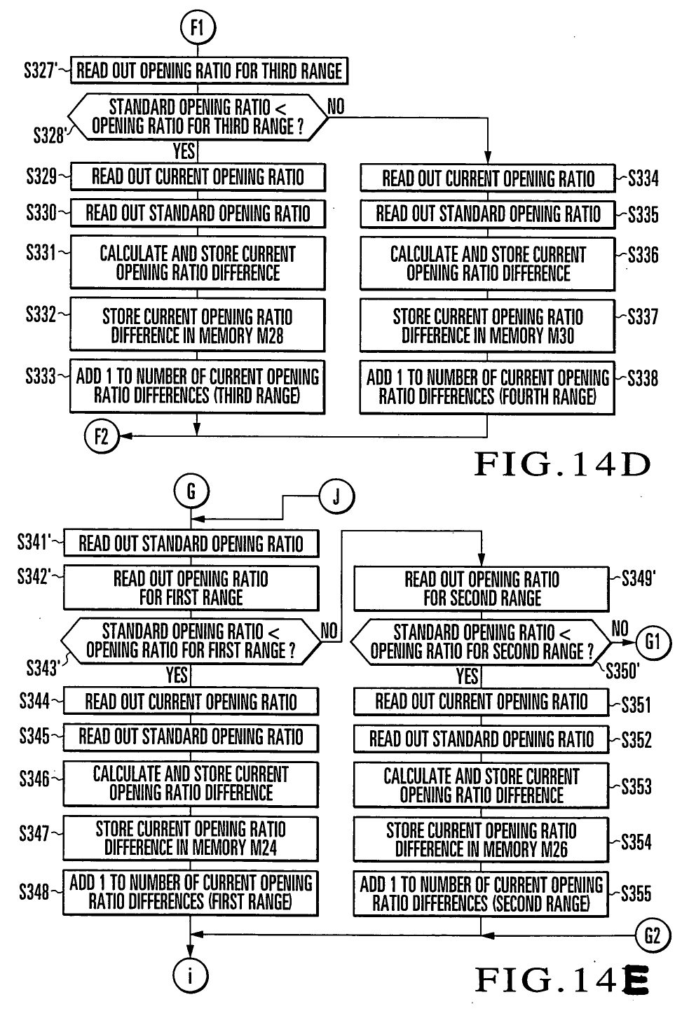

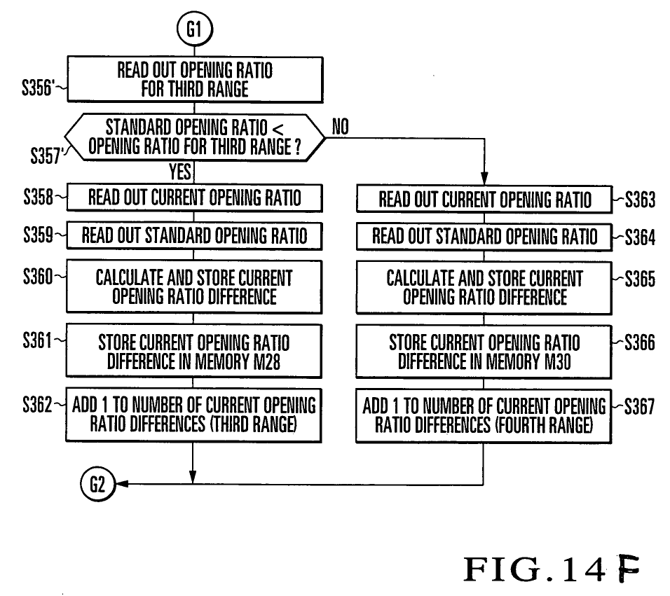

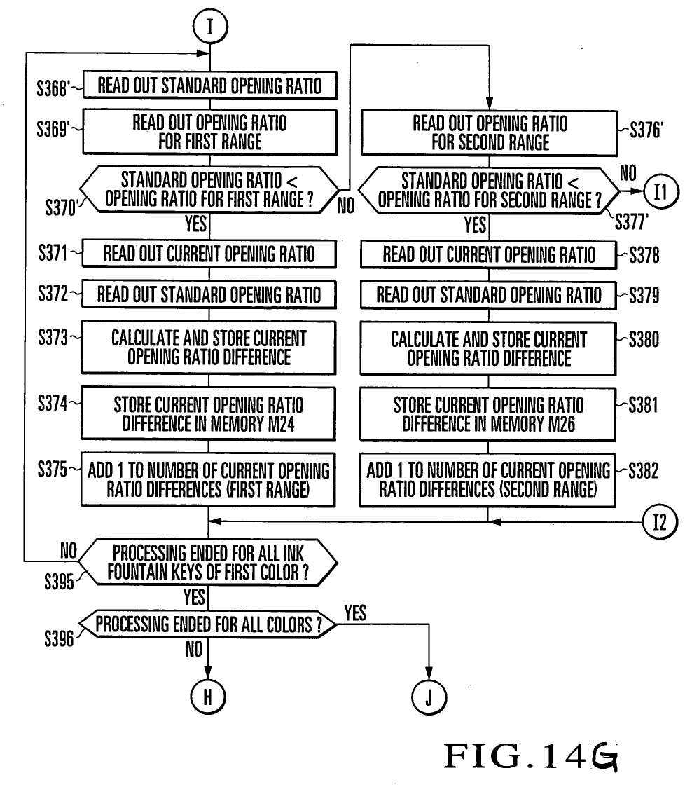

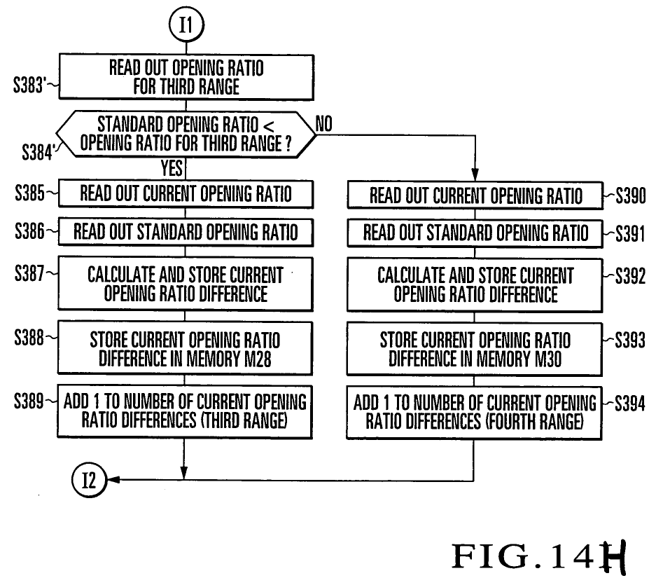

In the first embodiment, in the flowcharts shown in FIGS. 10E and 10F, the image area ratio of the area corresponding to the first ink fountain key of the first color is compared with the predetermined image area ratios to determine the first, second, and third ranges of the first color, thereby determining one of the four ranges S1 to S4 to which the first ink fountain key of the first color belongs. In the second embodiment, as shown in the flowcharts of FIGS. 14A and 14B, the standard opening ratio of the first ink fountain key of the first color before ink supply amount adjustment is read out. The readout standard opening ratio of the first ink fountain key of the first color before ink supply amount adjustment is compared with predetermined ink fountain key opening ratios to determine the first, second, and third ranges of the first color, thereby determining one of four ranges S1 to S4 to which the first ink fountain key of the first color belongs (steps S285′ to S287′, S293′, S294′, S300′, and S301′).

In this case, even in the flowcharts shown in FIGS. 10G, 10H, 10I, 10J, 10K, and 10L, the range to which an ink fountain key belongs is determined on the basis of the standard ink fountain key opening ratio before ink supply amount adjustment. FIGS. 14C and 14D show the flowcharts corresponding to FIGS. 10G and 10H. FIGS. 14E and 14F show the flowcharts corresponding to FIGS. 10I and 10J. FIGS. 14G and 14H show the flowcharts corresponding to FIGS. 10K and 10L. The remaining processes are the same as in the first embodiment, and the flowcharts thereof are not illustrated.

FIG. 15 shows the functional blocks of a CPU 13A shown in FIG. 6. Referring to FIG. 15, the CPU 13A comprises a rotation amount comparison unit 1301 which compares the standard rotation amount of an ink fountain roller 3 preset before ink supply amount adjustment with the rotation amount of the ink fountain roller 3 after ink supply amount adjustment, an opening ratio comparison unit 1302 which compares the standard opening ratios of ink fountain keys 4-1 to 4-n preset before ink supply amount adjustment with the opening ratios of the ink fountain keys 4-1 to 4-n after ink supply amount adjustment, a rotation correction amount calculation unit 1303 which obtains the correction amount of the ink fountain roller rotation amount on the basis of at least one of the comparison results of the rotation amount comparison unit 1301 and opening ratio comparison unit 1302, and an opening correction amount calculation unit 1304 which obtains an ink fountain key opening ratio correction amount common to all ink fountain keys on the basis of at least the comparison result of the opening ratio comparison unit 1302.

The rotation amount comparison unit 1301 executes step S250. The opening ratio comparison unit 1302 executes steps S290, S297, S304, S309, S317, S324, S331, S336, S346, S353, S360, S365, S373, S380, S387, and S392. The rotation correction amount calculation unit 1303 executes steps S251 to S263, S268 to S280, S447 to S460, S465 to S478, S483, S493, and S498 to S508. The opening correction amount calculation unit 1304 executes steps S397 to S408, S421 to S427, and S434 to S440.

In the above-described embodiments, the image area ratio is used to know the degree of the image of an area corresponding to an ink fountain key. However, the image area itself may be used. The standard ink fountain roller feed rate (standard feed rate before correction) is obtained from the “image area ratio−ink fountain roller feed rate conversion curve”. Instead, a permanently defined standard feed rate may be used. The precedingly learned correction amount ΔNSspnew may be added to the permanently defined standard feed rate to obtain the standard feed rate before ink supply amount adjustment (standard feed rate to be preset). If there is no precedingly learned correction amount ΔNSspnew, i.e., ΔNSspnew is 0, the standard feed rate obtained from the “image area ratio−ink fountain roller feed rate conversion curve” or the permanently defined standard feed rate is used as the standard feed rate before ink supply amount adjustment.

In the above-described embodiments, in checking the past ink fountain key correction directions in the first range S1 to the fourth range S4 of the respective colors, the average values of the differences between the past ink fountain key opening ratios of the respective colors in the first range S1 to the fourth range S4 after ink supply amount adjustment and the standard opening ratios before ink supply amount adjustment are stored. The average value of the average values of the differences between the past ink fountain key opening ratios of the respective colors in the first range S1 to the fourth range S4 after ink supply amount adjustment and the standard opening ratios before ink supply amount adjustment is obtained. Instead, the differences between the past ink fountain key opening ratios of the respective colors in the first range S1 to the fourth range S4 after ink supply amount adjustment and the standard opening ratios before ink supply amount adjustment may be stored. The average value of the differences between the past ink fountain key opening ratios of the respective colors in the first range S1 to the fourth range S4 after ink supply amount adjustment and the standard opening ratios before ink supply amount adjustment may be obtained.

According to the present invention, the standard ink fountain key opening ratio and standard ink fountain roller feed rate preset before ink supply amount adjustment are compared with the ink fountain key opening ratio and ink fountain roller feed rate after ink supply amount adjustment. The ink fountain key opening ratio correction amount and ink fountain roller feed rate correction amount common to all ink fountain keys are obtained from the comparison result. Hence, both the ink fountain key opening ratio and the ink fountain roller feed rate can be corrected rationally, and the ink supply amount can be adjusted easily in a short time.

What is claimed is:

1. An ink supply amount adjustment method for a printing press including a plurality of ink fountain keys each of which adjusts an amount of ink supplied from an ink fountain in accordance with an opening ratio, and an ink fountain roller which adjusts, in accordance with a rotation amount, an amount of ink to be supplied from the ink fountain to a plate cylinder, comprising the steps of:
comparing a standard rotation amount of the ink fountain roller preset before ink supply amount adjustment with a rotation amount of the ink fountain roller after ink supply amount adjustment;
comparing a standard opening ratio of each ink fountain key preset before ink supply amount adjustment with an opening ratio of the ink fountain key after ink supply amount adjustment;
obtaining an ink fountain roller rotation amount correction amount on the basis of at least one of two comparison results;
obtaining an ink fountain key opening ratio correction amount common to all the ink fountain keys on the basis of at least the comparison result of the ink fountain key opening ratio; and
adjusting the ink fountain key opening ratio and the ink fountain roller rotation amount in accordance with the obtained ink fountain key opening ratio correction amount and the obtained ink fountain roller rotation amount correction amount.

2. A method according to claim 1, wherein the correction amount obtaining step comprises the step of obtaining the ink fountain roller rotation amount correction amount on the basis of a difference between the ink fountain roller rotation amount after ink supply amount adjustment and the standard rotation amount before ink supply amount adjustment.

3. A method according to claim 1, wherein the correction amount obtaining step comprises the step of obtaining the ink fountain roller rotation amount correction amount by multiplying a difference between the ink fountain roller rotation amount after ink supply amount adjustment and the standard rotation amount before ink supply amount adjustment by a predetermined coefficient.

4. A method according to claim 3, wherein
the coefficient includes a first coefficient and a second coefficient smaller than the first coefficient, and
the correction amount obtaining step comprises the steps of:
using the first coefficient when a positive/negative direction of a difference between a current ink fountain roller rotation amount after ink supply amount adjustment and the standard rotation amount before ink supply amount adjustment coincides with a positive/negative direction of an average value of differences between ink fountain roller rotation amounts after a plurality of number of times of past ink supply amount adjustment and the standard rotation amount before a plurality of number of times of past ink supply amount adjustment; and
using the second coefficient when the positive/negative direction of the difference between the current ink fountain roller rotation amount after ink supply amount adjustment and the standard rotation amount before ink supply amount adjustment does not coincide with the positive/negative direction of the average value of the differences between the ink fountain roller rotation amounts after the plurality of number of times of past ink supply amount adjustment and the standard rotation amount before the plurality of number of times of past ink supply amount adjustment.

5. A method according to claim 1, wherein the correction amount obtaining step comprises the step of, when an absolute value of the ink fountain roller rotation amount correction amount is larger than a predetermined upper limit value, correcting the ink fountain roller rotation amount correction amount so as to set the absolute value of the ink fountain roller rotation amount correction amount to the upper limit value.

6. A method according to claim 1, wherein the correction amount obtaining step comprises the step of obtaining the ink fountain key opening ratio correction amount on the basis of an average value of differences between the ink fountain key opening ratios after ink supply amount adjustment and the standard opening ratios before ink supply amount adjustment.

7. A method according to claim 6, wherein the correction amount obtaining step comprises the step of obtaining the ink fountain key opening ratio correction amount by multiplying the average value of the differences between the ink fountain key opening ratios after ink supply amount adjustment and the standard opening ratios before ink supply amount adjustment by a predetermined coefficient.

8. A method according to claim 7, wherein
the coefficient includes a first coefficient and a second coefficient smaller than the first coefficient, and
the correction amount obtaining step comprises the steps of:
using the first coefficient when a positive/negative direction of an average value of differences between current ink fountain key opening ratios after ink supply amount adjustment and the standard opening ratios before ink supply amount adjustment coincides with a positive/negative direction of an average value of differences between ink fountain key opening ratios after a plurality of number of times of past ink supply amount adjustment and the standard opening ratios before a plurality of number of times of past ink supply amount adjustment; and
using the second coefficient when the positive/negative direction of the average value of the differences between the current ink fountain key opening ratios after ink supply amount adjustment and the standard opening ratios before ink supply amount adjustment does not coincide with the positive/negative direction of the average value of the differences between the ink fountain key opening ratios after the plurality of number of times of past ink supply amount adjustment and the standard opening ratios before the plurality of number of times of past ink supply amount adjustment.

9. A method according to claim 6, wherein the correction amount obtaining step comprises the step of obtaining the ink fountain key opening ratio correction amount on the basis of the average value of the differences between the opening ratios of ink fountain keys after ink supply amount adjustment and the standard opening ratios before ink supply amount adjustment, by using as targets the ink fountain keys belonging to a minimum one of a plurality of ranges defined by diving a range of one of an image area ratio and an image area of an area corresponding to the ink fountain keys.

10. A method according to claim 9, wherein the correction amount obtaining step comprises the step of, when no ink fountain key corresponds to the image area ratio or the image area larger than a second smallest range, and the ink fountain key opening ratio correction amount is obtained, comparing a positive/negative direction of an average value of differences between the opening ratios of ink fountain keys belonging to the second smallest range after ink supply amount adjustment and the standard opening ratios belonging to the second smallest range before ink supply amount adjustment with a positive/negative direction of an average value of differences between the opening ratios of the ink fountain keys belonging to the minimum range after ink supply amount adjustment and the standard opening ratios belonging to the minimum range before ink supply amount adjustment, and if the directions are different, obtaining the ink fountain roller rotation amount correction amount on the basis of the average value of the differences between the opening ratios of the ink fountain keys belonging to the second smallest range after ink supply amount adjustment and the standard opening ratios belonging to the second smallest range before ink supply amount adjustment.

11. A method according to claim 1, wherein the correction amount obtaining step comprises the step of obtaining the ink fountain roller rotation amount correction amount on the basis of an average value of differences between the ink fountain key opening ratios after ink supply amount adjustment and the standard opening ratios before ink supply amount adjustment.

12. A method according to claim 11, wherein the correction amount obtaining step comprises the step of obtaining the ink fountain roller rotation amount correction amount on the basis of an average value of differences between the opening ratios of ink fountain keys after ink supply amount adjustment and the standard opening ratios before ink supply amount adjustment, by using as targets the ink fountain keys belonging to a third smallest one of at least three ranges defined by dividing a range of one of an image area ratio and an image area of an area corresponding to the ink fountain keys.

13. A method according to claim 1, wherein the correction amount obtaining step comprises the step of obtaining the ink fountain roller rotation amount correction amount by multiplying an average value of differences between the ink fountain key opening ratios after ink supply amount adjustment and the standard opening ratios before ink supply amount adjustment by a predetermined coefficient.

14. A method according to claim 13, wherein the correction amount obtaining step comprises the step of obtaining the ink fountain roller rotation amount correction amount on the basis of an average value of differences between the opening ratios of ink fountain keys after ink supply amount adjustment and the standard opening ratios before ink supply amount adjustment, by using as targets the ink fountain keys belonging to a third smallest one of at least three ranges defined by dividing a range of one of an image area ratio and an image area of an area corresponding to the ink fountain keys.

15. A method according to claim 13, wherein
the coefficient includes a first coefficient and a second coefficient smaller than the first coefficient, and
the correction amount obtaining step comprises the steps of:
using the first coefficient when a positive/negative direction of a difference between an ink fountain roller rotation amount after ink supply amount adjustment and the standard rotation amount before ink supply amount adjustment coincides with a positive/negative direction of the average value of the differences between the ink fountain key opening ratios after ink supply amount adjustment and the standard opening ratios before ink supply amount adjustment; and
using the second coefficient when the positive/negative direction of the difference between the ink fountain roller rotation amount after ink supply amount adjustment and the standard rotation amount before ink supply amount adjustment does not coincide with the positive/negative direction of the average value of the differences between the ink fountain key opening ratios after ink supply amount adjustment and the standard opening ratios before ink supply amount adjustment.

16. A method according to claim 13, wherein
the coefficient includes a first coefficient and a second coefficient smaller than the first coefficient, and
the correction amount obtaining step comprises the steps of:
using the first coefficient when a positive/negative direction of an average value of differences between current ink fountain key opening ratios after ink supply amount adjustment and the standard opening ratios before ink supply amount adjustment coincides with a positive/negative direction of an average value of differences between ink fountain key opening ratios after a plurality of number of times of past ink supply amount adjustment and the standard opening ratios before a plurality of number of times of past ink supply amount adjustment; and
using the second coefficient when the positive/negative direction of the average value of the differences between the current ink fountain key opening ratios after ink supply amount adjustment and the standard opening ratios before ink supply amount adjustment does not coincide with the positive/negative direction of the average value of the differences between the ink fountain key opening ratios after the plurality of number of times of past ink supply amount adjustment and the standard opening ratios before the plurality of number of times of past ink supply amount adjustment.

17. A method according to claim 1, wherein the correction amount obtaining step comprises the step of, when an absolute value of an average value of differences between the ink fountain key opening ratios after ink supply amount adjustment and the standard opening ratios before ink supply amount adjustment is larger than an absolute value of the difference between the ink fountain roller rotation amount after ink supply amount adjustment and the standard rotation amount before ink supply amount adjustment, obtaining the ink fountain roller rotation amount correction amount by multiplying the average value of the differences between the ink fountain key opening ratios after ink supply amount adjustment and the standard opening ratios before ink supply amount adjustment by a predetermined coefficient.

18. A method according to claim 17, wherein the correction amount obtaining step comprises the step of obtaining the ink fountain roller rotation amount correction amount on the basis of an average value of differences between the opening ratios of ink fountain keys after ink supply amount adjustment and the standard opening ratios before ink supply amount adjustment, by using as targets the ink fountain keys belonging to a third smallest one of at least three ranges defined by dividing a range of one of an image area ratio and an image area of an area corresponding to the ink fountain keys.

19. A method according to claim 18, wherein the correction amount obtaining step comprises the step of, when no ink fountain key corresponds to the image area ratio or the image area larger than a second smallest range, and the ink fountain key opening ratio correction amount is obtained, comparing a positive/negative direction of an average value of differences between the opening ratios of ink fountain keys belonging to the second smallest range after ink supply amount adjustment and the standard opening ratios belonging to the second smallest range before ink supply amount adjustment with a positive/negative direction of an average value of differences between the opening ratios of the ink fountain keys belonging to the minimum range after ink supply amount adjustment and the standard opening ratios belonging to the minimum range before ink supply amount adjustment, and if the directions are different, obtaining the ink fountain roller rotation amount correction amount on the basis of the average value of the differences between the opening ratios of the ink fountain keys belonging to the second smallest range after ink supply amount adjustment and the standard opening ratios belonging to the second smallest range before ink supply amount adjustment.

20. A method according to claim 19, wherein the correction amount obtaining step comprises the step of obtaining the ink fountain key opening ratio correction amount by multiplying the average value of the differences between the opening ratios of the ink fountain keys belonging to the second smallest range after ink supply amount adjustment and the standard opening ratios belonging to the second smallest range before ink supply amount adjustment by a predetermined coefficient.

21. An ink supply amount adjustment apparatus for a printing press including a plurality of ink fountain keys each of which adjusts an amount of ink supplied from an ink fountain in accordance with an opening ratio, and an ink fountain roller which adjusts, in accordance with a rotation amount, an amount of ink to be supplied from the ink fountain to a plate cylinder, comprising:
first comparison means for comparing a standard rotation amount of the ink fountain roller preset before ink supply amount adjustment with a rotation amount of the ink fountain roller after ink supply amount adjustment;
second comparison means for comparing a standard opening ratio of each ink fountain key preset before ink supply amount adjustment with an opening ratio of the ink fountain key after ink supply amount adjustment;
first calculation means for obtaining an ink fountain roller rotation amount correction amount on the basis of at least one of comparison results of said first comparison means and said second comparison means;
second calculation means for obtaining an ink fountain key opening ratio correction amount common to all the ink fountain keys on the basis of at least the comparison result of said second comparison means; and
adjustment means for adjusting the ink fountain key opening ratio and the ink fountain roller rotation amount on the basis of calculation results of said first calculation means and said second calculation means.

22. An apparatus according to claim 21, wherein said first calculation means obtains the ink fountain roller rotation amount correction amount on the basis of a difference between the ink fountain roller rotation amount after ink supply amount adjustment and the standard rotation amount before ink supply amount adjustment.

23. An apparatus according to claim 21, wherein said first calculation means obtains the ink fountain roller rotation amount correction amount by multiplying a difference between the ink fountain roller rotation amount after ink supply amount adjustment and the standard rotation amount before ink supply amount adjustment by a predetermined coefficient.

24. An apparatus according to claim 23, wherein
the coefficient includes a first coefficient and a second coefficient smaller than the first coefficient, and
said first calculation means
uses the first coefficient when a positive/negative direction of a difference between a current ink fountain roller rotation amount after ink supply amount adjustment and the standard rotation amount before ink supply amount adjustment coincides with a positive/negative direction of an average value of differences between ink fountain roller rotation amounts after a plurality of number of times of past ink supply amount adjustment and the standard rotation amount before a plurality of number of times of past ink supply amount adjustment, and
uses the second coefficient when the positive/negative direction of the difference between the current ink fountain roller rotation amount after ink supply amount adjustment and the standard rotation amount before ink supply amount adjustment does not coincide with the positive/negative direction of the average value of the differences between the ink fountain roller rotation amounts after the plurality of number of times of past ink supply amount adjustment and the standard rotation amount before the plurality of number of times of past ink supply amount adjustment.

25. An apparatus according to claim 21, wherein when an absolute value of the ink fountain roller rotation amount correction amount is larger than a predetermined upper limit value, said first calculation means corrects the ink fountain roller rotation amount correction amount so as to set the absolute value of the ink fountain roller rotation amount correction amount to the upper limit value.

26. An apparatus according to claim 21, wherein said second calculation means obtains the ink fountain key opening ratio correction amount on the basis of an average value of differences between the ink fountain key opening ratios after ink supply amount adjustment and the standard opening ratios before ink supply amount adjustment.

27. An apparatus according to claim 26, wherein said second calculation means obtains the ink fountain key opening ratio correction amount by multiplying the average value of the differences between the ink fountain key opening ratios after ink supply amount adjustment and the standard opening ratios before ink supply amount adjustment by a predetermined coefficient.

28. An apparatus according to claim 27, wherein
the coefficient includes a first coefficient and a second coefficient smaller than the first coefficient, and
said second calculation means
uses the first coefficient when a positive/negative direction of an average value of differences between current ink fountain key opening ratios after ink supply amount adjustment and the standard opening ratios before ink supply amount adjustment coincides with a positive/negative direction of an average value of differences between ink fountain key opening ratios after a plurality of number of times of past ink supply amount adjustment and the standard opening ratios before a plurality of number of times of past ink supply amount adjustment, and
uses the second coefficient when the positive/negative direction of the average value of the differences between the current ink fountain key opening ratios after ink supply amount adjustment and the standard opening ratios before ink supply amount adjustment does not coincide with the positive/negative direction of the average value of the differences between the ink fountain key opening ratios after the plurality of number of times of past ink supply amount adjustment and the standard opening ratios before the plurality of number of times of past ink supply amount adjustment.

29. An apparatus according to claim 26, wherein said second calculation means obtains the ink fountain key opening ratio correction amount on the basis of the average value of the differences between the opening ratios of ink fountain keys after ink supply amount adjustment and the standard opening ratios before ink supply amount adjustment, by using as targets the ink fountain keys belonging to a minimum one of a plurality of ranges defined by diving a range of one of an image area ratio and an image area of an area corresponding to the ink fountain keys.

30. An apparatus according to claim 29, wherein when no ink fountain key corresponds to the image area ratio or the image area larger than a second smallest one of the ranges, and the ink fountain key opening ratio correction amount is obtained, said first calculation means compares a positive/negative direction of an average value of differences between the opening ratios of ink fountain keys belonging to the second smallest range after ink supply amount adjustment and the standard opening ratios belonging to the second smallest range before ink supply amount adjustment with a positive/negative direction of an average value of differences between the opening ratios of the ink fountain keys belonging to the minimum range after ink supply amount adjustment and the standard opening ratios belonging to the minimum range before ink supply amount adjustment, and if the directions are different, obtains the ink fountain roller rotation amount correction amount on the basis of the average value of the differences between the opening ratios of the ink fountain keys belonging to the second smallest range after ink supply amount adjustment and the standard opening ratios belonging to the second smallest range before ink supply amount adjustment.

31. An apparatus according to claim 21, wherein said first calculation means obtains the ink fountain roller rotation amount correction amount on the basis of an average value of differences between the ink fountain key opening ratios after ink supply amount adjustment and the standard opening ratios before ink supply amount adjustment.

32. An apparatus according to claim 31, wherein said first calculation means obtains the ink fountain roller rotation amount correction amount on the basis of an average value of differences between the opening ratios of ink fountain keys after ink supply amount adjustment and the standard opening ratios before ink supply amount adjustment, by using as targets the ink fountain keys belonging to a third smallest one of at least three ranges defined by dividing a range of one of an image area ratio and an image area of an area corresponding to the ink fountain keys.

33. An apparatus according to claim 31, wherein said first calculation means obtains the ink fountain roller rotation amount correction amount by multiplying an average value of differences between the ink fountain key opening ratios after ink supply amount adjustment and the standard opening ratios before ink supply amount adjustment by a predetermined coefficient.

34. An apparatus according to claim 33, wherein
the coefficient includes a first coefficient and a second coefficient smaller than the first coefficient, and
said first calculation means
uses the first coefficient when a positive/negative direction of a difference between an ink fountain roller rotation amount after ink supply amount adjustment and the standard rotation amount before ink supply amount adjustment coincides with a positive/negative direction of the average value of the differences between the ink fountain key opening ratios after ink supply amount adjustment and the standard opening ratios before ink supply amount adjustment, and
uses the second coefficient when the positive/negative direction of the difference between the ink fountain roller rotation amount after ink supply amount adjustment and the standard rotation amount before ink supply amount adjustment does not coincide with the positive/negative direction of the average value of the differences between the ink fountain key opening ratios after ink supply amount adjustment and the standard opening ratios before ink supply amount adjustment.

35. An apparatus according to claim 33, wherein
the coefficient includes a first coefficient and a second coefficient smaller than the first coefficient, and
said first calculation means
uses the first coefficient when a positive/negative direction of an average value of differences between current ink fountain key opening ratios after ink supply amount adjustment and the standard opening ratios before ink supply amount adjustment coincides with a positive/negative direction of an average value of differences between ink fountain key opening ratios after a plurality of number of times of past ink supply amount adjustment and the standard opening ratios before a plurality of number of times of past ink supply amount adjustment, and
uses the second coefficient when the positive/negative direction of the average value of the differences between the current ink fountain key opening ratios after ink supply amount adjustment and the standard opening ratios before ink supply amount adjustment does not coincide with the positive/negative direction of the average value of the differences between the ink fountain key opening ratios after the plurality of number of times of past ink supply amount adjustment and the standard opening ratios before the plurality of number of times of past ink supply amount adjustment.

36. An apparatus according to claim 21, wherein when an absolute value of an average value of differences between the ink fountain key opening ratios after ink supply amount adjustment and the standard opening ratios before ink supply amount adjustment is larger than an absolute value of the difference between the ink fountain roller rotation amount after ink supply amount adjustment and the standard rotation amount before ink supply amount adjustment, said first calculation means obtains the ink fountain roller rotation amount correction amount by multiplying the average value of the differences between the ink fountain key opening ratios after ink supply amount adjustment and the standard opening ratios before ink supply amount adjustment by a predetermined coefficient.

37. An apparatus according to claim 36, wherein said first calculation means obtains the ink fountain roller rotation amount correction amount on the basis of an average value of differences between the opening ratios of ink fountain keys after ink supply amount adjustment and the standard opening ratios before ink supply amount adjustment, by using as targets the ink fountain keys belonging to a third smallest one of at least three ranges defined by dividing a range of one of an image area ratio and an image area of an area corresponding to the ink fountain keys.

38. An apparatus according to claim 37, wherein when no ink fountain key corresponds to the image area ratio or the image area larger than a second smallest one of the ranges, and the ink fountain key opening ratio correction amount is obtained, said first calculation means compares a positive/negative direction of an average value of differences between the opening ratios of ink fountain keys belonging to the second smallest range after ink supply amount adjustment and the standard opening ratios belonging to the second smallest range before ink supply amount adjustment with a positive/negative direction of an average value of differences between the opening ratios of the ink fountain keys belonging to the minimum range after ink supply amount adjustment and the standard opening ratios belonging to the minimum range before ink supply amount adjustment, and if the directions are different, obtains the ink fountain roller rotation amount correction amount on the basis of the average value of the differences between the opening ratios of the ink fountain keys belonging to the second smallest range after ink supply amount adjustment and the standard opening ratios belonging to the second smallest range before ink supply amount adjustment.

39. An apparatus according to claim 38, wherein said second calculation means obtains the ink fountain key opening ratio correction amount by multiplying the average value of the differences between the opening ratios of the ink fountain keys belonging to the second smallest range after ink supply amount adjustment and the standard opening ratios belonging to the second smallest range before ink supply amount adjustment by a predetermined coefficient.
